(19) United States
(12) Patent Application Publication
(10) Pub. No.: US 2026/0219778 A1
(43) Pub. Date: Jul. 30, 2026

(54) CUSTOMIZED USER INTERFACES AND MEDIA CONTENT EXPERIENCES

(71) Applicant: Roku, Inc., San Jose, CA (US)

(72) Inventors: Margret Schmidt, Redwood City, CA (US); Ryan Terry, Tucson, AZ (US); Erich K. Woo, San Francisco, CA (US); Kaushiki Priyam, San Jose, CA (US); Michael Bruza, Los Gatos, CA (US); Mudassir Anjun, San Ramon, CA (US)

(21) Appl. No.: 19/279,419

(22) Filed: Jul. 24, 2025

Related U.S. Application Data
(60) Provisional application No. 63/749,854, filed on Jan. 27, 2025.

(51) Int. Cl. G06F 3/04845; G06F 3/04842

(52) U.S. Cl. CPC G06F 3/04845; G06F 3/04842

(57) ABSTRACT

System, apparatus, article of manufacture, method and/or computer program embodiments are provided for customizing user interfaces (UIs) based on custom themes and animations. An example method can include determining topic candidates for a theme of a UI of an application at a device associated with a user; determining a respective selection parameter for each topic from the topic candidates, the respective selection parameter comprising a topic preference score, a topic priority, a topic metric, and/or a topic relevance to a date associated with a presentation of the UI, the user, the application, and/or content associated with the application; selecting a topic from the topic candidates based on the respective selection parameter for each topic from the topic candidates; based on the topic, determining a theme for the UI of the application; and generating UI data defining a customized configuration of the UI based on the theme.

### CROSS-REFERENCE TO RELATED APPLICATIONS

This application claims the benefit of, and priority to, U.S. Provisional Application No. 63/749,854 filed on Jan. 27, 2025, the contents of which are incorporated herein by reference in their entirety and for all purposes. This application is also related to U.S. Non-Provisional Patent Application No. ______, filed on Jul. 24, 2025; and U.S. Non-Provisional Patent Application No. ______, filed on Jul. 24, 2025; which are expressly incorporated by reference herein in their entirety and for all purposes.

### BACKGROUND

### Technical Field

This disclosure is generally directed to media content and interfaces and, more specifically, user interfaces, avatars, and content customized based on themes and immersive interface experiences.

### SUMMARY

Provided herein are system, apparatus, article of manufacture, method and/or computer program product embodiments (and/or combinations and/or sub-combinations thereof) for generating user interfaces customized based on a theme(s) and configured to provide immersive experiences. In some aspects, a method is provided for generating user interfaces customized based on a custom theme(s), animation(s), and/or interface components. An example method can include determining topic candidates for a theme of a UI of an application at a device associated with a user; determining a respective selection parameter for each topic from the topic candidates, the respective selection parameter comprising a topic preference score, a topic priority, a topic metric, and/or a topic relevance to a date associated with a presentation of the UI, the user, the application, and/or content associated with the application; selecting a topic from the topic candidates based on the respective selection parameter for each topic from the topic candidates; based on the topic, determining a theme for the UI of the application; and generating UI data defining a customized configuration of the UI based on the theme.

In some aspects, a system is provided for generating user interfaces customized based on a custom theme(s), animation(s), and/or interface components. The system can include one or more computing and/or media devices such as, for example, a television, a media player, a server, a computer, a set-top box, an Internet-of-Things (IoT) device, a peripheral device, a mobile device (e.g., a smartphone, etc.), a wearable computing device (e.g., a smartwatch, smartglasses, a head-mounted display (HMD), an extended reality (e.g., virtual reality, augmented reality, mixed reality, virtual reality with video passthrough, etc.) glasses, etc.) system, a single-board computer (SBC) or system-on-chip (SoC) device, a video game console, and/or a smart device, among others.

The system can include memory used to store data, such as computing instructions, and one or more processors coupled to the memory and configured to perform operations including determining topic candidates for a theme of a UI of an application at a device associated with a user; determining a respective selection parameter for each topic from the topic candidates, the respective selection parameter comprising a topic preference score, a topic priority, a topic metric, and/or a topic relevance to a date associated with a presentation of the UI, the user, the application, and/or content associated with the application; selecting a topic from the topic candidates based on the respective selection parameter for each topic from the topic candidates; based on the topic, determining a theme for the UI of the application; and generating UI data defining a customized configuration of the UI based on the theme.

In some aspects, a non-transitory computer-readable medium is provided for generating user interfaces customized based on a custom theme(s), animation(s), and/or interface components. In some cases, the non-transitory computer-readable medium can have instructions stored thereon that, when executed by one or more processors, cause the one or more processors to perform operations including determining topic candidates for a theme of a UI of an application at a device associated with a user; determining a respective selection parameter for each topic from the topic candidates, the respective selection parameter comprising a topic preference score, a topic priority, a topic metric, and/or a topic relevance to a date associated with a presentation of the UI, the user, the application, and/or content associated with the application; selecting a topic from the topic candidates based on the respective selection parameter for each topic from the topic candidates; based on the topic, determining a theme for the UI of the application; and generating UI data defining a customized configuration of the UI based on the theme.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIG. 3A illustrates an example of a customized user interface implementing a theme and associated content, according to some examples of the present disclosure.

FIG. 3B illustrates another example of a customized user interface implementing a theme and associated content, according to some examples of the present disclosure.

FIG. 4 illustrates another example of a user interface configured with a theme, according to some examples of the present disclosure.

FIGS. 5A through 5D illustrate example user interfaces customized based on a theme(s), according to some examples of the present disclosure.

FIGS. 6A and 6B illustrate example user interfaces customized according to a theme(s) and configured to provide immersive experiences, according to some examples of the present disclosure.

FIG. 7A illustrates an example user interface with a user interface container and a customized theme, according to some examples of the present disclosure.

FIG. 7B illustrates an example user interface with an example user interface container generated based on a user interface element selected by a user, according to some examples of the present disclosure.

FIG. 8A illustrates an example user interface container customized to include a combination of themes, according to some examples of the present disclosure.

FIG. 8B illustrates an example user interface that includes an example user interface container customized with a combination of themes, according to some examples of the present disclosure.

FIG. 8C illustrates an example user interface customized based on a combination of themes and including multiple user interface containers, according to some examples of the present disclosure.

FIG. 9 is a diagram illustrating an example system process for customizing user interfaces, according to some examples of the present disclosure.

FIGS. 10 and 11 are flowcharts illustrating example methods for customizing user interfaces based on themes, according to some examples of the present disclosure.

FIG. 12 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can access and consume media content using media devices such as, for example and without limitation, mobile phones (e.g., smartphones), set-top boxes, computers (e.g., desktop computers, laptop computers, tablet computers, etc.), televisions (TVs), Internet Protocol television (IPTV) devices or receivers, media players, displays or monitors, projectors, video game consoles, smart wearable devices (e.g., smartwatches, smartglasses, head-mounted displays (HMDs), extended reality devices (e.g., virtual reality glasses, augmented reality glasses, mixed reality glasses, virtual reality devices with video passthrough, etc.), single-board computers (SBCs) or system-on-chip (SoC) devices, and Internet-of-Things (IoT) devices, among other devices. The media content can include or encompass digital formats and/or assets such as, for example and without limitation, videos (e.g., live videos, pre-recorded or on-demand videos, streamed videos, TV shows, movies, animated videos, motion graphics videos, live action recordings, video clips, any sequence of video frames or graphics, etc.), video games, audio, text (e.g., closed captions, subtitles, onscreen text, intertitles, superimposed text, and/or any other text content), graphics, video and/or application channels, and/or images, among other types.

For example, a user can use a media device to watch a video available in a content platform. The content platform can include a software application, infrastructure, and/or environment associated with (e.g., that includes, hosts, provides, implements, runs on, corresponds to, can be accessed via, etc.) a streaming service, set-top box, set-top box application or environment, online content delivery network, video game system, media application or player, video sharing application, web browser, TV (and/or, TV application, operating system, and/or platform), entertainment system, online media content service, media channel, content provider, broadcast system, podcast system, linear content system, media receiver, and/or the like. The video can include, for example, a video (e.g., movie, TV show, podcast, livestream, video stream or feed, video broadcast, video recording, video clip, animated video, etc.), broadcast, video game, video conference, video podcast, etc. The media device can access (or stream) the video from the content platform or a web browser, access the video from storage, or obtain the video from another source. The media device can display the video for the user, and the user can use the media device, a remote control, and/or an application to manage any settings of the video (e.g., volume, closed caption settings, subtitles, resolution, color settings, brightness levels, etc.), manage/control a behavior or functionality of the video (e.g., playback, pause, stop, rewind, record, forward, etc.), navigate and/or access content, etc. The media device can include, obtain, and/or manage content (e.g., videos, images, audio, etc.), channels, applications, settings, input/output devices, functionalities, and/or other features/components.

The media device can provide or display content via a user interface. The user can use the user interface to access and consume (e.g., view/watch, play/replay, etc.) content, interact with content, select content, navigate content, manage a content behavior, adjust content settings, engage in content experiences, etc. The user interface, including the user interface configuration and attributes, can affect the user experience. For example, the user interface can affect the level of difficulty for the user to find/discover or identify/navigate content and features/functionalities, search or access content, interact with the user interface or content available through the user interface, navigate the user interface, understand the user interface layout, explore the user interface, etc. A poorly designed user interface can frustrate the experience of a user, cause a user to lose interest in a content experience and/or an associated platform, frustrate the ability of a user to navigate or explore the user interface and its content, frustrate the ability of a user to learn or discover features and functionalities available through the user interface, discourage or deter a user from engaging with the user interface and/or associated content, etc.

For example, a user interface that is cumbersome, unorganized, confusing, unengaging, or visually unappealing may frustrate a user's experience when using the user interface, cause the user to lose interest in content or experiences available through the user interface, negatively impact the user's view of an application or platform associated with the user interface, discourage or deter the user from using the user interface and an associated application or platform, impede the user's ability to find/discover content and features/functionalities available through the user interface, etc. By contrast, a user interface that is organized, engaging, user friendly, visually appealing, immersive, easy to navigate, and easy to understand can provide numerous advantages, such as drawing users to an application/platform (and associated content and experiences) associated with the user interface, increasing a userbase and user retention, evoking positive feelings from users towards the user interface and an associated application/platform, improving user experiences, etc. However, it can be difficult to create a well-designed user interface that captures these (and other) advantages. The design of a user interface can be further complicated as the amount and type of content and experiences provided by the user interface increase.

Provided herein are system, apparatus, device, method (also referred to as a process) and/or computer program product embodiments, combinations and/or sub-combinations thereof (also referred to as “systems and techniques” hereinafter) for customized and immersive user interfaces and experiences. In some examples, the systems and techniques described herein can be used to generate customized user interfaces for accessing content (e.g., playing content, interacting with content, engaging with content, etc.), navigating content and associated features (e.g., searching and finding content and features, discovering content and features, etc.), engaging in customized and/or immersive content experiences, etc. The user interfaces can be intelligently designed (e.g., customized, organized, etc.) and engaging, appealing, immersive, user friendly (e.g., easy to navigate, easy to understand, etc.) and designed to increase user interest, draw and retain users, improve user and content experiences, evoke positive feelings from users, etc. The user interfaces can optionally implement customized or intelligently-selected user profiles, avatars, and/or associated content/experiences.

In some cases, a customized user interface can implement a theme, display selective/tailored content, include a tailored appearance, implement a user or group-specific configuration (e.g., a configuration tailored to or selected for a user or group) or a device-specific configuration (e.g., a configuration tailored or selected for a device), depict a customized user avatar or profile image, apply a customized user/group profile, provide a customized experience(s), etc. In some examples, the user interface can be customized based on user preferences or characteristics, temporally relevant topics (e.g., events, people, content, announcements, contexts, environments, activities, preferences, etc., relevant to a current or specific event, trend, context, activity, interaction, condition, preference, user, group, device, setting, environment, etc.), featured content (e.g., highlighted or promoted content, recommended content, tailored content, preferred content, etc.), a theme, a performance goal, a design preference, a user history, a trend, a customization criteria, and/or any other factor.

For example, a user interface (and/or aspects thereof) can be customized based on a relevant event (e.g., a current or trending event) such as a competition (e.g., the Olympics, World Cup, World Series, Superbowl, a game show, etc.). The user interface can implement, present, promote, and/or highlight content selected based on the relevant event (e.g., the current or trending event), immersive and/or interactive experiences related to the event, a theme and/or visual appearance based on the event, attributes based on the event, and/or other customization details. The user interface can optionally invite users to interact with content or features related to the event, steer users to certain content or features, help the user explore or discover content and features, and even teach the user certain features or functionalities of the user interface.

The user interface can be customized based on a theme(s). In some cases, the user interface can be customized for the user based on a selected theme(s) as well as a user preference(s), a user profile, a user input (e.g., an input providing relevant information, an input request or selection, etc.), a user history (e.g., a content consumption history, a user preference history, a user purchasing history, etc.), social media information associated with the user (e.g., social media posts or content, a social media profile, social media connections, social media likes or interactions, etc.), user photos and/or a photo library made available by the user, user interactions and/or activity, customization weights or criteria, and/or any other information.

In some cases, the user interface can provide, highlight, promote, prioritize, and/or recommend information, features, and/or experiences (e.g., content, interactions, destinations, products, etc.) associated with a team. For example, the user interface can display information about a team associated with a theme, such as team statistics or a team history, promote merchandise associated with the team, highlight videos associated with the team (e.g., previous games, game highlights, team reels, player highlights, historical highlights, etc.), offer an immersive experience or interactive activity associated with the team (e.g., an offer to bet on the team, an activity to create a preferred starting lineup, an activity to predict or select a particular play during the game, a video game including that team, an interaction with other users involving the team, a prediction of player or game statistics, etc.), customize an avatar or profile image of the user to depict any details associated with the team, customize a user profile based on the team (e.g., to provide, recommend, or promote content, features, and/or experiences associated with team and/or an associated sport, etc.), etc.

A theme implemented by a user interface can optionally continue or evolve across user interface spaces (e.g., pages, screens, windows, frames, regions, instances, etc.), user sessions, days of use, etc. For example, a theme implemented by a user interface on a particular day can continue user interface screens, components, pages, sections, experiences, and/or spaces on that day (or a timespan including multiple days) and/or session (or multiple sessions), and can optionally evolve during the user session, experience, or interaction with the user interface. To illustrate, if the user interface implements a theme related to a trending event in social media, the user interface may first incorporate the theme in a particular page (e.g., home page, landing or welcome page, etc.). If the user navigates to a different page or a different section of the user interface, the different page or section of the user interface can also incorporate the theme (and/or aspects thereof). As the user interacts with the user interface, the user interface can persist the theme (and/or aspects thereof) and can optionally evolve the theme by adjusting or updating the theme at certain points.

If the user wants the user interface to stop implementing the theme or switch to a different theme, the user can optionally request so or can trigger the user interface to stop implementing the theme or implement a different theme. When the user accesses the user interface on a different day, the user interface may continue with the same theme or may implement another theme. For example, if another event is temporally relevant to that day, has a higher relevance score, or is otherwise selected based on certain data (e.g., rules, inputs, weights, criteria, preferences, promotions, etc.), the user interface can incorporate a different theme on that day, such as a theme that is based on an event that has a higher relevance score or is more temporally on that day. This way, the user interface can adapt to user interests/preferences, temporal events, changes, content experiences, locations, information, devices, etc.

In some cases, the systems and techniques described herein can implement profiles used to manage aspects of the user interface. The profiles can customize the user interface and/or associated content, features, experiences, etc., for a user or a group of users. The systems and techniques described herein can customize a profile for a particular user and can create shared profiles customized for a group of users, such as users in a household, party, event, etc. A shared profile of a group of users can be generated or configured by merging the profiles of the users in the group or combining selected aspects (e.g., content, features, themes, experiences, recommendations, interface attributes, behaviors, settings, appearance parameters, etc.) from various profiles associated with users in the group. In some cases, the shared profile (or a portion of the shared profile) can be configured to include aspects selected for the shared profile (and/or the group) based on the profiles of the users in the group (and/or aspects thereof). The selected aspects can be extracted from the profiles of the users in the group and/or can be calculated based on information from the profiles of the users in the group. The selected aspects can be calculated based on one or more shared profile rules, requirements, policies, preferences, details, and/or cues, and/or information about each individual in the group (e.g., user preferences, user history, user policies, user characteristics, user constraints, user controls such as parental controls, user information or demographics, user statistics, user inputs, etc.).

For example, if the group includes an adult and a child. The profile of the adult may be configured to prioritize, promote, or implement content unsuitable for minors and the profile of the adult may be configured to prioritize, promote, or implement content for children of a certain age range that may be of little interest to the adult. In this case, merging the profiles can result in the shared profile including content inappropriate for the child. Thus, instead of merging the profiles, the systems and techniques described herein can create a shared profile that excludes any content that is filtered for a particular user, such as content that is inappropriate for the child and a category of content blacklisted or blocked by the adult. The shared profile can include the unfiltered portions of the adult and child profiles, and/or can include aspects that are not included in either of the adult or child profiles but is calculated based on information about such profiles and/or associated users.

To illustrate, perhaps neither the adult profile nor the child profile includes family content. Thus, individually, the child profile customized for the child does not include family content as the child may be more interested in other content (e.g., content for children, such as cartoons) when consuming content without the adult, and the adult profile customized for the adult also does not include family content as the adult may typically be more interested in adult content when consuming content without the child. While the child and the adult may not prefer family content when consuming content individually, the adult and child may have a higher interest in family content when consuming content together, as the family content may include content that is suitable for both the child and the parent and may represent the best match for the child and parent combined based on information about the child (and/or child profile) and the adult (and/or adult profile).

For example, assume that the adult has (or is estimated to have) a preference or affinity for adult comedies and the child has (or is estimated to have) an interest in (or a preference or affinity for) comedic content rated for children of certain ages. Here, the child may not be allowed to consume adult comedies and the adult may not be interested in content rated for children of such ages. However, the adult and child are both estimated to have an interest in comedy and the child may be allowed to consume comedies that are not rated for adults. While the adult may not be interested in content that is rated for children of a certain age, when consuming content with the child, the adult may enjoy comedies rated as family content suitable for children when accompanied by the child even if such content is not a preferred content when the adult consumes content without the child (e.g., and thus such content is likely not implemented by the adult profile). Moreover, while the child may not be allowed to consume adult comedies, the child may be allowed to consume comedies rated as family content and may enjoy such content when accompanied by the adult even if such content is not preferred by the child when the child is not accompanied by the adult (e.g., and thus such content is likely not implemented by the child profile).

Accordingly, while the comedies rated as family content may not be included or promoted in the adult profile or the child profile and may not be preferred or prioritized by the adult when not accompanied by the child or the child when not accompanied by the adult, such content may be more suitable for the shared profile of the adult and child and more likely enjoyed by (and suitable for) the adult and child when consuming content together. Therefore, the shared profile may include or promote comedies rated as family content given an overlap in interests of the adult and child and an estimated suitability for the adult and child when the adult and child are together, even though such content may not be recommend, promoted, or included in the individual profiles of the adult and child and less of interest to the adult and child when not together but more of interest to them when together. Thus, the shared profile can include or be customized based on content and/or preferences associated with multiple profiles and users, but in some cases may not include content or attributes from any of the profiles of the users associated with the shared profile and instead include content or attributes that are suitable or selected for the group that would not be otherwise selected or used for the individual profiles of the users in the group.

In some cases, the systems and techniques described herein can detect a presence of one or more users in a scene that includes a media device (or within a proximity of the media device) and automatically implement a profile at the media device for the one or more users. For example, the systems and techniques described herein can use one or more sensors (e.g., one or more camera sensors, ranging sensors such as radio detection and ranging (RADAR) sensors and/or light detection and ranging (RADAR) sensors, ultrasound sensors, infrared sensors, etc.) and/or data about a behavior of the one or more users in the scene (e.g., a navigation behavior, a usage behavior of a remote control, a usage behavior of the media device, a motion or pattern of motion, user activity, etc.), user inputs, and/or user characteristics to detect the one or more users in the scene (or within a proximity of the media device. In some cases, the systems and techniques described herein can additionally or alternatively detect the one or more users based on wireless signals associated with certain devices, such as wireless (e.g., WIFI, Bluetooth, etc.) signals indicating a presence of one or more mobile devices of the one or more users, an active connection of such devices with a network associated with the scene, or notifications (e.g., messages, instructions, beacons, signals, etc.) from such devices. In response to detecting the one or more users, the media device can automatically implement a user profile customized for the one or more users.

In some cases, the one or more users can use the one or more mobile devices to scan a visual element depicted by a display, such as a quick response (QR) code depicted by a display of the media device or coupled to the media device, and trigger the one or more mobile devices to send a notification to the media device that the one or more users are present (e.g., within a proximity). The media device can then implement the user profile customized for the one or more users. The one or more mobile devices can optionally provide information to the media device used to customize the user profile for the one or more users, such as device data, user data, user history data, user activity, user preferences, user patterns, user inputs, user profile information, etc. In some cases, each of the one or more mobile devices can include an application that can communicate information to the media device used to customize the user profile, trigger implementation of the user profile, trigger the user profile to be timed-out or terminated/closed, or enable any user to interact with the media device or the user profile.

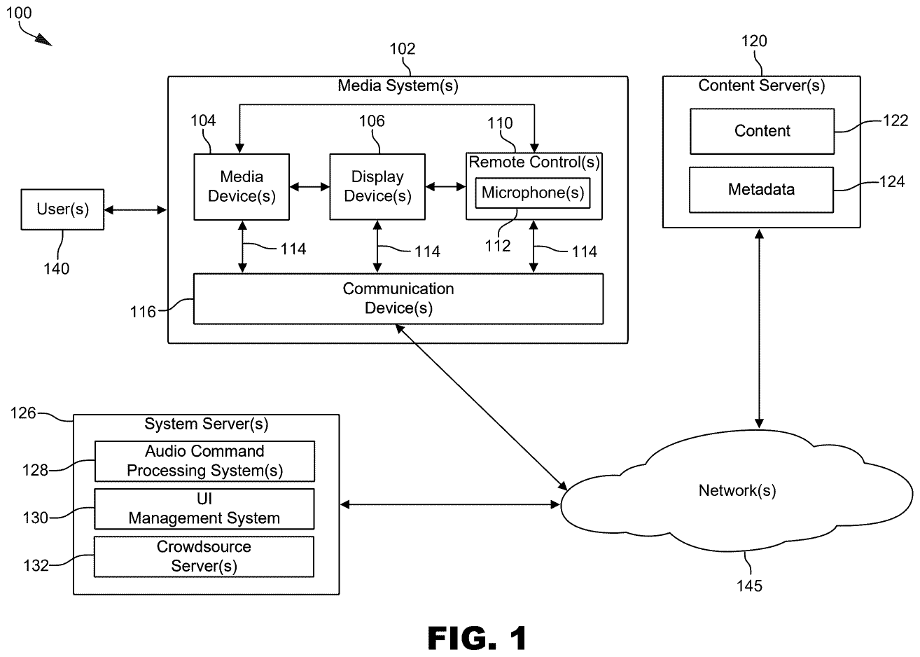

Various embodiments and aspects of this disclosure may be implemented using, and/or may be part of, multimedia environment 100 shown in FIG. 1. It is noted, however, that the multimedia environment 100 is provided for illustrative purposes and is not limiting. Examples and embodiments of this disclosure may be implemented using, and/or may be part of, environments that are different from and/or in addition to the multimedia environment 100, as will be appreciated by persons skilled in the relevant art(s) based on the teachings contained herein. An example of the multimedia environment 100 shall now be described.

### Example Multimedia Environment

FIG. 1 illustrates a block diagram of an example multimedia environment 100, according to some embodiments. In a non-limiting example, multimedia environment 100 may be directed to media content. However, this disclosure is applicable to any type of content (instead of or in addition to media content), as well as any mechanism, means, protocol, method and/or process for distributing content (e.g., media content, etc.), interacting with media content, and/or interacting with media devices.

The multimedia environment 100 may include a media system(s) 102. The media system(s) 102 can include one or more media systems, and each media system can include and/or represent a scene or environment and/or one or more devices in a scene or environment. The scene or environment can include, for example and without limitation, a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 140 may operate the media system(s) 102 (and/or one or more devices associated with the media system(s) 102) to select/access content (e.g., videos, images, audio, text, user interfaces, application content, etc.), consume content (e.g., watch/view content, play or replay content, interact with content, engage with content, play video game content, etc.), stream content, engage in content interactions or activities, etc. The user(s) 140 can include or represent one or more users in multimedia environment 100. The content can include, for example and without limitation, visual content (e.g., movies, television shows and/or programs, images, graphics, visual animations, videos, etc.), audio content (e.g., music, speech or dialogue, sounds, noise, etc.), text content (e.g., subtitles, closed captions, superimposed text or supers, overlaid text, scene text, etc.), metadata, podcasts, application content (e.g., content depicted and/or available via an application, application pages, application menus, etc.), user interfaces and/or user interface content, etc.

Media system(s) 102 may include media device(s) 104, display device(s) 106, remote control(s) 110, communication device(s) 116, and optionally any other device(s). Media device(s) 104 can be coupled to display device(s) 106 and/or can include a display device used to display digital content. Media device(s) 104 can include one or more media devices, and each media device can be coupled to or include a display device (or multiple display devices). It is noted that terms such as “coupled,” “connected to,” “attached,” “linked,” “combined” and similar terms may refer to physical, electrical, magnetic, logical, direct, wired, wireless, etc., connections, unless otherwise specified herein. The one or more media devices can include, for example, one or more streaming devices, DVD or BLU-RAY devices, audio/video playback devices, cable boxes, gaming systems or consoles, televisions, head-mounted displays (HMDs), set-top boxes, video display devices, computers (e.g., laptop computers, desktop computers, tablet computers, etc.), mobile phones (e.g., smartphones), smart wearable devices (e.g., smartwatches, smart glasses, etc.), screens, appliances, internet-of-things (IoT) devices, monitors, single-board computers (SBCs), system-on-chip (SoC) devices, projectors, extended reality (XR) devices (e.g., augmented reality (AR) devices, virtual reality (VR) devices, mixed reality (MR) devices, video-passthrough devices, etc.), and/or digital video recording devices, to name just a few non-limiting examples.

Media device(s) 104 (and/or each media device of media device(s) 104) can include and/or implement and/or can be part of, integrated with, operatively coupled to, and/or connected to one or more display devices, such as display device(s) 106 and/or a separate display. Media device(s) 104 may be configured to communicate with network 145 via communication device(s) 116. Communication device(s) 116 may include, for example, a cable modem, a satellite television (TV) transceiver, a router, an access point, a network device, an antenna, a gateway, a network switch, a cellular communication device or interface, etc. For example, in some cases, communication device(s) 116 can include or represent a network device, such as a router, switch, gateway, access point, etc. Media device(s) 104 may communicate with communication device(s) 116 over a link. The link may include a wireless connection(s) (e.g., WiFi, Bluetooth, cellular, etc.) and/or wired connection(s).

Network 145 can include, for example and without limitation, a public and/or private network, a cloud network, a wired network, and/or a wireless network. For example, network 145 can include the Internet, an intranet, an extranet, a cellular network, a Bluetooth network, an infrared network, a wide area network (WAN), a backbone network, an internet service provider (ISP) network, a network segment, a local area network (LAN), a wireless LAN (e.g., a WIFI network, etc.), an on-premises network, a public and/or private cloud network, and/or any other short range, long range, local, regional, global communications mechanism, means, approach, protocol and/or network, or any combination(s) thereof.

Display device(s) 106 can include one or more display devices and each display device can include one or more displays, screens, monitors, televisions, projectors, HMDs, XR devices, heads-up devices, any other display and/or presentation devices, and/or the like. In some cases, display device(s) 106 can include one or more media devices and each media device can be coupled to or include a display (or multiple displays). In some examples, display device(s) 106 may include, represent, implement, and/or be part of and/or coupled to one or more monitors, televisions (TVs), displays, screens, computers (e.g., desktop computers, laptop computers, tablet computers, etc.), mobile phones (e.g., smartphones), smart wearable devices (e.g., smart glasses, HMDs, etc.), appliances, IoT devices, SBCs, SoCs, XR devices, set-top boxes, video game consoles, digital media players, home entertainment systems, video display devices, electronic ink (eInk) devices or displays, and/or projectors, to name a few non-limiting examples.

Remote control(s) 110 can include, implement, represent, or be part of any component, apparatus, and/or software for controlling media device(s) 104 and/or display device(s) 106, such as a remote control, a computer with remote control software and/or with or coupled to remote control hardware (e.g., a tablet computer, laptop computer, desktop computer, tablet computer, etc.), a mobile phone with remote control software and/or with or coupled to remote control hardware, a smart wearable device with remote control software and/or with or coupled to remote control hardware, on-screen control, integrated control button, audio control, input device, peripheral device, touch screen, or any combination thereof, to name a few examples. In some examples, remote control(s) 110 can communicate with media device(s) 104 and/or display device(s) 106 using any wireless and/or wired communication link, technology, and/or protocol such as, for example, cellular, Bluetooth, infrared, WIFI, WIFI direct, etc., or any combination thereof.

For example, remote control(s) 110 can communicate with media device(s) 104 and/or display device(s) 106 via a wireless connection and/or wireless signals such as a Bluetooth connection and/or signal, a WIFI connection and/or signal, a WIFI direct connection and/or signal, a cellular connection and/or signal, an infrared connection and/or signal, any other wireless connection or signal, or any combination thereof. In some cases, remote control(s) 110 may optionally include a microphone(s) 112. Microphone(s) 112 can record audio such as speech commands, voice commands, dialogue, and/or utterances used to interact with, control, and/or transmit commands and/or data to media device(s) 104 and/or display device(s) 106. Microphone(s) 112 can optionally record other audio as well such as noise, sounds, music, etc. In some cases, microphone(s) 112 can include a hardware and/or software feature (e.g., button, setting, functionality, etc.) that the user(s) 140 can use to activate the recording functionality of microphone(s) 112 to record audio, such as audio commands, questions, dialogue, etc.

Multimedia environment 100 may include content server(s) 120 (e.g., content provider(s), channel(s), source(s), platform(s), storage, system, etc.). Content server(s) 120 can include, implement, and/or represent one or more content servers, storage systems, content delivery services, distributed storage systems, content streaming and/or broadcasting systems, etc. Although only one content server is shown in FIG. 1, in practice, the multimedia environment 100 may include any number of content servers. Content server(s) 120 may be configured to communicate with network 145. Content server(s) 120 may store content 122 and metadata 124. Content 122 may include any type of content and/or combination of content such as music, videos, movies, video games, television (TV) programs, multimedia content, TV shows, images or still pictures, text, graphics, video games, gaming applications, advertisements, programming content, public service content, government content, channels, applications, local community content, data, user interface data/content, user profiles, user avatars, templates, content items, audio content, files, targeted media content, software, and/or any other content or data objects in electronic form.

Metadata 124 can include data about content 122. For example, metadata 124 may include information about content 122, ancillary information indicating or related to writer, director, producer, composer, artist, actor, summary, chapters, production, settings, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 100 may also include system server(s) 126. System server(s) 126 may operate to support media device(s) 104 and/or display device(s) 106 from a remote location and/or network, such as a cloud network, a backend network, a datacenter, etc. It is noted that the structural and functional aspects of system server(s) 126 may wholly or partially exist in the same or different system servers.

In some examples, system server(s) 126 may include, host, operate, and/or implement audio command processing system(s) 128, user interface (UI) management system 130, and/or crowdsource server(s) 132. Audio command processing system(s) 128 can process audio data such as speech/voice inputs and/or commands, audio/speech in videos, etc. For example, as noted above, remote control(s) 110 may include a microphone(s) 112 that can receive audio data from user(s) 140 (and/or other sources such as media device(s) 104, display device(s) 106, etc.). In some examples, media device(s) 104 may be audio responsive, and the audio data may represent verbal commands from the user(s) 140 to control media device(s) 104 and/or any other components in the media system(s) 102, such as display device(s) 106.

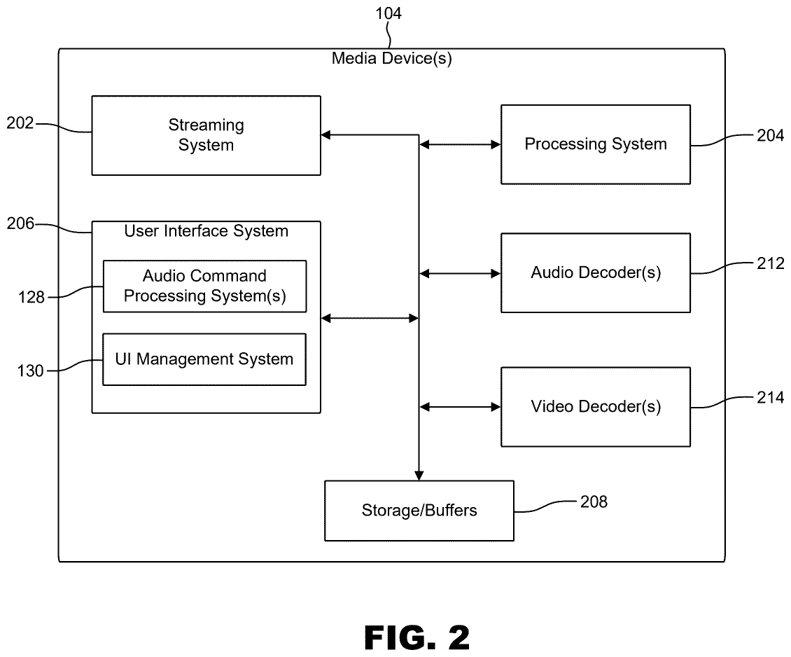

In some examples, the audio data recorded by microphone(s) 112 of remote control(s) 110 can be transferred to media device(s) 104, which can forward the audio data (with or without first processing the audio data) to audio command processing system(s) 128. Audio command processing system(s) 128 may operate to process and analyze the received audio data to recognize the verbal commands of the user(s) 140. Audio command processing system(s) 128 may forward the verbal commands back to media device(s) 104 for processing. In some cases, the audio data may be alternatively or additionally processed and analyzed by a copy or version of audio command processing system(s) 128 in media device(s) 104 (see FIG. 2). Media device(s) 104 and system server(s) 126 may cooperate to pick any of the verbal commands for processing (either the verbal command recognized by audio command processing system(s) 128 in system server(s) 126, or the verbal command recognized by the copy or version of audio command processing system(s) 128 in media device(s) 104). In some cases, audio command processing system(s) 128 can include, perform, or implement automatic speech recognition (ASR), natural language processing (NLP), natural language understanding (NLU), natural language generation (NLG), text-to-speech generation, etc.

UI management system 130 can select, configure, generate, manage, deliver, and/or provision user interfaces and/or associated content, settings, behaviors, customizations, designs, themes, and/or experiences. The user interfaces can be provided to, and/or rendered/displayed by media device(s) 104 and/or display device(s) 106. The user interface content can include any type of content, data, and/or metadata, such as media content (and any other content) from the content 122 and/or metadata from the metadata 124 at the content server(s) 120. UI management system 130 can select content and/or metadata for presentation to the user(s) 140 via media device(s) 104 and/or display device(s) 106. For example, UI management system 130 can generate, render, configure, manage, and/or provide a user interface(s) for display by media device(s) 104 and/or display device(s) 106.

UI management system 130 can additionally or alternatively generate, configure, and/or provide user interface data that media device(s) 104 and/or display device(s) 106 can use to render, display, generate, configure, and/or implement a user interface(s). The user interface(s) can include and/or can be used to access and/or engage/interact with content, content settings, application content, controls, menus, content experiences, metadata, user profiles, user avatars or profile images, media, and/or content services. For example, UI management system 130 can provide (and/or render) a user interface(s) or interface data (e.g., data used to render, display, generate, and/or configure a user interface) to media device(s) 104 and/or display device(s) 106 for presentation to user(s) 140. The user(s) 140 can use the user interface(s) to access, navigate, view, control, engage with, and/or interact with content (e.g., videos, images, advertisements, animations, graphics, text, movies, TV shows and/or programming content, audio, podcasts, video games, application content, etc.), content experiences, content settings, controls, metadata, user profiles, user avatars or profile images, content services, menus, and/or the like.

UI management system 130 can configure the user interface(s) and/or a content, behavior, setting, design, theme, artwork, experience, functionality, and/or feature of the user interface(s) and/or data thereof. The user interface(s) can include or implement a dynamic, static, customized, and/or shared user interface, user interface experience, user interface theme, user interface configuration, user interface behavior, user interface experience, and/or user interface, as further described herein. For example, UI management system 130 can configure, adjust, generate, select, and/or customize any content, pages, screens, windows, themes, appearances (e.g., look and feel, etc.), designs, content experiences, user profiles, user avatars or profile images, recommended content, interface elements, content and/or interface attributes, content and/or user interface visualization, and/or content and/or user interface settings displayed on a user interface(s) for the user(s) 140 by media device(s) 104 and/or display device(s) 106.

UI management system 130 can configure, adjust, generate, select, and/or customize such content, pages, screens, windows, themes, appearances, content, content and/or user interface attributes, the content and/or user interface visualization, and/or the content and/or user interface settings based on one or more signals. The one or more signals can include, for example and without limitation, user profile data, user profile detection signals, user avatar or profile image data, user interactions, user history, event data (e.g., content release events, current events, promotion events, trending events, cultural events, user and/or device events, popular culture events, sporting events, content events, group events, social events, etc.), household or group profile data, content activity, content interactions, user and/or device location information, user preferences, user inputs, social media signals (e.g., connections, posts, content, feedback, etc.), user statistics, trends (e.g., social media trends, user ratings, consumption trends, activity trends, current trends, regional trends, etc.), time information (e.g., a time of day, a day of a week, a time/day of the year, a time period, etc.), temporal events (e.g., a current event, a trending event, a media content trend, a current context, a current situation, a current condition, a time-of-year, a content release or release day/date, a current activity or competition, etc.), sensor information, a device associated with the user(s) 140, context information, a content or promotion campaign, a content consumption context, historical information, usage patterns, user data, group data, promoted content, content statistics, user interactions, etc.

UI management system 130 can implement, host, include, run, represent, and/or be part of one or more software algorithms, neural networks, applications, interfaces (e.g., application programming interfaces (APIs), etc.), models (e.g., artificial intelligence (AI) and/or machine learning (ML) models, etc.), code, servers, services, engines, logic, resources, software containers, virtual machines, resource (e.g., hardware and/or software resources), etc. For example, UI management system 130 can include an interface, such as an API, used to obtain or retrieve data from the content server(s) 120 and/or provide data to user devices, software such as an algorithm and/or model (e.g., an AI/ML model(s), etc.) configured to generate, customize, modify, update, render, manage, and/or configure a user interface(s) (and/or associated data, behaviors, experiences, settings, etc.), such as a user interface(s) of a content platform or application. The user interface(s) (and/or content and/or features thereof) can include, depict, or implement a certain visual and/or content experience, such as a theme-based visual and/or content experience, an immersive experience, a profile or profile-based experience, a user avatar or profile image, a tailored experience, etc. In some cases, UI management system 130 can configure the user interface(s) to provide theme-based, immersive, and/or interactive experiences such as interactive games, interactive or immersive activities, theme-based content and experiences, etc. In some examples, the content and/or interactive/immersive experiences can allow the user(s) 140 to interact with the user interface(s) and/or content presented by and/or available through the user interface(s) at media device(s) 104 and/or display device(s) 106.

In some cases, crowdsource server(s) 132 in system server(s) 126 can operate to cause closed captioning to be turned on and/or off during streaming of a media content item, such as a movie. For example, using information received from media device(s) 104 in the media system(s) 102 (e.g., in thousands or millions of media systems), crowdsource server(s) 132 may identify similarities and overlaps between closed captioning requests issued by different users watching a movie. Based on such information, crowdsource server(s) 132 may determine that turning closed captioning on may enhance the users'viewing experience at particular portions of the movie (e.g., when the soundtrack of the movie is difficult to hear), and turning closed captioning off may enhance the users'viewing experience at other portions of the movie (for example, when displaying closed captioning obstructs important or relevant visual aspects of the movie). Accordingly, crowdsource server(s) 132 may operate to cause closed captioning to be automatically turned on and/or off during future streamings of the movie.

In some cases, audio command processing system(s) 128, UI management system 130, and/or crowdsource server(s) 132 can be part of, hosted at, and/or implemented by a same server (or set of servers) from system server(s) 126 or different/separate servers from system server(s) 126. In other cases, UI management system 130 can be part of, hosted at, and/or implemented by a server (or set of servers) that is (or are) separate from a server(s) that includes, implements, and/or hosts audio command processing system(s) 128 and/or crowdsource server(s) 132. In other cases, audio command processing system(s) 128, UI management system 130, and/or crowdsource server(s) 132 can be distributed across multiple and/or different servers.

In some cases, media device(s) 104 can include, implement, and/or host a copy or version of audio command processing system(s) 128 and/or UI management system 130 as shown in FIG. 2. Moreover, audio command processing system(s) 128, UI management system 130, and crowdsource server(s) 132 can each include, implement, be part of, and/or host one or more servers, computers, models and/or neural networks, models (e.g., AI/ML models, statistical models, etc.), algorithms, applications, software engines or modules, code/logic, software components, processors and/or processing circuitry (e.g., central processing units (CPUs), compute resources, application services, software containers, virtual machines, microservices, digital signal processors (DSPs), graphics processing units (GPUs), image signal processors (ISPs), processor cores, system-on-chip (SOC) devices, application-specific integrated circuits (ASICs), field-programmable gate arrays (FPGAs), integrated circuits, etc.), software and/or hardware elements, software platforms, and/or any hardware and/or software components.

FIG. 2 illustrates a block diagram of an example of media device(s) 104, according to some examples of the present disclosure. For illustration and explanation purposes, in FIG. 2, media device(s) 104 represents a single media device. However, media device(s) 104 can include multiple media devices. Media device(s) 104 in FIG. 2 may include a streaming system 202, processing system 204, storage/buffers 208, user interface system 206, audio decoder(s) 212, and video decoder(s) 214. The user interface system 206 may optionally include a copy or version of audio command processing system(s) 128 to perform some or all of the operations, tasks, functions, and/or actions of audio command processing system(s) 128. Additionally or alternatively, the user interface system 206 may optionally include a copy or version of UI management system 130 to perform some or all of the operations, tasks, functions, and/or actions of UI management system 130.

For example, media device(s) 104 may optionally include a copy or version of audio command processing system(s) 128 and/or UI management system 130 to allow media device(s) 104 to respectively perform any of the tasks, operations, functions, actions, etc., described herein with respect to audio command processing system(s) 128 and/or UI management system 130 (e.g., in addition to or instead of any of such tasks, operations, functions, etc. (or portions thereof), performed by audio command processing system(s) 128 and/or UI management system 130 in/from system server(s) 126 in FIG. 1).

In some examples, audio command processing system(s) 128 and/or UI management system 130 can be optionally included in, implemented by, and/or part of the user interface system 206. Alternatively, audio command processing system(s) 128 and/or UI management system 130 can be optionally included in, implemented by, hosted at, and/or part of media device(s) 104, such as the processing system 204, or represent one or more separate components.

In some cases, audio command processing system(s) 128 optionally included in media device(s) 104 can be the same as audio command processing system(s) 128 in/from system server(s) 126 in the multimedia environment 100 shown in FIG. 1. In other cases, audio command processing system(s) 128 optionally included in media device(s) 104 in FIG. 2 can be a version of audio command processing system(s) 128 in/from system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of audio command processing system(s) 128 in/from system server(s) 126 in FIG. 1.

In some cases, UI management system 130 optionally included in media device(s) 104 in FIG. 2 can be the same as UI management system 130 in/from system server(s) 126 in the multimedia environment 100 shown in FIG. 1. In other cases, UI management system 130 optionally included in media device(s) 104 in FIG. 2 can be a version of UI management system 130 in/from system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of UI management system 130 in/from system server(s) 126 in FIG. 1.

As shown in FIG. 2, media device(s) 104 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Media device(s) 104 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name some examples.

### Customized User Interfaces and Content Experiences

Referring again to FIGS. 1 and 2, UI management system 130 (e.g., at system server(s) 126 and/or media device(s) 104) can generate, render, and/or provide customized, theme-based, interactive, dynamic, and/or immersive user interfaces and associated content experiences. The user interfaces can be used to access content (e.g., media content from content server(s) 120 and/or any other source), navigate content, search/find content, play and/or interact with content, engage in content experiences, participate in content activities or immersive interactions, access and/or adjust associated settings, access and/or manage user data such as profiles and/or avatars, etc. UI management system 130 can design, generate, configure, and/or customize an organization, behavior, visual appearance, design, theme, user profile, content experience, user avatar or profile image, and/or settings of the user interfaces and associated content. The user interfaces can be organized, engaging, visually appealing, immersive, user friendly, relevant, and/or customized in order to increase user interest and retention, draw new users to an associated content platform or application, increase and/or maximize content experiences, evoke positive feelings from users towards a content and/or platform associated with the user interfaces, and/or improve an overall user experience.

UI management system 130 can customize, configure, and/or adjust any aspect of a user interface. For example, UI management system 130 can customize a user interface, configure the user interface (and/or associated content and/or experiences) to implement a particular theme(s), display specific content (and/or categories of content), organize content in a particular way, provide a tailored look and feel, implement a particular design and/or configuration (e.g., a configuration and/or design selected for and/or tailored to a user, group of users, device, group of devices, context, topic, etc.), etc. In some examples, UI management system 130 can customize the design (e.g., the theme, content, organization, look and feel, style, settings, appearance, etc.) of the user interface according to user preferences and/or characteristics (e.g., of a user or a group of users), temporally relevant features (e.g., based on a current event, context, activity, interaction, condition, topic, etc.), trending and/or temporally relevant topics, featured content (e.g., highlighted content, promoted content, relevant content, preferred content, etc.), theme, performance goals and/or characteristics, design preferences, and/or any other factors.

For example, UI management system 130 can customize the user interface for different users based on a topic, such as a topic associated with an event, context, trend, etc. In some examples, UI management system 130 can customize the user interface for users based on a current or upcoming competition, such as a sports competition, a game show competition, an awards ceremony/competition, etc. The user interface can present, promote, and/or highlight content related to a customized theme and/or topic (e.g., a current or trending event, a current context, a content release event, a user preference, etc.), provide immersive and/or interactive content experiences, incorporate a particular visual appearance and/or attributes, invite users to interact with certain content and/or features, provide animations used to engage the user and/or help the user discover and/or understand any features and/or content available via the user interface, content and/or features associated with a user profile, customized avatars or profile images, etc.

To illustrate, if UI management system 130 determines that a trending movie is being released on a particular day, UI management system 130 can customize the user interface presented on that day (or an associated timeframe) based on the movie being released on that day. The user interface can include a theme related to the movie. The theme can promote merchandise related to the movie, highlight/promote and/or prioritize the movie and/or related content, offer users an option to engage in an interactive activity related to the movie, customize a user avatar or profile image based on the movie, customize a user/group profile based on the movie, offer a content experience associated with the movie, etc. For example, the user interface can implement a theme that includes attributes related to the movie (e.g., characters, imagery, visualizations, logos, thumbnails, symbols, backgrounds, etc.), content related to the movie (e.g., images, videos, thumbnails, text, audio, etc.), visual aesthetics/patterns based on the movie, interface elements related to and/or based on the movie, design characteristics depicting and/or related to the movie (e.g., related to a movie content, a movie character(s), a movie plot, a landmark or scene in the movie, an activity in the movie, a condition in the movie, visual attributes of the movie, an object in the movie, a movie context, etc.), hidden messages associated with the movie, artwork based on the movie, a background/backdrop based on the movie, animations based on the movie, avatars customized based on the movie, and/or other settings/content associated with the movie.

In this example, when users access the user interface, the users can correlate the user interface (and/or theme) with the movie, access the movie or content promoted or recommended based on the movie, interact with content from and/or related to the movie, engage in an interactive experience generated based on the movie, etc. The user interface can convey to users that the movie is a current/trending event and/or the movie was or is being released, highlight or provide content and/or activities/interactions relevant to the movie, promote merchandise associated with the movie, invoke feelings or a mood based on the movie, etc.

As another example, if a topic is trending (e.g., in social media, in the news, in current events, etc.) and/or is being promoted by an application/platform associated with the user interface, UI management system 130 can customize the user interface to incorporate content and/or features associated with that topic, tailor a theme of the user interface based on that topic, include attributes associated with that topic, promote or highlight content associated with that topic, provide activities and/or interactions associated with that topic, customize an appearance of the user interface based on that topic, customize a theme of the user interface based on the topic, etc. To illustrate, if the topic is basketball, UI management system 130 can customize the user interface based on a basketball theme. The user interface can depict basketball content and/or artwork, implement attributes related to basketball, promote basketball content and/or merchandise, display information about basketball and/or a basketball game or tournament, prioritize and/or suggest content related to basketball (e.g., basketball games, basketball media/TV channels, basketball applications, basketball movies, basketball social media content or posts, basketball documentaries, basketball videos, etc.), provide interactive content and/or activities related to basketball, display colors and/or imagery related to one or more basketball teams, provide access to basketball events or betting options, configure an interface element to depict or mirror basketball content (e.g., a scoreboard, a basketball, etc.), etc.

The user interface can additionally or alternatively incorporate a theme and/or features customized for a user. For example, referring back to the example of the user interface customized for a basketball theme, if a user is a fan of a basketball team, the user interface can include a theme based on that basketball team, such as the colors of the basketball team, any symbols or logos associated with that basketball team, a mascot of the basketball team, a city and/or state associated with the basketball team, a player(s) associated with the basketball team, a jersey associated with the basketball team, etc. UI management system 130 can obtain information about a user preference for that team from a user profile, a user input (e.g., an input providing such information, etc.), a user history, a user request, social media information associated with the user (e.g., social media posts, a social media profile, etc.), user photos and/or a photo library of the user made available by the user, previous user interactions and/or activity, stored user preferences, content (e.g., channels, shows, videos, etc.) and/or content categories (e.g., sports, basketball, etc.) designated as a favorite(s) by the user, and/or any other source of such information.

In some cases, UI management system 130 can configure the user interface to provide, highlight, promote, prioritize, and/or recommend information, content, interactions, and/or any activity associated with the basketball team of the user. For example, UI management system 130 can configure the user interface to display information about the basketball team, such as team statistics or a team history, promote content and/or merchandise associated with the basketball team, highlight videos associated with the basketball team (e.g., previous games, game highlights, team reels, player highlights, historical highlights, etc.), offer an interactive activity associated with the basketball team (e.g., an offer to bet on the basketball team, an activity to create a starting lineup, an activity to predict or select a particular play during the game such as a dunk, a video game including that basketball team, an interaction with other users involving the basketball team, a prediction of a player statistics, etc.), etc.

In some aspects, UI management system 130 can configure a user interface to continue to implement a theme across sessions, interface pages and/or spaces, user interface experiences, etc. For example, UI management system 130 can configure the user interface to implement a theme on a particular day and continue implementing the theme on that particular day (and optionally on one or more subsequent days) across user interface screens, content, pages, sections, sessions, experiences, etc., until a user session (or multiple user sessions) ends, until a timeframe ends, until another theme is selected/implemented, etc. To illustrate, if UI management system 130 configures the user interface to implement a theme related to a trending game show, the user interface can incorporate that theme in a home, landing, and/or welcome page of the user interface. If the user navigates to a different page or section of the user interface, the different page or section of the user interface can also incorporate the theme (and/or aspects thereof) or an updated version of the theme. As the user interacts with the user interface, the user interface can persist the theme (and/or aspects thereof) across the user interactions or update the theme to depict a continuous and/or progressively changing theme. If the user wants the user interface to stop implementing the theme or switch to a different theme, the user can optionally provide a user input requesting that the user interface switches to a different theme or configured to change the theme. When the user accesses the user interface on a different day, if there is a different theme selected on that day (e.g., based on a topic that is temporally relevant on that day, being promoted on that day, selected for that day, etc.), the user interface can incorporate a different theme on that day. This way, the user interface can adapt to user interests/preferences, temporal information, events, contexts, trends, content experiences, locations, etc.

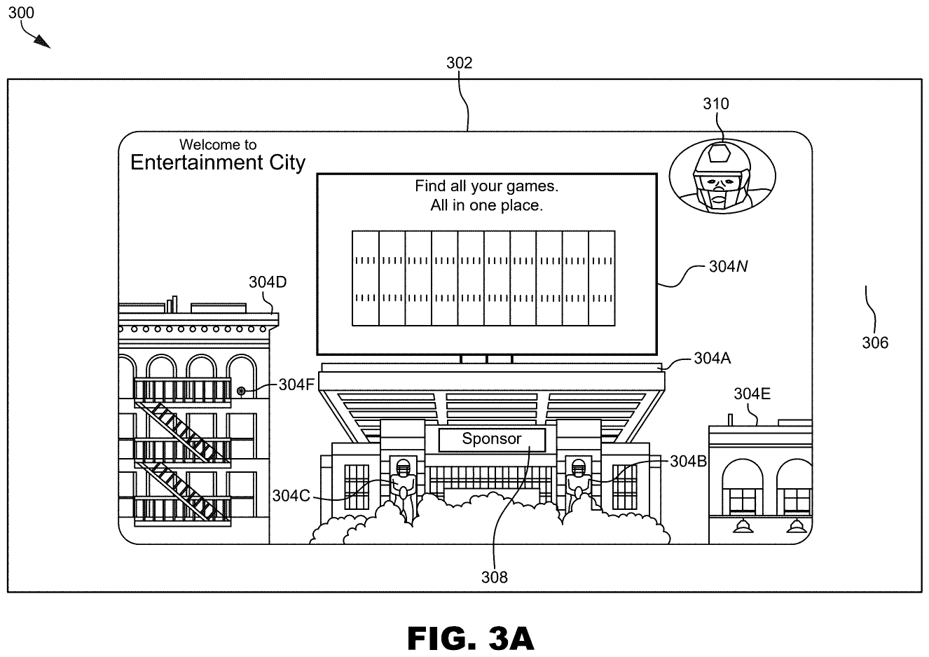

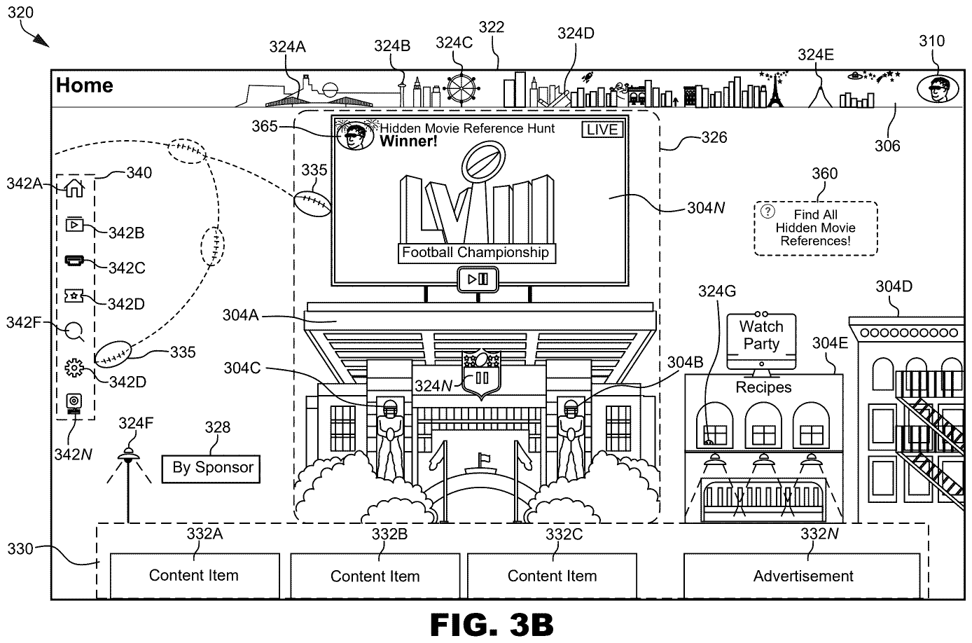

FIG. 3A illustrates an example of a user interface 300 customized based on a selected theme. The user interface 300 can be used to access, navigate (e.g., search, find, browse, etc.), consume (e.g., watch/view, play, stream, display, etc.), interact with, and manage content (e.g., media content, etc.), access and engage in media content experiences, etc. The user interface 300 can display and/or include content (e.g., media content, interactive content, interface content, etc.) and a theme selected for the user interface 300, as further described herein. The user interface 300 can also include a backdrop 306. The backdrop 306 can include a background, wallpaper, a page with visualizations/artwork, and/or screensaver, which may or may not be animated (and/or include animated content). The backdrop 306 can be theme-based (e.g., can implement a theme and/or features selected and/or configured based on a theme).

The user interface 300 can display, include, and/or represent an interface page, window, screen, section, area, library, and/or section that includes and/or displays content, features, activities, interface elements, visual elements, etc. In some examples, the user interface 300 can be used to access and/or navigate content (e.g., media content, interactive content, immersive content, static content, dynamic content, etc.), access content experiences/activities (e.g., interactive experiences, games, interactive experiences, etc.), etc. The content included in, displayed by, and/or available from the user interface 300 can include, for example and without limitation, one or more movies, TV shows, podcasts, videos, broadcasts, live content (e.g., live TV, livestreams, live video feeds, etc.), content channels, audio content, media content applications, artwork, content libraries and/or catalogs, video games, interactive content, dynamic content, suggested content, application content, and/or any other content. The user interface 300 can also include and/or depict a scene or a representation of a scene, which may or may not be based on a theme or incorporate one or more aspects of a theme. For example, in FIG. 3A, the user interface 300 includes an interface section 302 that includes, depicts, and/or represents a city scene associated with a media platform or application corresponding to the user interface 300.

In some examples, the user interface 300 can be part of, implemented by, rendered by/for, and/or associated with a media platform. The media platform can include a software application/platform used to access, interact with, stream, navigate (e.g., search, find, browse, etc.), engage with, load, and/or consume (e.g., view, play, etc.) content, such as media content, and/or content experiences. For example, the media platform can include a streaming platform or application, a media player application, a media center application, a home theater application, a media/entertainment application, a media content service application or platform, a media library, a media portal, a video game application, a digital set-top box or player, a television software or framework, a media content suite, an electronic programming guide (EPG) portal, a multimedia software interface, etc.

In some cases, the user interface 300 can include, represent, and/or display a home page, a welcome page (e.g., a page rendered or loaded before the user(s) 140 transitions to another page or interface section, such as a media content page, section, portal, or home), or any other page of the media platform or application associated with the user interface 300. As shown, the user interface 300 and/or backdrop 306 can implement a theme(s). The theme(s) can be selected, generated, customized, and/or configured based on one or more topics selected based on one or more signals. The one or more signals can include, for example and without limitation, a user preference, an event (e.g., a current event, a trending event, a competition, a content release event, a promotional event, a game, a show, a news event, etc.), a context (e.g., a current context such as a current location of the user(s) 140 and/or a device displaying the user interface 300, a media content experience, a streaming context, a context of a user session, a date and/or time, a location, a user context, a device context, a season, an environment, an activity, etc.), a user and/or group characteristic (e.g., a demographic, a user or group location, a user or group history, etc.), group data (e.g., a group preference, a group statistic, a group trend, etc.), a trend (e.g., social media trend, regional trend, cultural trend, popular trend, etc.), social media data, content statistics, historical data (e.g., content consumption data, historical input data, historical interactions, etc.), a pattern (e.g., a content pattern, a usage pattern, etc.), promotional data (e.g., promotional preferences, promotional campaigns, promotional priorities and/or rankings, promotional content, etc.), current and/or previous sessions and/or activity, temporal information, user and/or group activity, device characteristics, etc.

The theme(s) can include, depict, and/or implement visual elements 304A-N (collectively referred to as “visual elements 304” hereinafter) and the backdrop 306. The visual elements 304 and/or the backdrop 306 can be selected, customized, generated, and/or configured based on the theme(s). For example, the visual elements 304 and/or the backdrop 306 can be related and/or relevant to (e.g., having a threshold relevance to) the theme(s) and/or designed to convey the theme(s) and/or aspects of thereof. To illustrate, the visual elements 304 and/or the backdrop 306 can include, depict, provide, and/or represent content and/or a content experience(s) associated with the theme(s), such as artwork (e.g., imagery, visualizations, representations, etc.), a design, a color(s), a pattern(s), an object(s), a video(s), a character(s), an image(s), an icon(s) and/or thumbnail(s), an option(s), an interface element(s), a content item(s), a content behavior(s), a content tile(s), a design element(s), an animation(s), a game(s), an activity/activities, text, audio, and/or any other text, audio, and/or visual content associated with the theme(s).

As previously noted, in FIG. 3, user interface 300 and backdrop 306 include a city theme. The user interface 300 also includes a sports theme, which in FIG. 3 is a football theme. The city theme and football theme are depicted or conveyed through the visual elements 304 (and optionally through the backdrop 306). For example, the visual elements 304 can include artwork, text, objects, interface elements, content experiences, animations, and/or visual elements (e.g., objects, buildings, imagery, characters, structures, landmarks/landscapes, designs, views, etc.) depicting city, a city environment, a portion and/or view of a city, football imagery, football players or characters, football buildings/structures (e.g., a stadium, a field, etc.), football objects, football symbols, football teams, football information, football team colors, etc.

In some examples, the visual elements 304 together can convey the theme(s) (e.g., the city and football themes), such as visual elements associated with the theme(s), an associated mood, an associated scene and/or atmosphere (e.g., a city and/or football scene and/or atmosphere). To illustrate, the visual element 304A depicts a football stadium, the visual elements 304B-C depict football players or characters (e.g., images of one or more real football players, fake or computer-generated football players, football player avatars, football player icons, football player characters, football player representations, etc.), the visual elements 304D-E depict city buildings, and the visual element 304N depicts a display (e.g., a television, a projection, a screen, a billboard, a display surface, etc.) depicting football-related content, such as a football field, a football image, a football video, a football game, a football promotion, a football trailer, a football thumbnail, football artwork, a football game, interactive football content, etc.

The user interface 300 and/or backdrop 306 can optionally include one or more promotional content items, such as promotional content, merchandise, a sponsor, etc. For example, in FIG. 3A, the user interface 300 includes a promotional content item 308 identifying a sponsor and/or content associated with a sponsor (e.g., a logo, a sign, an advertisement, a trademark, etc.), such as a sponsor of the backdrop 306, a sponsor of a content of any of the visual elements 304, a sponsor of the display depicted by the visual element 304N, a content of the user interface 300, and/or content accessible via the user interface 300. In some cases, the promotional content item 308 can include an interactive content item, such as a button or link to content or a product(s) associated with the promotional content item, an interactive element that the user(s) 140 can use to access an item associated with the sponsor (e.g., a page, merchandise, a product or service, information, an activity, a game, etc.), a content experience sponsored by the sponsor, content associated with the sponsor, etc. In some cases, the user interface 300 and/or the backdrop 306 can include hidden messages (also referred to as “easter eggs” herein), such as references from or clues about a content item (e.g., a movie, TV show, video game, application, channel, etc.) and/or a feature of the content item (e.g., an activity, an object, a character, a building, an animal, an animation, a scene, etc.), content (e.g., artwork, images, animations, icons, visual elements, etc.) depicting or conveying a message or a reference/clue associated with a content item (e.g., an object, a building, a landscape, a scene, a character, a symbol, a background, a view, a structure, an environment, a condition, etc.). etc.

For example, in FIG. 3A, the visual element 304D includes a city building from a particular movie. Thus, the visual element 304D is a reference to or clue about the city building from that movie. A window of the city building (visual element 304D) includes a visual element 304F that depicts a graphic representing a reference to or clue from another movie. Some users may recognize the city building depicted by the visual element 304D as a specific city building from the particular movie, and the graphic depicted by the visual element 304F in the window of the city building as a graphic (e.g., object, character, etc.) from the other movie. Thus, the visual elements 304D and 304F represent hidden messages, clues, or references to the movies associated with the city building and the graphic.

Similarly, the visual element 304E depicts a building representing a barbershop from a movie, which some users may recognize as the barbershop in that movie. Accordingly, the visual element 304E represents a hidden message, clue, or reference to the barbershop from that movie.

The visual element 304A depicts a football stadium. In some cases, the football stadium can represent a reference to a football stadium from a particular content item (e.g., movie, TV show, game, video game, image, animation, etc.), which some users may recognize as the football stadium from that particular content item. The visual elements 304B-C can depict football players or characters. The football players or characters can be fictitious football players or characters, real football players or characters, or football players or characters from a content item (e.g., references to football players from a content item).

In some cases, the backdrop 306 can include one or more interactive interface elements that the user(s) 140 can use to interact with content or access dynamic content. For example, the display depicted by the visual element 304N can include an interactive image or video that the user(s) 140 can select or click to initiate a football video, trailer, and/or interactive experience such as a football activity, interactive game, video game, etc. In some examples, the interactive experience can include a game such as a trivia game or an animated game or activity.

In some cases, the user interface 300 may enable the user(s) 140 to interact with content or engage in interactive experiences provided by any content and/or elements of the user interface 300, such as the visual element 304N. For example, when the visual element 304N is selected/activated, the visual element 304N can initiate a video that the user(s) 140 can interact with or that is part of an interactive experience. To illustrate, the display depicted by the visual element 304N can play a video such as a trailer, movie, livestream, a game, a hidden message/clue within the video or a portion thereof, activity, etc. The user(s) 140 can optionally engage with the content of the video. In some examples, the user(s) 140 can also engage in an interactive experience where the user(s) 140 can look for a hidden message/clue in the video, such as a hidden reference to a movie or TV show. If the user(s) 140 finds the hidden message/clue, the user(s) 140 can optionally submit an input identifying the hidden message/clue or indicating that the user(s) 140 found the hidden message/clue. In response to finding the hidden message/clue, the user(s) 140 can optionally receive a benefit (e.g., a credit, a discount, a subscription or subscription reward, a point redeemable in some way, a digital trophy, recognition, an award, a monetary benefit, a score, an add-on, a rank, a recognition within user interfaces displayed on other user devices, etc.) or the user interface 300 can provide additional content or modify the user experience associated with the video (e.g., show additional portions of the video, show an additional video, customize the video accordingly, overlay content such as a recognition over the video, add more clues in the video or increase the difficulty of clues, etc.).

In some examples, an interface element(s) optionally included in the user interface 300 and/or backdrop 306 can include a personalized element. For example, if the user interface 300 and/or backdrop 306 incorporates a football theme, the football theme can be personalized to include content from the user(s) 140 (e.g., a video, a social media post, etc.), content representing or showing the user(s) 140 (e.g., the visual representation or avatar), content of interest to the user(s) 140 (e.g., content showing a team of the user(s) 140), content showing the user(s) 140 in an activity (e.g., playing football, etc.). This way, the user interface 300 and/or backdrop 306 can incorporate a football theme that is further personalized for the user(s) 140.

The football theme can be based on a topic (e.g., a football topic) selected for the user interface 300 and/or the backdrop 306. The topic (and thus the football theme) can be selected based on one or more signals, as previously explained. For example, the topic can include a football topic selected based on a relevance, popularity, and/or preference associated with the football topic (and thus the football theme) with respect to a temporal (e.g., a date, timeframe, day, time, season, etc.) cue (e.g., a relationship between a current or specific date and/or time a date of a football game, event, topic, content item, etc.), a context (e.g., a user context, a device context, a location, an environment or scene, a condition, a situation, etc.), an event (e.g., a current event, a release of content associated with football, a football game, a football championship, a football-related news event, etc.), a trend (e.g., a trending football topic, a trending football activity, a trending football game, trending football content, etc.), a user and/or group preference, a user location and/or characteristic, a location and/or device type of a device used to display the user interface 300, a user statistic and/or history (e.g., a content consumption history, a content preference history, etc.), a content pattern (e.g., a content pattern of a user or group, a content pattern associated with football content, etc.), calendar data, social media connections, platform data (e.g., a promotion, a weight associated with the football topic/theme, a rank or priority for the football topic/theme, an input from a user or device associated with the platform, business preferences, etc.), a rule or filter, a user input, and/or any other cue(s).

For example, assume that the user interface 300 is displayed on a day of a football game/championship, a day within a football season, within a timeframe with respect to a football game/championship or event (e.g., within a time period relative to a football game, within a football championship week, within a college or professional football season or playoffs, etc.), on football Sunday or Monday, on a day that football is trending (e.g., based on posts in social media, etc.), a release date of a football video (e.g., movie, documentary, show, etc.), or on a particular day associated with football and/or a football event. Accordingly, based on such information, UI management system 130 may determine that football is a temporally relevant or trending topic. UI management system 130 can select the football theme based on the determination that football is a temporally relevant or trending topic when the user interface 300 is displayed. UI management system 130 can then configure the user interface 300 and/or backdrop 306 to implement the football theme.

The user interface 300 and/or the backdrop 306 can optionally include other interface elements. For example, the user interface 300 and/or backdrop 306 can optionally include a user avatar 310 associated with the user(s) 140. The user avatar 310 can include a real or fake image or visual representation of the user(s) 140. The user avatar 310 can be used as a profile image of the user(s) 140. In some cases, the user avatar 310 can include or be based on an image of the user(s) 140, such as a picture of the user(s) 140 uploaded, selected, and/or shared by user(s) 140. For example, user avatar 310 can include an image of the user(s) 140 customized by UI management system 130 (e.g., by an AI/ML model of UI management system 130) or an image generated by UI management system 130 (e.g., via the AI/ML model) based on information associated with the user(s) 140, such as an image, a description of the user(s) 140, etc.

An avatar (e.g., a user avatar, a group avatar, etc.) can include any visual representation of a user or group of users associated with the avatar (e.g., a real picture, an image generated by an AI/ML model(s) of UI management system 130 such as a synthetic image, an image generated by the AI/ML model(s) of UI management system 130 based on a real picture such as a real picture modified by the AI/ML model(s), a graphic representing or depicting the user or group such as a cartoonized image of the user or group, etc.). Moreover, an avatar can include or be used as a profile image. For example, if the user(s) 140 has a user profile, the user avatar 310 can include or be used as a profile image associated with the user profile. If a user group has a group/shared profile, the group/shared profile can include a user avatar of the users, which can include or be used as a profile image for the group/shared profile. The profile image can include any visual representation of a user or group, as previously noted with respect to an avatar.

In some examples, the user(s) 140 can navigate away from user interface 300 to access another user interface page, window, screen, area, or section, such as an interface page where the user(s) 140 can access content or experiences to watch or interact with, such as movies, TV shows, live feeds, broadcasts, TV channels, video games, etc. In some cases, if the user(s) 140 navigates to another destination, the other destination can implement a different theme(s) and/or can retain any theme (or aspects thereof) of user interface 300 to maintain a consistent theme and navigation experience across different destinations/experiences.

For example, if the user(s) 140 navigates to the page in FIG. 3B, the page 322 can incorporate attributes (e.g., artwork, colors, patterns, content, etc.) of the theme(s) associated with the user interface 300 (e.g., the football theme and/or the city theme). In some examples, if the page 322 (or any other section/page) incorporates a theme(s), such as the football theme (or aspects thereof), the page 322 can optionally include, highlight, prioritize, recommend, and/or promote content related to the theme(s) (e.g., of the football theme or a different theme) such as, for example and without limitation, videos, movies, shows, channels, games, advertisements, interactive content, games, and/or any other content associated with the theme(s).

FIG. 3B illustrates another example of a customized user interface 320 implementing a theme and associated content. In this example, the user interface 320 depicts and/or represents a page 322 of a media platform. The page 322 can be displayed when the media platform associated with the user interface 320 is loaded or after another user interface associated with the media platform, such as after the user interface 300 shown in FIG. 3A. For example, the user(s) 140 can transition from the user interface 300 shown in FIG. 3A to the user interface 320 displaying page 322.

In some cases, user interface 320 and/or page 322 can implement a theme(s) and/or retain a theme(s) associated with the user interface 300 shown in FIG. 3A. For example, the user interface 320 can include visual attributes (e.g., artwork, color, color scheme, pattern, appearance, visual elements, content, interface elements, design, style, etc.), a topic (e.g., sports, football, a holiday, an event, etc.), a content experience (e.g., content interaction, animation, activity, game, etc.), a content item(s), a behavior, and/or any features associated with the football theme and/or city theme of the user interface 300 shown in FIG. 3A. In some examples, a user interface theme, content experience, and/or appearance can vary or remain consistent (e.g., same or with a threshold similarity or relevance) across user interfaces, interface pages, interface spaces, interface sections, content areas, etc. For example, the user interface 320 and/or page 322 can include a football theme like the user interface 300 in FIG. 3A. The user interface 320 and/or page 322 can additionally or alternatively maintain a similar or consistent appearance (e.g., a consistent color, color theme, background/backdrop, artwork, visual elements, etc.) as the user interface 300 in FIG. 3A.

The user interface 320 can include a backdrop 306. The backdrop 306 can include visual attributes such as a background color, a color scheme or pattern, artwork, imagery, content, objects, interface elements, visual elements, etc. The visual attributes can optionally be based on one or more themes associated with the user interface 320, such as the football theme and/or the city theme.

As shown in this example, the user interface 320 and page 322 include a football theme and a city theme. The football and city themes are depicted or conveyed in the page 322 via visual elements 304A-E and optionally via additional visual elements 324A-N (collectively referred to as “visual elements 324” hereinafter). To convey the football and city themes, the visual elements 304A-E can include artwork, images, content, hidden references or clues, animations, content, interface elements, and/or visual attributes associated with the football and city themes. Additionally, some or all of the visual elements 324 can optionally include, depict, or convey aspects of the football theme and/or the city theme. In some cases, some or all of the visual elements 324 can include hidden messages, such as hidden references to one or more respective content items (e.g., movies, TV shows, etc.).

For example, the visual elements 324 can be part of the city and/or football theme implemented by user interface 320. The visual elements that are part of the city theme can include city elements such as city buildings, city bridges, city structures, a cityscape, a city landmark, etc. The visual elements that are part of the football theme can include football-related elements such as football artwork, images, content, colors, logos, etc. In some cases, any of the visual elements 324 can include a reference from a content item, such as a movie or TV show, and can represent a hidden message or clue associated with the content item. For example, visual element 324A depicts a bridge from a movie and is part of the city theme, visual element 324B depicts a building from a movie and is part of the city theme, visual element 324C depicts a Ferris wheel from a movie and is part of the city theme, visual element 324D depicts a sinking boat from a movie and is part of the city theme, visual element 324E depicts a volcano from a movie and is part of the city theme, visual element 324F depicts a lamp post from a movie and is part of the city theme, visual element 324G depicts a graphic from a movie and is part of the city theme, visual element 324N depicts a football logo and is part of the football theme, visual elements 304A-C depict football-related items and are part of the football theme, visual element 304D depicts a building from a movie, visual element 304E depicts a barbershop from a movie, and visual element 304N depicts a display with football content.

The visual elements depicting content from a content item (e.g., the bridge depicted by visual element 324A, the building depicted by visual element 324B, the Ferris wheel depicted by visual element 324C, the sinking boat depicted by visual element 324D, the volcano depicted by visual element 324E, the lamp post depicted by visual element 324F, the graphic depicted by visual element 324G, the building depicted by visual element 304D, the barbershop depicted by visual element 304E) can include references to respective content items (e.g., movies, TV shows, etc.) that represent hidden messages or clues associated with the respective content items. The hidden messages or clues can engage the user(s) 140 and help provide a more immersive and/or delightful experience for the user(s) 140. For example, the user(s) 140 can try to find the hidden messages or clues as a fun challenge or game, as part of an interactive experience such as a scavenger hunt, or any other activity, game, or content experience.

In some cases where hidden messages or clues in the user interface 320 are gamified, if the user(s) 140 finds the hidden messages or clues (or a subset thereof) and identifies the sources/references associated with such hidden messages or clues, the user(s) 140 can provide an input via the user interface 320 identifying the hidden messages or clues, and can obtain a benefit for accurately identifying the hidden messages or clues (e.g., identifying all hidden messages or clues in the user interface 320 or a threshold number or percentage) such as an add-on to the user avatar 310, a content credit, a free content item, a subscription or upgrade, a promotion of the user(s) 140 in other user interfaces associated with the media platform displayed by other user devices, a recognition of the user(s) 140 with respect to other users, a recognition of the user(s) 140 or inclusion of a representation of the user(s) 140 in other user interfaces and/or themes (and/or within the city theme or the football theme depicted by the user interface 320), a discount or coupon, points, an option to select or suggest a theme or content implemented or promoted/highlighted in user interfaces presented to other users, and/or any other reward or benefit. For example, the user interface 320 can include a prompt 360 challenging the user(s) 140 to find all the hidden movie references in the user interface 320. The user(s) 140 can provide an input identifying any hidden movie references found by the user(s) 140. In some cases, the user(s) 140 can click on the prompt 360 to input the hidden movie references found by the user(s) 140.

In some cases, a hidden message or clue (e.g., hidden reference to content) can be placed somewhere within the user interface 320 intended to drive the user to explore that portion of the user interface 320 and/or any content or features associated with that portion of the user interface 320. For example, a hidden message or clue can be placed or hidden on, within, or adjacent to a content item that the media platform associated with the user interface 320 wants to promote to the user(s) 140 (e.g., wants the user(s) 140 to explore or watch), a content section that the media platform wants to drive the user(s) 140 to explore, a feature such as a control/setting or functionality that the media platform wants the user(s) 140 to explore or learn, etc. This way, hidden messages can be used to steer the user(s) 140 to or incentivize the user(s) 140 to learn and/or explore certain content, features, functionalities, controls/settings, content sections, etc.

The user interface 320 can include an interactive section 326. In this example, the interactive section 326 includes a display depicted by the interface element 304N that is used to show content related to a theme, such as content related to the football theme. The content can include, for example, a video, a video game, an image, a content experience, an XR experience, an activity, a link to content or a content experience, etc. In some cases, the user(s) 140 can select the display depicted by the visual element 304N to watch football content, such as a football game. The display depicted by the interface element 304N can optionally display other content. For example, the display depicted by the interface element 304N can display a message notifying the user(s) 140 that the user interface 320 includes a scavenger hunt with hidden movie references or identifying the user(s) 140 as the winner of the scavenger hunt. In some cases, the display depicted by the interface element 304N can include a customized user avatar 365 depicting a representation of the user(s) 140. The user avatar 365 can be depicted in the display shown in the user interface 320 presented to the user(s) 140 and optionally the display show in the user interface presented to other users, to recognize the user(s) 140 as the winner of the scavenger hunt.

In some cases, the football theme can be carried over from the user interface 300 and/or backdrop 306 in FIG. 3A to the page 322. The football theme can be selected for the user interface 300 and page 322 based on one or more signals, such as a temporal signal, a context, an event, a trend, a user preference, a group preference, a location, a business preference, a rule or filter, a user profile, a user history, content statistics, a promotion or campaign, a user input, a weight(s) defined by the media platform, a priority, a calendar, social media data, news data, etc. For example, if the page 322 is displayed on a day or week (or any other time window) of a football championship, the page 322 can include a football or football championship theme given a temporal relevance, popularity, trending statistic, and/or promotion of the football championship (and thus football) when the page 322 is displayed.

The page 322 can optionally include or depict any other content. For example, the page 322 can include an advertisement 328 associated with a product/service, brand, business, content, entity, sponsor, etc. The page 322 can include a content section 330 that includes content items 332A-N (collectively “332” hereinafter) such as movies, TV shows, channels, media applications, video games, videos, advertisements, podcasts, images, audio or music items, audiobooks, etc. In some examples, the content items 332 can include content items from a particular category, such as recommended content, recently-accessed content, content of a certain genre, content from a certain producer, content of a certain type, content of a certain popularity or rating, content personalized for the user(s) 140, etc. In some cases, the user(s) 140 can navigate the content section 330 for specific content, content categories, content libraries, content channels, content applications, etc.

In some examples, the content section 330 can highlight, prioritize, promote, and/or include content related to a theme(s) or topic(s) associated with the page 322. For example, if the page 322 includes a football theme, the content section 330 can highlight, prioritize, and/or promote content related to football. The content section 330 can additionally or alternatively include other content, content categories, topics, libraries, etc.

Page 322 can optionally include menu 340. The menu 340 can include menu items 342A-N, such as a navigation menu that the user(s) 140 can use to navigate to specific content and/or spaces (e.g., sections, interfaces, pages, destinations, etc.), a menu for certain content and/or content categories, a settings menu, a search menu, a display menu, a tools menu, etc.

In some examples, the user interface 320 can display animated content used to increase a user appeal, steer the user(s) 140 to certain items (e.g., content, spaces, features, tools, menus, etc.), incentivize the user(s) 140 to explore certain items, help the user discover certain items, and/or teach the user(s) 140 certain features. The animated content can relate to a theme of the user interface 320 or can be separate from any theme of the user interface 320. For example, in FIG. 3B, the user interface 320 depicts an animation of a football 335. In this example, the animation of the football 335 relates to the football theme. The animation of the football 335 can show the football 335 moving towards and landing or crashing into something that the media platform wants to promote to the user(s) 140, steer the user(s) 140 to, drive the user(s) 140 to explore or discover, or teach the user(s) 140. For example, the football 335 can move across a portion of the user interface 320 and land or crash on the display depicted by the visual element 304N in order to bring the attention of the user(s) 140 to the content available via the display or steer the user(s) 140 to such content. As another example, the football 335 can move about a portion of the user interface 320 and land or crash on menu item 342D to steer the user(s) 140 to the menu item 342D in order to promote the menu item 342D, drive the user(s) 140 to explore the menu item 342D, or drive the user(s) 140 to select the menu item 342D to teach the user(s) 140 a feature(s) accessible through the menu item 342D or how to use or configure the menu item 342D.

The user interface 320 can optionally include the user avatar 310. In some examples, the user avatar 310 depicted in the user interface 320 can be customized, personalized, and/or configured to depict certain visual attributes based on a theme, content, and/or experience associated with the user interface 320.

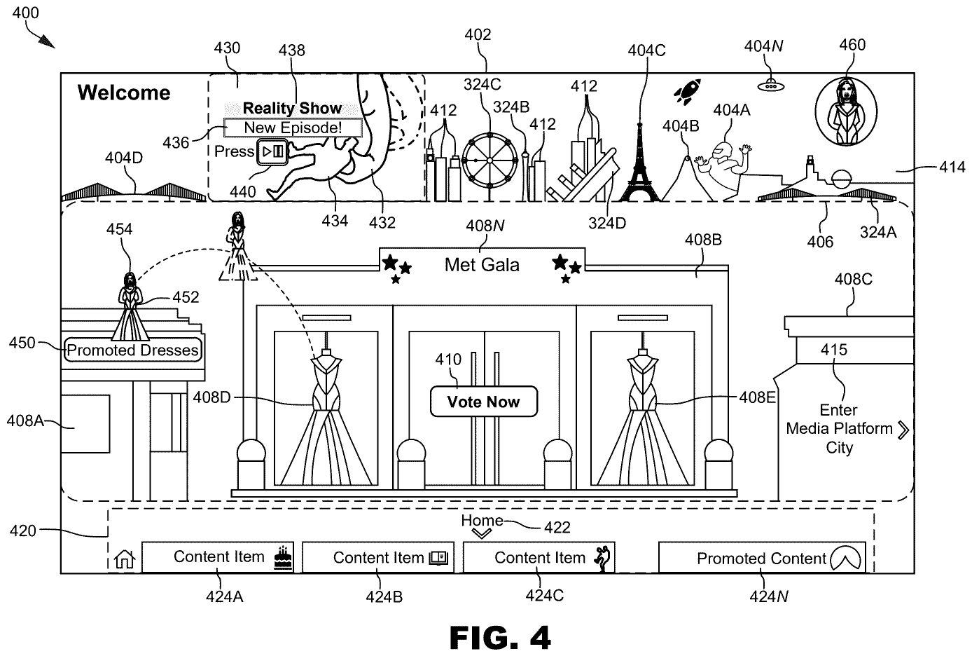

FIG. 4 illustrates another example of a user interface 400 configured with a theme, according to some examples of the present disclosure. The user interface 400 can display a page 402 used to display content associated with a content platform. The content platform can be associated with or can include, host, and/or implement a software application(s), infrastructure(s), and/or environment associated with one or more media content services, TVs (and/or TV platforms, operating systems, applications, environments, etc.), media players, content servers, media entertainment systems, streaming services, content providers, media channels, set-top boxes, online media services or platforms, media receivers, broadcast receivers, linear content services/channels, digital media devices, and/or any other media content application, source, and/or software. The user(s) 140 can use the user interface 400 to consume (e.g., view/watch, access, play/replay, stream, display/render, etc.), navigate, interact with, and/or engage with any content, content experience, and/or features associated with the page 402 and the content platform.

The page 402 can include a section 406 of content. The content can include static content, dynamic content, animated content, image content, video content, theme-based content, video game content, interactive content, visual elements, interface elements, and/or any other content. The page 402 can optionally include one or more other sections, as further described herein.

The page 402 can include a background 414. The background 414 can include features such as one or more images, videos, colors, color schemes, patterns, interface elements, content items, visualizations, visual effects, attributes, animations, content item references, screensavers, etc. For example, the background 414 can include a backdrop, screensaver, background image, artwork, color, color pattern, graphics content, animation(s), pattern(s), logo(s), visual element(s), visual effect(s), content item(s), and/or any other content and/or attribute.

The user interface 400, page 402 and/or background 414 can include, depict, and/or be customized based on a theme(s). The theme(s) can be associated with a topic(s). For example, the theme(s) can be selected or determined based on one or more topics. The topic(s) used to determine or select the theme(s) can be selected/determined based on one or more signals. The one or more signals can include and/or indicate, for example and without limitation, a context, a temporal cue, an event, a user preference, a season, a trend, calendar data, a promotion or campaign, a location, a news event, a current event, an activity, a situation, a release date (e.g., a content release date, etc.), an announcement or event date (e.g. a tournament date, an announcement of a winner of a competition/award or event, etc.), a media content interaction(s) (and/or statistics thereof), a content pattern or statistic, a content history associated with the user(s) 140 or a household, a condition, a rule or filter, a weight, a user input, social media data, historical data, a business decision, and/or any other signal.

In some examples, the user interface 400 and/or background 414 can be configured based on a same or different theme(s) (e.g., can implement a same or different theme(s) or aspects thereof). In FIG. 4, the theme(s) includes a city theme and a Met Gala theme. The city theme is at least partly implemented and/or depicted via visual elements 412. The visual elements 412 can depict features from a city, such as city buildings and other city elements (e.g., other elements of one or more specific cities and/or one or more general cities), and thus convey and/or form part of the city theme. The theme(s) can optionally include or depict one or more other themes.

The Met Gala theme includes a theme selected based on a topic associated with a content item (e.g., TV show, movie, video game, etc.) and/or event about, related to, and/or associated with a Met Gala, such as a Met Gala show. The Met Gala theme in this example is at least partly implemented and/or depicted via visual elements 408A-N (collectively “visual elements 408” hereinafter). The visual elements 408 depict features of, from, and/or associated with the Met Gala topic and/or event, and thus convey and/or form part of the Met Gala theme. The features of, from, and/or associated with the Met Gala topic and/or event depicted by the visual elements 408 and used to convey and/or implement the Met Gala theme (or aspects thereof) can include, depict, and/or represent one or more content items, colors, interface elements, visualizations, visualization effects, background elements, animations, attributes, items, graphics, objects, characters, images, renderings, buildings, artwork, and/or details associated with the Met Gala topic, event, and/or theme. Thus, the visual elements 408 can be part of and/or can convey, depict, and/or be configured according to the Met Gala theme.

For example, the visual elements 408A-N can depict, convey, and/or represent one or more buildings, dresses, symbols, messages, graphics, backgrounds, characters, attributes, colors, symbols, visualizations, visual effects, interface elements, promotions, content items, details, and/or artwork associated with the Met Gala topic, event, and/or TV show. In FIG. 4, the visual elements 408A-C depict or represent buildings from or associated with a Met Gala TV show, visual elements 408D-E depict or represent dresses from or associated with the Met Gala TV show (e.g., Met Gala dresses and/or dresses selected for the Met Gala theme), and visual element 408N displays the message “Met Gala”, which is used to promote the Met Gala topic and/or TV show and/or indicate that the building depicted or represented by the visual element 408B is a Met Gala building, a building from or associated with the Met Gala TV show, or a building named Met Gala.

Any of the buildings depicted or represented by the visual elements 408A-C can be used to depict one or more features associated with any of the themes of the user interface 400. For example, in FIG. 4, the building depicted or represented by the visual element 408A includes a content item 450 promoting dresses associated with the Met Gala topic and/or theme, such as Met Gala dresses promoted for sale, and the building depicted or represented by the visual element 408B includes the visual element 408N associated with the Met Gala theme, which as previously explained displays the “Met Gala” message, and an interface element 410 associated with the Met Gala theme. The interface element 410 can include a visual element, static element, interactive element, dynamic element, theme-based element, navigation element, input element, object, link, and/or any other element associated with the Met Gala theme.

In FIG. 4, the interface element 410 includes an input or interactive element that the user(s) 140 can select or activate to submit a vote associated with the Met Gala theme, such as a vote for a content item, character, dress, object, participant, TV show, TV episode, personality, movie, feature, promotion, activity, scene, and/or item associated with the Met Gala theme. For example, the user(s) 140 can select the interface element 410 to vote on clothing (e.g., a dress, an outfit, etc.), a participant, a character, an object, an activity (e.g., a challenge), a participant question, a participant challenge, or an episode of a Met Gala TV show associated with the Met Gala theme (and/or any other associated content).

The user(s) 140 can select the interface element 410 (and/or another interface element on the user interface 400) to access, load/initiate, play, or interact with content and/or a content experience associated with the Met Gala theme. For example, the interface element 410 can include an interactive/selectable element (e.g., a button, link, anchor, control, etc.) that the user(s) 140 can use to (e.g., via an input selecting or activating the interface element 410) to play or stream a content item associated with the Met Gala theme (e.g., a Met Gala content item such as a Met Gala movie, TV show, video game, etc.), purchase a product (e.g., a dress, ticket, subscription, content, object, etc.) associated with the Met Gala theme (e.g., a Met Gala product), access Met Gala content, access information about a Met Gala event or content (e.g., Met Gala products, episodes, participants, statistics, history, etc.), access an activity or interaction related to the Met Gala theme (e.g., a bet, game, content experience, etc.), display a visual rendering associated with the Met Gala theme, perform a transaction associated with the Met Gala theme, etc.

In some cases, any of the buildings depicted or represented by the visual elements 408A-C can additionally or alternatively include, promote, initiate, trigger, and/or convey other content, features, and/or themes. For example, the building depicted or represented by the visual element 408C can include a navigation element 415. The user(s) 140 can use the navigation element 415 (e.g., by selecting or activating the navigation element 415) to navigate to another destination, which may or may not include or relate to a theme(s) of the user interface 400, such as another interface, space, scene, experience, screen, location, content, etc. To illustrate, in the example shown in FIG. 4, when the navigation element 415 is selected or activated, the user interface 400 can transition to a destination that includes, represents, mimics, mirrors, depicts, and/or conveys a city theme (e.g., the city theme of user interface 400, a different city theme, a version of the city theme of user interface 400 such as a modified or updated version, and/or a similar city theme). The destination can include another interface, space, scene, experience, screen, page, and/or rendering, such as a page depicting or representing a content city associated with a content platform (e.g., a content platform associated with the user interface 400).

As previously noted, the Met Gala theme of the user interface 400 can be determined and/or selected based on a Met Gala topic. In some examples, the Met Gala theme of the user interface 400 can be selected or implemented based on a determination that the Met Gala topic is a relevant topic (e.g., temporally relevant, contextually relevant, relevant to the user(s) 140, relevant to an event, relevant to preference of the user(s) 140 (or a preference of a user group, a business, a sponsor, or a content platform associated with the user interface 400), relevant to a content release date or event, relevant to a business or sponsor, relevant to a content platform associated with the user interface 400, relevant to a cue or condition, relevant to a trend or statistic, relevant to a content or an advertisement campaign, relevant to a promotion, relevant to a region or culture, etc.), a prioritized or promoted topic, a preferred topic (e.g., preferred by the user(s) 140, a user group, a business, a sponsor, a content platform associated with the user interface 400, etc.), a sponsored topic, a topic associated with a paid sponsor, a topic matching a rule or criterion, etc.

In some cases, the Met Gala topic can be associated with a Met Gala content item (e.g., TV show, movie, etc.) or event determined to be relevant (e.g., have a threshold relevance to the user(s) 140, a user group, a business or sponsor, a content platform, an event, a date, a condition, a campaign, a trend, a cue, a region or culture, a promotion, a context, a location, etc.) or selected as the basis for a theme of the user interface 400. For example, the Met Gala topic can be selected based on a determination that the Met Gala content item or event has a threshold relevance when the user interface 400 is presented (e.g., contextually relevant, temporally relevant, thematically relevant, etc.), is a promoted content item or event when the user interface 400, is assigned a threshold priority when the user interface 400 (e.g., is prioritized on a date or in a period of time including a day when the user interface 400 is displayed), is trending when the user interface 400 (e.g., is associated with a threshold trend metric), is preferred by the user(s) 140 (and/or by a user group, business or sponsor, content platform, etc.), matches one or more preferences (e.g., a user preference, business preference, sponsor preference, group preference, etc.), is associated with a content statistic, is associated with a popularity metric, etc.

For example, the Met Gala Show or event can include a show or event released and/or promoted when the user interface 400 is displayed (and/or within a period that includes a day when user interface 400 is displayed, within a period prior to user interface 400 being displayed, within a period after user interface 400 is displayed, etc.). As another example, the Met Gala topic used to select the Met Gala theme can be determined or selected based on a determination that the Met Gala event or content item is a trending event or content item, scheduled to occur or be released/televised on a day when the user interface 400 is presented (or within a time frame relative to when the user interface 400 is presented), a promoted event, an event of interest to the user(s) 140 (and/or to a group of users including the user(s) 140, a business or sponsor, a content platform, etc.), is temporally relevant, is geographically relevant (e.g., taking place in a same region, such as a same city or state, as the location of the user(s) 140 and/or a device used to display the user interface 400), is contextually relevant, is selected to be highlighted, etc.

To illustrate, if the Met Gala event occurs annually on a particular day, the Met Gala event may be a relevant and/or trending event and topic on that day (or a period of time that includes that day or relative to that day). Accordingly, the Met Gala topic can be used to select the Met Gala theme for the user interface 400 on that day (or period of time). When the user(s) 140 accesses the user interface 400 (e.g., via media device(s) 104) on that day, since the Met Gala topic/event has a threshold relevance on that day, the user interface 400, when presented on that day, can be customized based on the Met Gala theme. In some cases, the user interface 400 can dynamically incorporate (or change) thematic features (e.g., content, imagery, attributes, artwork, colors, etc.) and/or any other features associated with a topic, such as the Met Gala topic. If another topic is selected (e.g., because it is more relevant or has a higher relevance score, is promoted or has a higher promotion score, is trending or associated with a higher trending metric, etc.) on another day, the theme of the user interface 400 can change according to the other topic when presented on the other day (or within a timeframe). If the Met Gala topic is still the selected topic for the user interface theme on that other day, the user interface 400 can optionally continue implementing the Met Gala theme and/or retain any aspect of the Met Gala theme (e.g., in addition to or instead of any aspect of the other theme). Alternatively, the user interface 400 may remove or change any aspect of the Met Gala theme or only include a certain aspect(s) of the Met Gala theme.

The user interface 400 can include any other visual elements. Any of the visual elements of the user interface 400 can represent and/or provide a reference (e.g., hidden message or clue) to a respective content item (e.g., movie, TV show or episode, video game, etc.) and/or a feature associated with the respective content item (e.g., an object, character, building, scene, logo, symbol, vehicle, landmark, structure, graphic, activity, device, location, content, or any other feature from, depicted in, corresponding to, and/or related to the respective content item). For example, a visual element of the user interface 400 can be configured to depict or represent a reference to a content item and/or feature associated with the content item.

Each visual element may or may not be part of or configured based on a theme(s) of the user interface 400. For example, each visual element may or may not be configured or selected based on the city and/or Met Gala theme of the user interface 400, configured to depict a feature(s) of the city and/or Met Gala theme of the user interface 400 (e.g., to form part of such theme and/or convey any aspect(s) of such theme), etc. To illustrate, the user interface 400 in FIG. 4 includes visual elements 324A-D and 404A-N. Any of the visual elements 324A-D and 404A-N can include, depict, and/or convey a feature of a theme(s) of the user interface 400, such as a content, graphic, image, interface element, background, color(s), artwork, animation, object, character, logo, message, scene, structure, landmark, visualization, visual effect, visual content, and/or any other feature that depicts, conveys, and/or is part of any portion or aspect of the city and/or Met Gala theme of the user interface 400. Moreover, any visual element from the visual elements 324A-D and/or the visual elements 404A-N may depict, include, and/or represent a reference to a feature (e.g., object, character, building, structure, landmark, content or item from a scene, symbol, graphic, etc.) associated with (e.g., in, from, corresponding to, etc.) a content item (e.g., movie, TV show, video game, etc.), such as a content item from a content platform associated with the user interface 400, a content item being released, or any other content item.

In some cases, the reference to the feature associated with the content item can represent a hidden message or clue associated with the content item. Moreover, the reference to the feature associated with the content item can optionally relate to or be based on a theme(s), such as the theme(s) of the user interface 400. Accordingly, any of the visual elements 324A-D and/or 404A-N can be associated with a theme(s), such as the city theme and/or Met Gala theme of the user interface 400. For example, in FIG. 4, the visual elements 324A-C and 404B-D are associated with the city theme of the user interface 400. Here, each visual element depicts theme-based content, such as content depicting or representing a city element (e.g., a city building, scene, landmark, background, object, image, infrastructure item, road, sign, structure, name, etc.). To illustrate, visual element 324A depicts a city bridge, visual element 324B depicts a city building, visual element 324C depicts a Ferris wheel, visual element 404B depicts a volcano in a city, visual element 404C depicts the Eiffel tower from Paris, and visual element 404D depicts another city bridge. Thus, the visual elements 324A-C and 404B-D in this example can be part of and/or help convey/implement the city theme.

As previously noted, a visual element can additionally or alternatively represent a content item reference (e.g., a hidden message or clue from a content item) that depicts or includes a feature(s) included in, depicted in, and/or correlated to the content item. For example, the visual elements 404A-N depict references to features (e.g., objects, characters, buildings, structures, landmarks, content or items from a scene(s), symbols, graphics, etc.) from one or more respective content items and can optionally represent hidden messages or clues associated with the one or more respective content items. To illustrate, in FIG. 4, visual element 404A depicts a character from a movie and thus represents a reference to that movie (and/or the character from that movie), visual element 404B depicts a volcano from a movie and thus represents a reference to that movie (and/or the volcano from that movie), visual element 404C depicts a representation of the Eiffel Tower from a movie and thus represents a reference to that movie (and/or the Eiffel Tower representation from that movie), visual element 404D depicts a bridge from a movie and thus represents a reference to that movie (and/or the bridge from that movie), and visual element 404N depicts a spaceship from a TV show and thus represents a reference to that TV show (and/or the spaceship from that TV show).

In some cases, the topic(s) used to determine or select the theme(s) associated with the user interface 400 and/or background 414 can be based on a topic(s), such as a topic(s) related to, describing, representing, indicating, matching (or having a threshold similarity to), selected based on, and/or otherwise associated with an event, content, sport, category, context, rule, content category, social media data (e.g., posts, subscriptions, connections, messages, activity, trends, statistics, content, inputs, communications, profiles, etc.), genre, action or activity, location, venue and/or landmark, campaign, sponsor, product, brand, calendar, date or season, relevance metric (e.g., a score representing or measuring a temporal relevance, contextual relevance, user and/or group relevance, content consumption or statistical relevance, relevance to a business preference and/or subject, a combination thereof, etc.), input, user and/or group profile, content statistic, content history, scene or environment, preference, request, promotion, a combination thereof, and/or any other factor. As previously noted, the topic(s) associated with the theme(s) of the user interface 400 can be based on a signal(s).

The signal(s) can include, describe, identify, and/or correspond to a context, event (current event, sports event, news event, cultural and/or regional event, seasonal event, trending event, promotion event, content event, release event, product event, business event, user/group event, social event, media event, entertainment event, cultural event, etc.), calendar data, preference (e.g., user, group, business/platform, sponsor, promotion preference or weight, and/or any other preference), weight, rule, factor selected by an AI/ML model (e.g., predicted, recommended, learned, prioritized, and/or otherwise selected factor), filter, temporal cue, profile (e.g., user, group, content, and/or device profile), history (e.g., content history, session history, input history, preference and/or recommendation history, user history, group/household history, social media history, business/platform history, event history, regional/cultural history, etc.), cue (e.g., topical cue indicating topic trend, metric, weight, relevance, priority, rank, promotion/highlight score, etc.), campaign (e.g., content campaign, topic/theme-based campaign, regional campaign, promotion campaign, etc.), date and/or time, timeframe (e.g., period, month, week, day, hours, year, season, etc.), cultural or regional data (e.g., trend, preference, norm/tradition, language, event, etc.), trend and/or popularity data (e.g., a trend/popularity score or statistic associated with a topic, event, content, pattern, context, date, etc.), weight(s), scene or environment (e.g., current and/or previous), input (e.g., user/group input, input or decision of/from a business or platform associated with the user interface 400, etc.), interaction (e.g., user/group interaction, device interaction, content interaction, etc.), user/content session information, statistic (e.g., user/group statistic, device statistic, content statistic, etc.), user/group attribute (e.g., demographics, social media connections, content and/or social media subscriptions, content “likes”, “dislikes”, content feedback, etc.), activity (e.g., associated with a user, group, content, device, etc.), topic and/or content attribute, etc.

In some cases, the user interface 400, page 402, background 414, and/or theme(s) of the user interface 400, page 402, and/or background 414 can be customized for or based on the user(s) 140, another user, a household or group of users, a device, a group of devices, a context, a preference, an event, a situation, a condition, a rule or filter, a weight, a user input, a business preference, a business decision, a trend, a content pattern, historical data, social media data, an activity, etc. In some examples, the background 414, page 402, and/or theme(s) can be based on a configuration of the user interface 400, a date and/or context in which the user interface 400 is presented, a characteristic or profile of the user(s) 140 associated with the user interface 400, the device used to display the user interface 400, a content platform(s) or service(s) associated with the user interface 400, etc. In some examples, the background 414 and/or theme(s) can change or can be implemented (e.g., can remain the same or maintain a common attribute(s) or threshold similarity) across spaces (e.g., screens, interfaces, windows, pages, sections, etc.), sessions, etc. For example, the background 414 and/or theme(s) can remain the same or thematically consistent throughout a content or navigation experience, across interfaces/spaces, etc.

The user interface 400 can optionally include content section 420. Content section 420 can include content items 424A-N (and/or links to content items or categories of content items), such as movies, TV shows, TV channels, applications, video games, podcasts, audiobooks, videos, content catalogs, promoted content, advertisements, content categories, etc. In some cases, one or more of the content items 424A-N in content section 420 can be associated with (e.g., can relate to, can depict, can be selected based on, etc.) the Met Gala theme, such as a video of a current or previous Met Gala event, a Met Gala movie (and/or any characters, clothing articles, brands, or items associated with a Met Gala movie), a live stream or broadcast of a Met Gala event, a TV channel showing or scheduled to show Met Gala content, a documentary of a Met Gala event, a highlight reel from Met Gala events, videos of participants in one or more Met Gala events, etc. The content section 420 can additionally or alternatively include other media content items.

In some cases, the content section 420 may highlight, promote, or prioritize content items associated with the Met Gala theme, but may also or instead include other content items. The content section 420 can optionally include a navigation element 422 that the user(s) 140 can use (e.g., select or activate) to navigate content items in content section 420 and/or access or navigate to other spaces (e.g., sections, pages, portions, interfaces, etc.). For example, the navigation element 422 can include a selectable element which, when selected, causes the user interface 400 to expand the content section 420 to display other content items, sections, portions, pages, etc.

In some cases, the content section 420 can include or represent a bottom sheet. The bottom sheet can show content anchored to a bottom of the screen of the user interface 400. The user(s) 140 can select or activate the navigation element 422 to expand or enlarge the bottom sheet to display content as previously explained, navigate to content items in the bottom sheet, increase a size or prominence of the bottom sheet relative to other portions of the user interface 400, load an enlarged or expanded view of the bottom sheet, load an additional portion of the bottom sheet, or otherwise load a page associated with the bottom sheet containing content items associated with the bottom sheet (e.g., content items that are not visible within the user interface 400 until the user(s) 140 selects or activates the navigation element 422).

In some cases, the user interface 400 can include an animation(s). The animation(s) can be used to entertain users, provide an immersive experience, and/or promote/teach or draw attention to certain content, features, functionalities, etc. For example, in FIG. 4, the user interface 400 displays an animated arm 432 that is surfaced from a portion of the user interface 400, such as a border, and can extend to a region of the user interface 400 and can remain static for a period or disappear (e.g., can be removed, can move out of the screen, etc.) based on a trigger, such as a timeout, a time period, an input, an interaction, etc. As shown, the animated arm 432 is depicted holding a character 434. The character 434 is also holding a message 430 promoting a new episode of a reality show 438. The message 430 can identify the new episode of the reality show 438, and can optionally include a playback control 440 that the user(s) 140 can select to play or stream the new episode of the reality show 438 and/or any other information associated with the reality show 438 and/or the new episode.

The animated arm 432, the character 434, the message 430, and the reality show 438 are illustrative examples provided for explanation purposes. In other examples, the user interface 400 can display a different animated or static graphic (e.g., a different body part, an object, an animal, a logo or symbol, a character, a pattern, a vehicle, an image, an avatar, a creature, a system, etc.), which can hold the character 434 or hold or provide a different graphic (e.g., different character, an object, an animal, a vehicle, an image, a creature, a logo, a system, a person, etc.) and/or can include a different message or any other content (e.g., a video, a game, an XR experience, an image, a video game, a prompt, a content experience, etc.).

For example, in FIG. 4, the user interface 400 also depicts an animated character 454 associated with the Met Gala theme. In some cases, the animated character 454 can include a participant in a Met Gala event, a Met Gala model, a visual depiction of the user(s) 140 customized to include an attribute(s) associated with the Met Gala theme (e.g., a dress or outfit, etc.), etc. In this example, the animated character 454 includes a dress depicted by the visual elements 408D-E associated with the Met Gala theme. This way, the animated character 454 can be relevant to the Met Gala theme and/or depict an aspect thereof. The animated character 454 in this example is surfaced from the dress depicted by the visual element 408D and moves within the user interface 400 towards a content item 450. The animated character 454 can be placed on/near the content item 450 or crash against the content item 450 to draw the attention of the user(s) 140 to the content item 450 or otherwise highlight/promote the content item 450. In this example, the content item 450 includes a button or link to content associated with promoted dresses, such as an advertisement of promoted dresses, an illustration of promoted dresses, a virtual fitting of promoted dresses, a page of promoted dresses available for purchase, a page of virtual dresses promoted as interface or avatar add-ons, a content depicting promoted dresses, an activity or experience associated with promoted dresses, etc.

The user interface 400 can optionally display a user avatar 460. The user avatar 460 can depict the user(s) 140 or a representation of the user(s) 140. The user avatar 460 can include an image of the user(s) 140, can be generated based on an image of the user(s) 140, can be uploaded or provided by the user(s) 140, and/or can depict a virtual, animated, cartoon, or graphical representation of the user(s) 140. The user avatar 460 can optionally be customized based on a theme(s) associated with the user interface 400. For example, in FIG. 4, the user avatar 460 is customized based on the Met Gala theme. As shown, the user avatar 460 includes a dress, such as a Met Gala dress, and can optionally depict a hairstyle selected based on the Met Gala theme. In some cases, the user avatar 460 can indicate what profile is active, used, selected, or implemented by user interface 400.

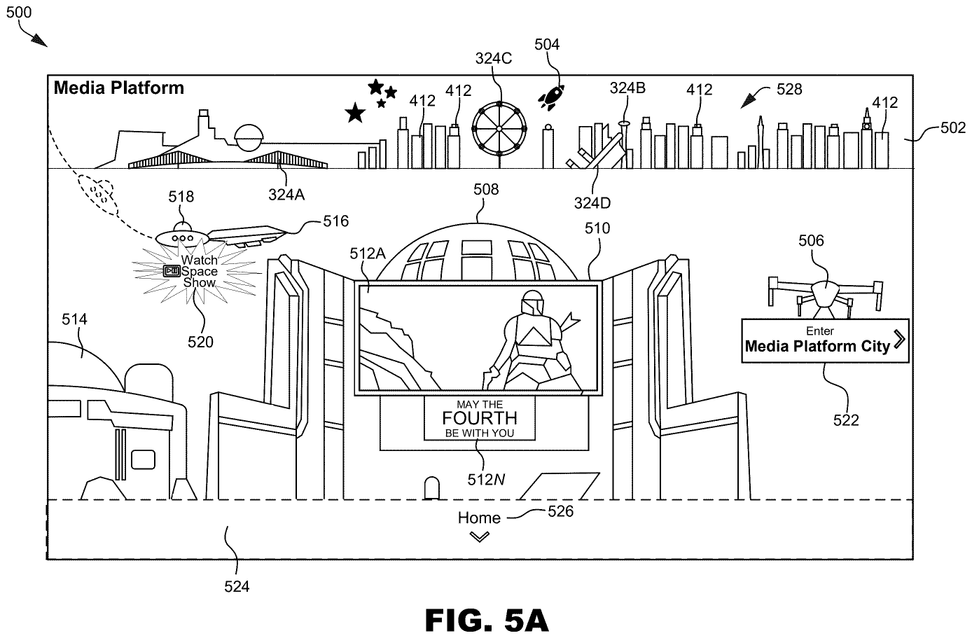

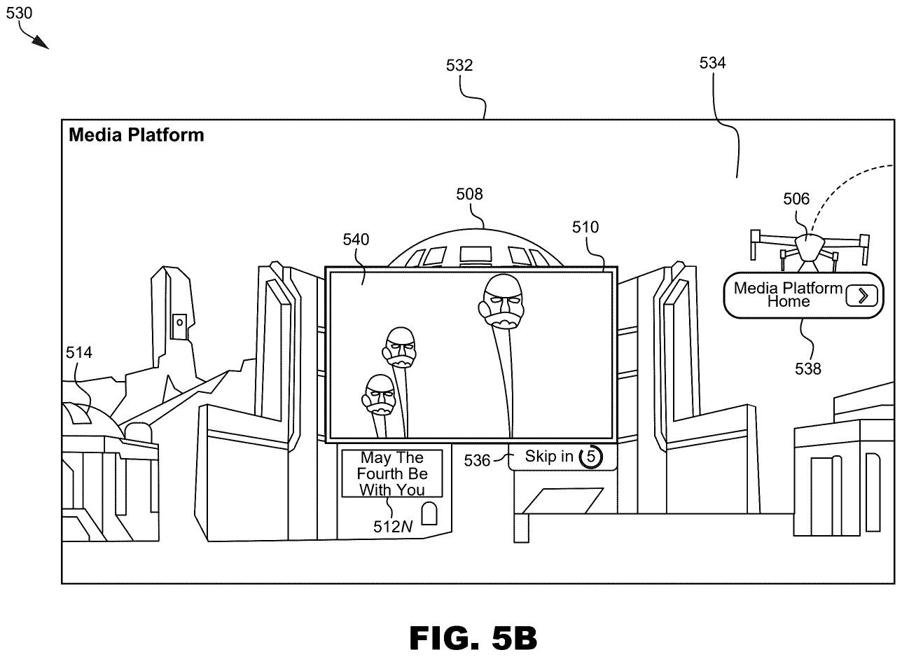

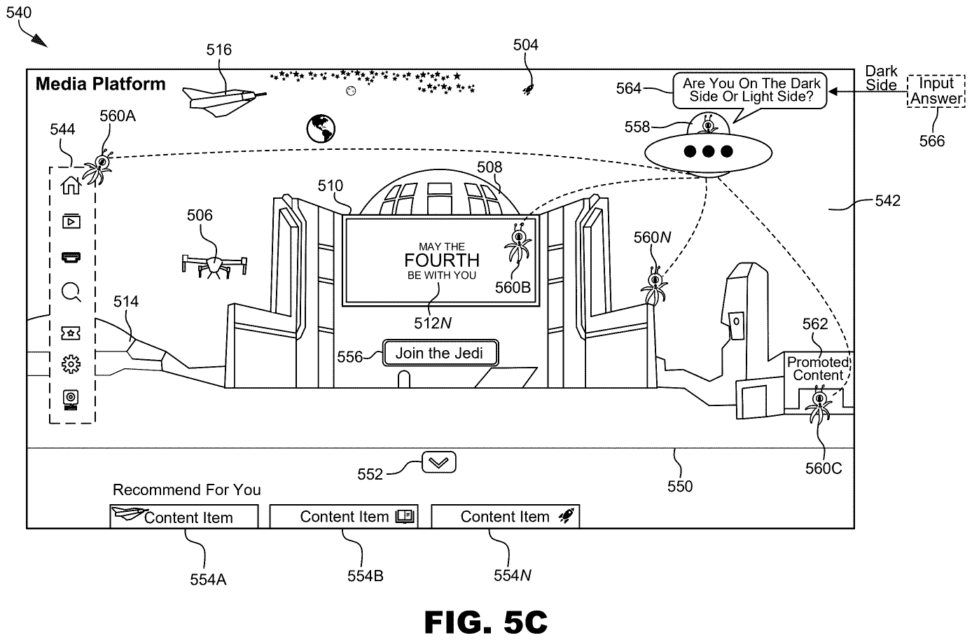

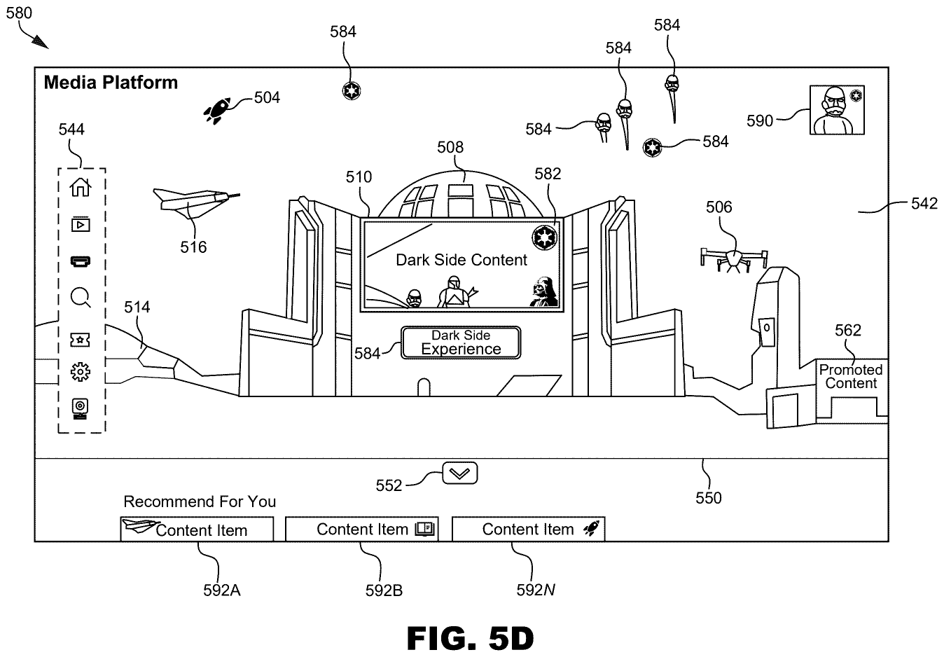

FIG. 5A illustrates another example of a user interface 500 configured to provide customized themes and/or content experiences. The user interface 500 can include a graphical user interface (GUI) of a content platform, a device, an operating system, a media application, a streaming service, a media library, media channel, a media entertainment system, a video game system, a set-top box, a media broadcast player or receiver, etc. In some cases, the user interface 500 can represent or depict a landing or welcome page presented when the user interface 500 is launched or initiated and/or when an associated platform, application, service, channel, and/or library is launched, triggered, executed, etc. In other cases, the user interface 500 can depict or represent any other interface or page.

For example, the user interface 500 can provide an entry point for the user(s) 140 to access content, access or start a content experience, access or navigate a content platform, channel, service, and/or the like. The user interface 500 can be customized based on a theme(s) selected for the user interface 500. The theme(s) can be selected based on a signal(s) such as, for example and without limitation, a context signal (e.g., a device location, a current time or date, a season, an environment of the user(s) 140 and/or an associated device, a circumstance, a condition, etc.), a preferences (e.g., user preference, household or user group preference, business or platform preference, sponsor preference, etc.), an event signal (e.g., a current event, trending event, release event, calendar event, competition, sports event, TV event, content event, regional event, etc.), a statistic signal (e.g., a trend metric, a content statistic, etc.), a temporal signal (e.g., a season, date, time period, holiday, month, week, etc.), a relevance signal (e.g., a signal identifying a topic, event, location, context, activity, and/or feature that is relevant to a date, time, period, context, user preference, statistic, trend, content, etc.), a data signal (e.g., statistics, historical data, input data, a data pattern, user data, content information, event data, context data, temporal data, profile data, preference data, etc.), a signal associated with an interaction or behavior (e.g., a user interface interaction, a trending user interaction, a user input, a user response and/or reaction to certain content and/or features, a content access and/or navigation pattern, a purchasing pattern, a content behavior, etc.), and/or any other signal.

In FIG. 5A, the user interface 500 is customized based on a theme associated with a “May The Fourth Be With You” topic or event (e.g., a “May The Fourth Be With You” theme). “May The Fourth Be With You” is or represents an event (e.g., a cultural or popular event) that is associated with and celebrates a space show (e.g., a space movie, TV show, video game, media franchise, and/or other media content). The event is celebrated on May 4^{th} by certain people, such as fans of the space show, to commemorate, recognize, and/or celebrate the space show. The theme can be selected based on one or more signals, such as one or more signals indicating that “May The Fourth Be With You” is a relevant topic with respect to a date/day/time/period when the user interface 500 is presented, relevant to a context associated with the user(s) 140 and/or media device(s) 104, a relevant or trending event, a preferred event (e.g., based on a user/group preference, business/platform preference, sponsor preference, etc.), and/or a topic or event selected or promoted based on selection data (e.g., a user (and/or group) profile, a user and/or business input or profile, a user or group preference, a business or platform preference, etc.), a condition, an activity, a content item, a rule, a calendar, a statistic, social media data, etc.

For example, the user interface 500 can be displayed to the user(s) 140 (and any other users) on May 4^{th} and customized to include a “May The Fourth Be With You” theme. The theme can depict or include space-related features (e.g., content, attributes, interface elements, styles, designs, visual elements, graphics, artwork a background, an experience, etc.) and/or features associated with the “May The Fourth Be With You”. In some cases, the theme can be selected based on a determination that “May The Fourth Be With You” is a trending or relevant topic or event on May 4^{th}. Thus, when presenting user interface 500 on May 4^{th}, user interface 500 can be customized to include such theme. In some examples, the theme can additionally or alternatively be selected based on one or more signals including and/or identifying a decision of a business or platform associated with the user interface 500 to promote or highlight the “May The Fourth Be With You” topic or event (and thus a “May The Fourth Be With You” theme) when the user interface 500 is presented, a respective weight associated with one or more topic candidates including the theme of user interface 500, a content history of the user(s) 140 or a group, a user or group preference, a rule, a calendar, a profile, a content history, content statistic, a trend, social media data, etc.

In some cases, the theme can be implemented on May 4^{th} based on a relevance, popularity, and/or history of the topic or event (e.g., “May The Fourth Be With You”) associated with the theme on that day. The theme can include or depict features (e.g., an appearance, content, style, color, color scheme, object, experience, animation, attribute, background, etc.) associated with or customized for or based on the “May The Fourth Be With You” topic. For example, the theme can depict one or more content items, experiences, attributes, graphics, artwork, background, objects, characters, animations, etc., related to a space show associated with “May The Fourth Be With You” based on a relevance of the “May The Fourth Be With You” event on May 4^{th} and/or the space show associated with such event. When the user(s) 140 accesses the user interface 500 (e.g., via media device(s) 104) on May 4^{th}, the user interface 500 displayed on that day can be customized as shown in FIG. 5A to include, incorporate, and/or depict a theme associated with “May The Fourth Be With You” and/or the associated space show. This way, the user interface 500 can provide the user(s) 140 a content and experience that relates to a relevant event and/or dynamically or selectively correlates to or conveys a relevant theme.

The user interface 500 can include a background 502 and visual elements 504-522 related to the “May The Fourth Be With You” theme, and thus conveying such theme. The visual elements 504-522 can include, for example, one or more images, colors, patterns, attributes, objects, color schemes, content experiences, characters, content items, information, styles, shapes, designs, characteristics, buildings, artwork, videos, features, interface elements, animations, background attributes, interface attributes, details, and/or other features that create or convey a theme associated with “May The Fourth Be With You”.

For example, in FIG. 5A, the visual elements 504 and 516 depict or represent spaceships, the visual element 506 depicts or represents a flying vehicle, the visual elements 508 and 514 depict or represent space or alien city structures (e.g., buildings, infrastructure, objects, and/or other visuals thematically relevant to the theme), and the visual element 510 depicts or represents a display showing content 512A-512N from or associated with a “May The Fourth Be With You” theme and/or a space show theme associated with “May The Fourth Be With You”. In this example, the content 512A can include a content item (e.g., an image, video, animation, graphic, game, etc.) and the content 512N can include a message associated with “May The Fourth Be With You”. Thus, the visual elements 504-522 can implement a theme and create an experience that relates to “May The Fourth Be With You” and/or an associated space show. Moreover, the visual elements 504-522 can immerse the user(s) 140 in an experience that relates to or is reminiscent of “May The Fourth Be With You” and/or the associated space show.

The background 502 can be selected, customized, and/or configured based on a theme(s). The theme(s) of the background 502 can include the “May The Fourth Be With You” theme associated with the user interface 500 and/or another theme. In FIG. 5A, the background 502 depicts a city theme. The city theme includes, depicts, and/or conveys a cityscape 528. The city scape 528 can include one or more structures, objects, attributes, elements, scenes, experiences, content items, and/or any other attributes of or associated with a city or urban area, such as a real city or urban area, a city or urban area included or depicted in one or more digital content items (e.g., one or more movies, TV shows, video games, animations, images, graphics, media channels, etc.), a city or urban area from or depicted/included in “May The Fourth Be With You” content (and/or related content), etc. For example, the cityscape 528 can include a cityscape or scene from a digital content item (e.g., a movie, TV show, video game, animation, video, image, etc.), a cityscape or scene from a physical content item (e.g., a painting, drawing, print or photograph, city landscape, etc.), a cityscape or scene from a real city or urban area, and/or physical aspects of a real city or urban area.

A theme(s) of the user interface 500 and/or background 502 can change across spaces (e.g., screens, interfaces, windows, screens, pages, sections, etc.) and/or experiences, or can remain the same or maintain one or more theme features (e.g., with or without any variations or additional aspects) across spaces and/or experiences to maintain a level of thematic and/or visual consistency throughout spaces and/or experiences and provide a common or related appearance and/or attribute across spaces and/or experiences. In some examples, the background 502 and/or visual elements 504-522 used to implement the “May The Fourth Be With You” and city themes can invoke a mood and/or thoughts/feelings associated with the themes.

The content 512A shown on the display depicted or represented by visual element 510 can include interactive content. For example, the content 512A can include a link a content item or experience, a game, a movie, a TV show, a livestream, a podcast, a video, interactive content that is selectable to initiate an action, game, activity, experience, and/or content item, and/or any other content. To illustrate, the content 512A can include a link to a movie, video, game, product, or activity of the space show associated with the “May The Fourth Be With You” theme. When the user(s) 140 clicks on or selects the content 512A, the link can trigger/activate the movie (e.g., initiate playback), the video (e.g., initiate playback), the video game (e.g., start a video game session), a transaction associated with a product, the activity, the content item, etc. In some examples, the content 512A can additionally or alternatively include static content that displays content associated with the space show and the “May The Fourth Be With You” theme.

In some examples, the user interface 500 can include other interface sections, content, spaces, features, and/or elements such as interface elements for navigating to other interface spaces or sections, providing inputs, interacting with the user interface 500, engaging with content, initiating an activity, etc. For example, in FIG. 5A, the user interface 500 includes a navigation element 522 that the user(s) 140 can use/select to navigate to another interface space (e.g., page, section, window, category, library, screen, interface or interface region, etc.), such as a page or experience depicting a media platform city or implementing a media platform city theme. When the navigation element 522 is selected or activated, the user interface 500 can transition or navigate to another user interface or page, which can include, depict, or implement the media platform city theme. The navigation element 522 can be placed on any location of the user interface 500 and can optionally be animated. In this example, the navigation element 522 depicts a sign with a message indicating that the navigation element 522 can be used to enter the user interface or page depicting or implementing the media platform city or associated theme. The sign in this example is held by the flying vehicle depicted by the visual element 506. The visual element 506 can optionally move (e.g., fly) within the user interface 500 and carry the navigation element 522 as it moves to provide animation, draw the attention of the user(s) 140, delight the user(s) 140, etc.

The user interface 500 can optionally include a content section 524. The content section 524 can include content items (and/or associated links) or categories (and/or associated links) available through the user interface 500, such as movies, TV shows, channels, media platforms/applications/services, video games, podcasts, audiobooks, videos, content catalogs, etc. For example, the content section 524 can include one or more content items related to “May The Fourth Be With You” and/or the associated space show, such as a movie of the space show, a “May The Fourth Be With You” video, a live stream or broadcast of space show content, a TV channel showing or scheduled to show space show content, a space show or “May The Fourth Be With You” documentary, a space show highlight reel, a space show catalogue, etc. The content section 524 can additionally or alternatively include other content items.

The content section 524 can optionally include an interface element 526 used to navigate content in content section 524, expand content section 524 to show additional content, scroll content section 524, and/or access other spaces (e.g., sections, pages, frames, windows, interfaces, regions, etc.). For example, the interface element 526 can be selected to expand the content section 524 to display content such as recommended content, previously-accessed content, promoted content, content related to the theme of the user interface 500, a content experience or activity, etc. In some cases, the content section 524 can include or represent a bottom sheet used to show content anchored to a bottom of the screen of the user interface 500. The user(s) 140 can select or activate the navigation element 522 to expand or enlarge the bottom sheet to display content, navigate to content in the bottom sheet, increase a size or prominence of the bottom sheet relative to other portions of the user interface 500, load an enlarged or expanded view of the bottom sheet, load an additional portion of the bottom sheet, or otherwise load a page associated with the bottom sheet (e.g., depicting content items that are not visible within the user interface 500 until the user(s) 140 selects or activates the navigation element 522).

In some cases, content section 524 can include or be part of a home page of a content platform associated with user interface 500. The user(s) 140 can select the interface element 526 to navigate to, expand, display, or access the home page. For example, the user interface 500 can represent a page displayed when media device(s) 104 loads a media platform or application associated with the user interface 500. The page can include or depict a selected theme as shown in FIG. 5A. The theme can provide a content experience(s) to the user(s) 140 before the user(s) 140 navigates to another space (e.g., another page or interface) such user interface 530 shown in FIG. 5B or user interface 540 shown in FIG. 5C.

In some examples, the user interface 500 can depict an animation used to provide an experience to the user(s) 140, steer the user(s) 140 to a specific feature(s) (e.g., a content, content space, setting, menu, control, functionality, option, section, graphic, object, advertisement, link, experience, interface element, page, etc.), help the user(s) 140 discover a specific feature (e.g., a specific content item, setting, menu, functionality, object, link, advertisement, clue, message, interface element, experience, etc.), teach the user(s) 140 how to use a specific configuration/control feature (e.g., a menu, setting, control input, control or configuration parameter, etc.) and/or functionality, help the user(s) 140 explore the user interface 500, etc. For example, in FIG. 5A, the user interface 500 depicts an animated spaceship 518 crashing into the spaceship depicted by visual element 516. The crash between the animated spaceship 518 and the spaceship depicted by the visual element 516 can trigger the user interface 500 to depict a visual element 520 with a message promoting certain content. The visual element 520 can additionally or alternatively include or depict a link or interactive element (e.g., a button, a control, etc.) configured to load, navigate, initiate, play, interact with, and/or access the promoted content. The user(s) 140 can access the promoted content by selecting or activating such link or interactive element included or depicted by the visual element 520 that is shown in response to the crash.

The animated spaceship 518 and animated experience provided by the animated spaceship 518 can be selected based on a theme (e.g., the “May The Fourth Be With You” theme) of user interface 500 and thus convey aspects of the theme and/or be relevant or related to the theme. In some cases, the content promoted by the visual element 520 can be selected based on the theme and/or can include content associated with the theme, such as a space movie, a space show, a space video game, a space documentary, a space experience, a space XR scene or environment, a space page, a content associated with “May The Fourth Be With You”, etc. The visual element 520 can promote any other content and/or can depict any other content, experience, animation, link, interface element, message, output, and/or any other feature.

For example, in FIG. 5A, the visual element 520 visually appears as, depicts, and/or represents an explosion (and/or aspects thereof) resulting from the crash between the spaceship depicted by the visual element 516 and the animated spaceship 518. The visual element 520 can depict the explosion using one or more features that convey an explosion from a crash, such as a shockwave, smoke, fire, debris, a message (e.g., “Boom”, “Bang”, “Crash”, “Explosion”, etc.), a structure or object collapsing (e.g., the spaceship depicted by the visual element 516 and/or the animated spaceship 518 collapsing), damage or disfigurement of a structure and/or object associated with the crash (e.g., the spaceship depicted by the visual element 516 and/or the animated spaceship 518), a shape representing or conveying an explosion (e.g., a shape that conveys the energy and/or radial nature of an explosion such as a sunburst shape, a starburst shape, a shape of a smoke cloud, etc.), a color(s) and/or texture(s) determined to convey an explosion (e.g., a color(s) and/or texture(s) used to simulate the visual intensity of an explosion such as any colors and textures having a threshold contrast and/or brightness), motion and/or speed used to capture the dynamic nature of an explosion (e.g., certain lines, streaks, patterns such as swirling patterns and/or any motion/animated pattern, imagery depicting or representing an explosion, etc.), etc. The object depict that depicts the content of the visual element 520, such as the promoted content and optionally any content link or control elements such as a playback or selection element.

In some cases, the crash can also include sound triggered by the crash, such as a crashing sound. Media device(s) 104 associated with the user interface 500 can output the sound via one or more speaker devices of media device(s) 104 or communicatively coupled to media device(s) 104 via a physical/wired and/or wireless connection.

FIG. 5B illustrates another example of a user interface 530 customized based on a selected theme. User interface 530 can provide a content experience for the user(s) 140 displayed before or after the user(s) 140 navigates or accesses another page or interface of a content platform (e.g., streaming platform, TV platform, media entertainment platform, media application, online content service, media player, set-top box platform, video game platform, etc.) associated with user interface 530 that displays and provides access to any content (e.g., movies, TV shows, channels, media applications or associated portals, video games, podcasts, content catalogs/collections/libraries, content sections, content features, etc.) and/or content experiences associated with the content platform, such as a home page or any content page or section.

The user interface 530 can be customized based on a theme(s) associated with a topic(s) selected based on one or more signals. In this example, the theme(s) of the user interface 530 is related to, associated with, and/or is customized based on astronomical space (e.g., the three-dimensional (3D) cosmic expanse also known as the universe), the “May The Fourth Be With You” topic, and/or features (e.g., attributes, content, artwork, etc.) associated with the “May The Fourth Be With You” topic and/or space show. The user interface 530 can depict a scene or environment associated with the theme, such as a space city 532 and/or any features representing, depicting, and/or associated with space city 532. The space city 532 (and associated features) can be used to implement, depict, and/or convey the theme(s). The space city 532 can provide a customized, thematic experience that depicts, conveys, and/or is associated with the astronomical space, “May The Fourth Be With You”, and/or the space show theme(s) of the user interface 530.

In some cases, the theme(s) associated with space city 532 can be selected based on, related to, and/or continued from the theme(s) of user interface 500 in FIG. 5A. For example, if the user(s) 140 navigates from user interface 500 to user interface 530 (or vice versa), the user interfaces displayed when the user(s) 140 navigates from user interface 500 to user interface 530 (or vice versa) can maintain or persist a theme(s) with or without any variations/adjustments. To illustrate, if the user(s) 140 selects or activates navigation element 522 in user interface 500, the navigation element 522 can trigger the user interface 500 to transition to and/or load user interface 530 depicting the space city 532. UI management system 130 can select the theme(s) of user interface 500 for user interface 530, and customize user interface 530 based on the selected theme(s). In some cases, UI management system 130 can customize user interface 530 (or trigger or instruct another device to customize user interface 530) based on the theme(s), which in this example includes space city 532.

The theme(s) of user interfaces 500 and 530 is/are an example(s) theme(s) provided for illustration and explanation purposes. In other cases, the user interfaces can implement or include any other theme(s), which can be selected based on one or more signals and may or may not be the same or have any similar or common/shared feature(s). For example, while the example user interfaces in FIG. 5A and FIG. 5B include or maintain a same or consistent theme(s) (with or without modifications/adjustments), in other examples the user interfaces 500 and 530 can additionally or alternatively implement a different theme(s) regardless of whether user interface 530 is accessed, navigated, or transitioned from user interface 500 (or vice versa) or a different user interface, or whether user interface 500 and user interface 530 are displayed on a same or different day and/or as part of a same or different session.

The space city 532 can include and/or depict a background 534, visual elements 506-514, and visual elements 536-538. The background 534, visual elements 506-514, and visual elements 536-538 (or a subset thereof) can be based on, associated with, and/or customized to include the theme(s) associated with user interface 530 (and/or aspects thereof). The space city 532 can include visual elements which may or may not relate to the theme(s). The background 534, visual elements 506-514, and visual elements 536-538 (or a subset thereof) can display features (e.g., attributes, experiences, settings, behaviors, designs, styles, content, etc.) and have an appearance of a city in space related to “May The Fourth Be With You” and/or the space show.

In FIG. 5B, the screen depicted by visual element 510 displays a video 540 related to the theme(s) of user interface 530, such as a space or “May The Fourth Be With You” related movie, show, animation, advertisement, game, etc. For example, when user interface 530 is displayed, the screen can show/play the video 540. The space city 532 can optionally include an interface element 536 for providing inputs. For example, interface element 536 can include a link, button, control, or interactive/selectable element that the user(s) 140 can use to initiate or control a behavior (e.g., playback, etc.) of the video 540. In FIG. 5B, the interface element 536 includes a button that the user(s) 140 can select to skip the video 540 or a portion of the video 540, such as an advertisement.

In some examples, the user interface 530 and/or space city 532 can include any animations used to delight the user(s) 140, draw an attention of the user(s) 140, steer the user(s) 140 to a feature(s), promote a feature(s), help the user(s) 140 navigate a feature(s) (and/or the user interface 530), help the user(s) 140 discover a feature(s), encourage the user(s) 140 to explore a feature(s), teach the user(s) 140 a feature(s) such as a setting or functionality, and/or otherwise promote anything in user interface 530 and/or assist the user(s) 140. For example, the flying vehicle depicted by visual element 506 can provide an animation to promote or draw an attention of the user(s) 140 to navigation element 538 and steer the user(s) 140 to the destination associated with navigation element 538 or help or encourage the user(s) 140 to explore other interface spaces, such as the destination associated with navigation element 538.

The flying vehicle depicted by visual element 506 can fly within user interface 530. For example, the flying vehicle can appear from outside of the screen (e.g., can fly into the user interface 530 from outside of the user interface 530) and move within user interface 530 while it holds or carries navigation element 538. The flying vehicle can continue to fly around user interface 530 holding or carrying navigation element 538 or can park in an area within user interface 530 and hold navigation element 538 from the parked location. In some cases, the flying vehicle can throw or drop navigation element 538 somewhere within user interface 530 and fly away. If the flying vehicle drops navigation element 538, user interface 530 can depict an animation showing navigation element 538 falling and optionally crashing into an object, a ground, or anything in user interface 530. The user interface 530 can optionally animate such crash and depict the crash. In some cases, the crash can trigger a rendering of another object/content or animation by user interface 530. For example, the crash can cause another object or content item, such as a promoted page or movie, to appear from the crash in an animated fashion. In some cases, the crash can trigger a sound such as a crashing sound. Media device(s) 104 can output the sound via a speaker of media device(s) 104 and/or communicatively coupled to media device(s) 104.

The space city 532 can optionally include a navigation element 538 that the user(s) 140 can select or activate to access a page, interface, section, screen, or any other destination. The user(s) 140 can select the navigation element 538 to leave space city 532 and user interface 530 and access another user interface or screen, such as user interface 540 shown in FIG. 5C.

While visual element 510 in space city 532 depicts a screen displaying a video 540, in other examples, visual element 510 and/or space city 532 can depict and/or include any other feature (e.g., content, attribute, object, animation, interface element, game, activity, experience, graphic, image, visual element, etc.) in addition to or instead of visual element 510 and/or space city 532. The experience associated with the theme(s) of space city 532 and visual element 510 in FIG. 5B is an example provided for illustration and explanation purposes. In other cases, the screen depicted by visual element 510 can include a video game that the user(s) 140 can play or participate in, an interactive or immersive experience related to the theme(s) associated with the user interface 530 (or any other topic/theme), etc.

FIG. 5C illustrates another example of a user interface 540 customized based on one or more themes. The user interface 540 can be customized based on a theme(s). In some examples, the user interface 540 can also include a background 542 (e.g., backdrop, wallpaper, screensaver, etc.), which may or may not be part of the theme(s) and/or a different theme(s). In FIG. 5C, the background 542 is customized based on the theme(s) associated with the user interface 540 and/or is part of such theme(s). For example, the background 542 can implement the “May The Fourth Be With You” theme. The background 542 can additionally or alternatively relate to or be based on another theme(s). For example, the background 542 can depict characteristics of a content platform (and/or a brand, service, and/or entity associated with the content platform) such as a color(s), logo(s), pattern(s), design(s), aesthetic feature(s), advertisement(s), content, etc..

The user interfaces 500, 530, and 540 can implement a same theme (with or without variations) or different themes. In FIGS. 5A-C, the “May The Fourth Be With You” theme is a continuous theme implemented across user interface 500, user interface 530, and user interface 540. In some examples, the themes of the user interfaces 500, 530, and 540 can remain the same during a session(s), time period(s) (e.g., day, week, hour, another unit or range of time, etc.), and/or experience(s) based on a match, similarity, relevance, and/or attribute of the topic(s) associated with the themes of user interfaces 500, 530, and 540. For example, if the user(s) 140 navigates between user interfaces 500, 530, and 540, the user interfaces 500, 530, and 540 can maintain a same theme (e.g., with or without variations) or aspects of a same theme. If the user interfaces 500, 530, and 540 are displayed within a specific time period or session associated with a theme, the user interfaces 500, 530, and 540 can maintain a same theme (with or without variations) or aspects of a same theme. If the respective themes of user interfaces 500, 530, and 540 are based on a same or similar (e.g., having a threshold similarity) topic, the themes can be the same or have a threshold similarity. This way, the user interfaces 500, 530, and 540 can maintain a same/consistent or similar/relevant themes and provide the user(s) 140 an experience with thematic continuity or consistent customizations.

While the theme(s) of the user interface 540 is the same (with some variations, adjustments, and/or customizations) as a respective theme implemented by user interface 500 and user interface 530, in other examples, user interface 540 can implement a different theme (in addition to or instead of a theme implemented by user interface 500 and/or user interface 530). In some cases, the background 542 of user interface 540 can include or be part of a different theme than a theme of user interface 540, user interface 500, and/or user interface 530. The theme of user interface 540 and background 542 can be based on a topic(s) selected based on one or more signals. The background 542 can include features associated with the theme, such as a color(s), color scheme(s), visual pattern(s), design(s) and/or style(s), appearance(s), content(s), experience(s), animation(s), attribute(s), image(s), wallpaper, characteristic(s), etc. The features can be used to implement the theme associated with background 542.

Moreover, the user interface 540 can include visual elements 504-516 and 556-564 selected or configured based on the theme of user interface 540. The visual elements 504-516 and 556-564 can depict/convey the theme (or aspects thereof) of user interface 540 and/or include features associated with the theme. For example, the visual elements 504-516 and 556-564 can depict content items, interface elements, animations, images, colors, objects, visual attributes, characters, hidden messages or clues (e.g., content references, etc.), color schemes, videos, graphics, and/or any other features associated with the theme

To illustrate, visual element 504 depicts a rocket flying to space, visual element 506 depicts a flying aircraft, visual elements 508 and 514 depict space buildings (e.g., a space theater, home, center, dome, stadium, hospital, hotel, and/or any other space structure), visual element 510 depicts a screen (also referred to as the “screen 510”) showing a visual element 512N with a message associated with “May The Fourth Be With You”, visual element 556 depicts a control element that displays a message associated with “May The Fourth Be With You” (e.g., Join the Jedi) and/or a title of a content item associated with a space show and/or “May The Fourth Be With You” and optionally accessible via the visual element 556 (e.g., loaded, played, initiated, and/or rendered in response to an input selecting or activating visual element 556 or a link or component thereof), and visual elements 558-564 depict and/or are part of an animation depicted by user interface 540 associated with the theme of user interface 540.

In some cases, visual element 556 can include an interactive element (also referred to as “interactive element 556”). When interactive element 546 is selected or activated, user interface 540 can update content in the screen 510 to include content associated with interactive element 556, such as content associated with a Jedi, which is a character from a space franchise associated with the theme (e.g., “May The Fourth Be With You” theme), such as a movie or other video of the Jedi and/or related to the Jedi, a video game related to the Jedi, text associated with “May The Fourth Be With You” or the Jedi, other content related to the Jedi, an immersive experience associated with the Jedi, a user interaction with content and/or features associated with Jedi, etc. In some examples, when the user(s) 140 selects or activates interactive element 546, the interactive element 546 can trigger the screen 510 to display content and/or change the content it displays.

As another example, when the user(s) 140 selects or activates interactive element 546, the user interface 540 can render an experience that appears as if the user(s) 140 is entering the space building depicted by visual element 508 to access a user interface or interface space depicting a scene inside of the space building where the user(s) 140 can participate in or obtain an experience associated with the Jedi (e.g., based on the interactive element 546 relating to the Jedi) and/or the message or content depicted by screen 510 (e.g., “May The Fourth Be With You”). In some examples, the scene inside of the space building can include content and/or an environment based the type of space building and/or theme associated with user interface 540. For example, if the space building represents a space theater, the scene inside of the space building can include, depict, and/or represent a space theater showing content (or where the user(s) 140 can view/access content) related to the Jedi and/or “May The Fourth Be With You”, such as a Jedi movie or a space video or show. If the space building represents a space colosseum, the scene inside of the space building can include, depict, and/or represent a space colosseum showing content (or where the user(s) 140 can view/access content) depicting a fight scene or competition involving the Jedi or any character associated with the theme of user interface 540.

The visual elements on user interface 540 (or a subset thereof) can provide an animation, depict an animation, or be part of an animation. For example, visual element 558 depicts an alien spaceship, visual elements 560A-N (collectively “visual elements 560” hereinafter) depict alien creatures (also referred to as “alien creatures 560” herein), and visual element 564 depicts an interaction (e.g., a prompt, message, question, survey, communication, chat, etc.) from an alien creature in the alien spaceship depicted by visual element 558 (also referred to as “alien spaceship 558” herein). The animation associated with visual elements 558-564 depicts the alien spaceship 558 flying around user interface 540 or appearing within a view of user interface 540 (e.g., appearing to fly into user interface 540 from outside of user interface 540) and dropping the alien creatures 560 (e.g., dropping the alien creatures 560 while or after alien spaceship 558 stops/parks within user interface 540 or as/while the alien spaceship 558 moves or continues to move about user interface 540). Upon being dropped or released by alien spaceship 558, the alien creatures 560 can fly, drop, land, move, hide, park, or go to respective destinations on user interface 540.

In FIG. 5C, the alien creature associated with visual element 560A (also referred to as “alien creature 560A” herein) is depicted on a toolbar 544 in user interface 540 after being dropped/released from or exiting alien spaceship 558. The toolbar 544 can include a menu toolbar with items. The items can include, for example and without limitation, a control menu for navigating to a destination, a menu for accessing certain content (e.g., videos, music, movies, TV shows, podcasts, documentaries, audiobooks, images, animations, video games, promoted or promotional content, etc.), a display menu for configuring display settings (e.g., a display output setting or port, a rendering setting, a graphics setting, a visual attribute or parameter, a framerate, a resolution, an aspect ratio, etc.), a search tool, a menu for accessing a type of content (e.g., content of a certain content category, content of a certain genre, content associated with a certain type of content experience, video content, image content, audio content, video game content, interactive content, animated content, customized content, interactive content, XR content, movies, TV shows, video games, podcasts, VR and/or AR content experiences, and/or any other type of content), a menu for accessing a source of content or content associated with a feature (e.g., content from or with a certain topic, group, provider, producer, application, platform, channel, repository, collection, franchise, server, library, region, language, setting, etc.), a settings menu (e.g., for settings such as content settings, device settings, interface settings, audio settings, video settings, language settings, display settings, etc.), an input or output (e.g., HDMI, etc.) source or setting, a controls menu for accessing certain controls (e.g., controls for a camera, microphone, display, content, interface, application, device, platform, etc.), and/or any other menu or menu item.

The user interface 540 can show the alien creature 560A going to the toolbar 544 and sitting (or being positioned) on the toolbar 544. Such animation can engage the user(s) 140, delight the user(s) 140, provide an immersive experience, draw an attention of the user(s) 140 to the toolbar 544 (or an item thereof), promote the toolbar 544 (or an item thereof), help the user(s) 140 explore or discover/learn the toolbar 544 (or an item thereof), and/or as part of an animated experience used to guide the user(s) 140 through the toolbar 544 (or any item thereof), demonstrate a use or functionality of the toolbar 544 (or any item thereof), teach the user(s) 140 how to use the toolbar 544 (or any item/feature thereof), provide a clue to the user(s) 140 as part of an interactive or immersive game or activity, and/or provide an animated tutorial associated with the toolbar 544, and/or any other purpose. Moreover, after being dropped/released from or exiting the alien spaceship 558, the alien creatures 560B-N are depicted going to and/or positioned at respective locations of, within, or within a proximity to the space building depicted by visual element 508 (also referred to as “space building 508” or “alien building 508” herein). The alien creatures 560B-N can go to the respective locations associated with the space building 508 to provide an animated experience; help user(s) 140 discover, understand, or learn any features (e.g., content, functionalities, experiences, settings, etc.) available/accessible or depicted/provided at, from, or near (e.g., within a proximity, adjacent to, etc.) the respective locations associated with the space building 508; teach or guide the user(s) to access or use certain features accessible/available from, at, or near the respective locations associated with the space building 508; provide a clue(s) associated with a game or activity; incentivize the user(s) 140 to access any feature or explore a portion of the user interface 540 associated with the respective locations of the alien creatures 560B-N; demonstrate to user(s) 140 certain feature(s) associated with the respective locations of the alien creatures 560B-N; and/or for any other purpose.

For example, the alien creature 560B (also referred to as “alien creature 560B” herein) is shown on screen 510. The alien creature 560B can drop or exit from alien spaceship 558 to the screen 510 on space building 508, and can be positioned on the screen 510 to draw attention to the screen 510 or content depicted/playing on the screen 510, draw attention to the message depicted by visual element 512N on the screen 510, incentivize or encourage the user(s) 140 to watch or play content on or via the screen 510, interact with the screen 510 or content on the screen 510, help the user(s) 140 discover content at or from the screen 510, etc.

The alien creature 560C (also referred to as “alien creature 560C” herein) is shown on a portion of the space building 508 that includes, displays, or provides access to promoted content 562. The alien creature 560C can be positioned by the promoted content 562 to steer the user(s) 140 to the promoted content 562, promote or highlight the promoted content 562, draw attention to the promoted content 562, incentivize or encourage the user(s) 140 to consume or access the promoted content 562, help the user(s) 140 discover or explore the promoted content 562, guide the user(s) 140 to the promoted content 562, teach the user(s) 140 how to access or anything else about the promoted content 562, and/or any other purpose. The promoted content 562 can include any content or type of content such as, for example and without limitation, a movie, a movie category or collection, a TV show, a TV show category or collection, a media application, a media channel, a video game, a video game category or collection, an advertisement, an interactive experience, an activity, an announcement, a page or interface, a brand, etc.

The visual element 564 can be part of the animation associated with the alien spaceship 558 and alien creatures 560. For example, the visual element 564 in FIG. 5C displays a message (also referred to as “message 564” herein) from alien spaceship 558. The message 564 can be part of a prompt, chat, question, survey, activity, game, experience, contest, challenge, promotion, campaign, tutorial, instruction, or any other message. The message 564 may or may not be part of, relevant to, or based on the theme(s) associated with user interface 540. For example, the message 564 in FIG. 5C asks if the user(s) 140 is on “the dark side” or “the light side”, which are references to a space content/franchise associated with “May The Fourth Be With You”.

The question can be part of an interactive experience. If the user(s) 140 provides an answer 566, the answer 566 can be used to trigger an experience, interact with a content or feature, further customize or personalize user interface 540, customize/personalize or configure a content recommended/promoted or provided by user interface 540, customize/personalize or configure a user profile associated with the user(s) 140, customize/personalize or configure a user avatar associated with the user(s) 140, etc. For example, the answer 566 can be used to customize the user avatar 590 in FIG. 5D.

In some cases, the user interface 540 can include content section 550. The content section 550 can include an interface element 552 that the user(s) 140 can select or activate to expand the content section 550 to display content or increase the content section 550. The content in content section 550 can relate to the theme of user interface 540 and/or any other topic. The content section 550 can include tiles 554A-N (collectively “tiles 554” hereinafter) representing content items. The user(s) 140 can use the tiles 554 to access and/or interact with content items associated with the tiles 554, watch/play or stream the content items (e.g., via corresponding tiles), navigate to the content items, select any of the content items, interact with the tiles 554 (and/or any corresponding content items), etc. The tiles 554 can represent or correspond to any type of content items such as, for example, movies, TV shows, podcasts, livestreams, videos, video games, animations, software applications, channels, advertisements, sponsored content, audiobooks, music, content from a content history of the user(s) 140, XR content, etc.

In some cases, the tiles 554 can include content items from one or more categories such as, for example, a recommended content category, a new release category, a live category, a genre or content category, a content type, a category for a target audience (e.g., family, children, adults, etc.), a ratings category, a language category, a theme-based category, a science category, a news category, a topic category, an experience or experience type category, etc. In some examples, the tiles 554 (or a subset thereof) can be organized, categorized, arranged, sorted, and/or grouped according to one or more factors, such as a factor(s) associated with the corresponding content items, the theme of user interface 540, the user(s) 140, a user preference or profile, a user avatar, a user input, a context, etc. For example, the tiles 554 can be organized, categorized, sorted, and/or grouped according to a genre, year, content type, content source, channel, language, country, topic, actor or character associated with the content, content metadata (e.g., length, tag, ratings, title, etc.), history, statistics, relevance to a theme of user interface 540, content activity, promoted content or a promotion campaign, a content release date, a content award, a cost, a format, content settings, a compatibility with a device presenting user interface 540, a relevance (e.g., relevance to the user(s) 140, a group of users, a household of the user(s) 140, a geographic location, a country or culture, a season, a context, an activity and/or context, an event, a trend, a topic, etc.), and/or any other factor.

FIG. 5D illustrates another example user interface 580 customized based on a theme(s). The user interface 580 can represent the user interface 530 in FIG. 5C with updates, a version of user interface 530, a user interface navigated or transitioned from (and/or displayed after) user interface 530, or a user interface generated based on user interface 530. In some cases, the user interface 580 can include an example of a user interface displayed after user interface 530 in FIG. 5C, the user interface 530 updated based on one or more inputs (and/or other data), or a version of user interface 530 customized and/or modified based on the answer 566 provided by the user(s) 140 in response to message 564. For example, the message 564 asked whether the user is on the “dark side” or “light side”. The answer 566 indicates that the user(s) 140 is on the “dark side”. The answer 566 can be used to update or modify the user interface or any aspect thereof. As shown user interface 580 is customized based on the theme(s) of user interface 530, but is further customized based on the answer 566. The user interface 580 can include any other customization or modification based on the answer 566.

For example, in FIG. 5D, user interface 580 depicts an interface element 584 selected based on answer 566. The user(s) 140 can select or activate interface element 584 to access or initiate an experience associated with “the dark side”, such as a video game, animation, movie, stream, activity, content, and/or feature associated with “the dark side” (e.g., associated with a scene(s), character(s), location(s), landmark(s), activity, content, empire, and/or any other aspect of the “dark side”). In some cases, the experience can be depicted by the screen 510 on space building 508, an interface page/window, a portion of user interface 580, and/or any other interface or space.

Moreover, the background 542 of user interface 580 (and/or the theme(s) of user interface 580) depicts visual elements 584 associated with the “dark side”. The visual elements 584 can depict any character(s), scene(s), symbol(s), color(s), graphic(s), structure(s), object(s), artwork(s), vehicle(s), visual element(s), and/or any other feature(s) associated with the “dark side”. In some examples, the answer 566 can be used to update or customize content of user interface 580, an experience provided by user interface 580, a user avatar, etc. For example, in FIG. 5D, user interface 580 displays a user avatar 590 associated with the user(s) 140. The user avatar 590 can depict the user(s) 140, a graphic representing or depicting the user(s) 140, and/or a photo or representation of the user(s) 140 (with or without modifications).

In FIG. 5D, the user avatar 590 includes a photo (e.g., a real photo, a modified photo, an animated photo, a cartoon photo, a software-generated photo such as a generative-AI photo, etc.) or representation of the user(s) 140 customized based on the “dark side”. For example, the user avatar 590 can depict the user(s) 140 with a helmet from a character of the “dark side”. If the answer 566 instead indicated the “light side”, user interface 580 (e.g., user avatar 590, content 582, interface element 584, background 542, etc.) may instead be customized based on the “light side”. Thus, the answer 566 can be used to customize user interface 580 and/or aspects thereof.

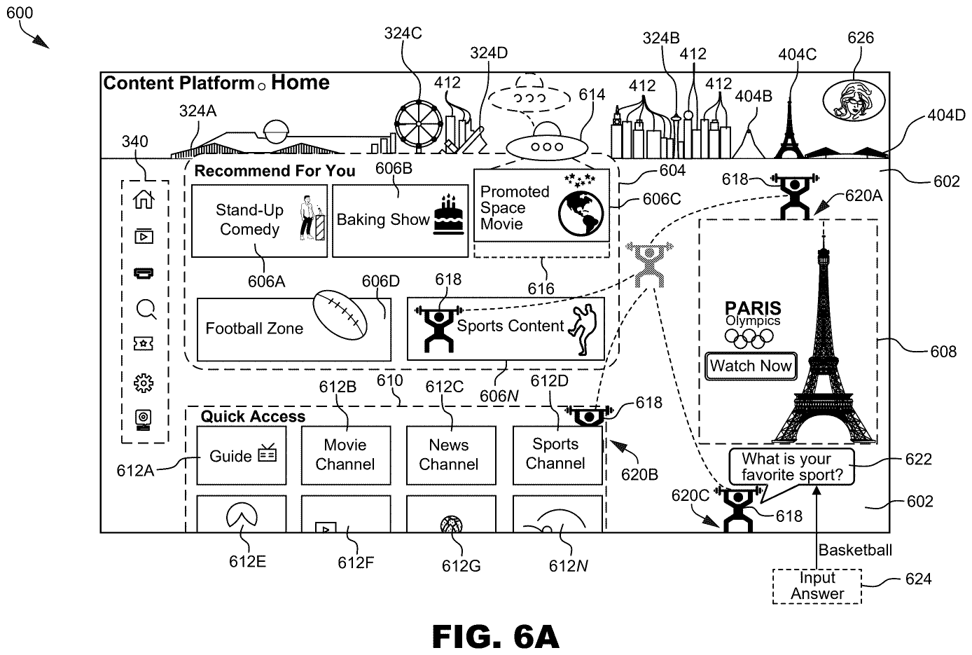

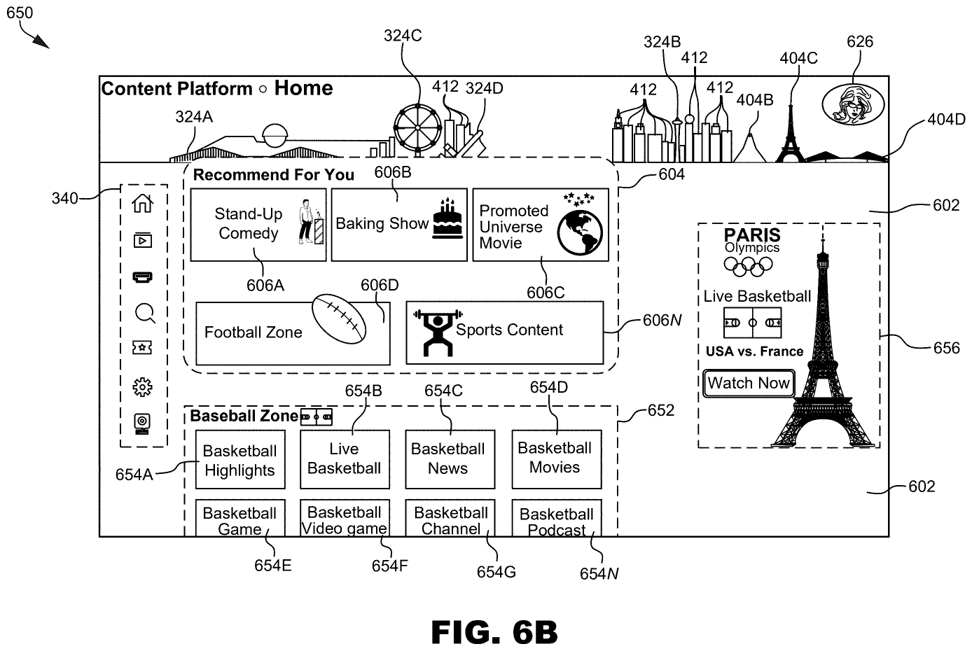

FIG. 6A illustrates another example of a user interface 600 customized according to a theme(s) and configured to provide immersive experiences. In this example, the user interface 600 includes background 602, content section 604, promoted content 608, content section 610, and menu 340. The background 602 can include one or more images, colors, color schemes, patterns, attributes, objects, characters, content items, artwork, messages, logos, styles, shapes, designs, content item references (e.g., hidden messages or clues, etc.), visual elements, visualizations, visual effects, animations, interface elements, details, artwork, imagery, visual content, screensavers or backdrops, etc.

The user interface 600 can include, depict, implement, and/or can be customized based on a theme(s). The background 602 can additionally or alternatively be customized based on or according to a theme(s), such as a theme(s) of user interface 600 and/or a different theme(s). For example, the background 602 can include one or more elements of a theme, such as colors, attributes, content, artwork, imagery, color schemes, designs, styles, visual effects, visual elements, animations, and/or any other features of a theme of user interface 600 (and/or a different theme). In FIG. 6A, the theme(s) of user interface 600 and background 602 includes a city theme.

In some cases, the theme (or aspects thereof) of user interface 600 and/or background 602 (e.g., the city theme) can be depicted, implemented, and/or configured using visual elements, such as colors, images, content items, animations, objects, graphics, artwork, interface elements, and/or any other theme elements/features. In FIG. 6A, the visual elements 324A-C, 412, and 404B-D in user interface 600 and background 602 are associated with the city theme. For example, the visual elements 324A-C, 412, and 404B-D can include, depict, convey, and/or incorporate the city theme (and/or aspects thereof), features of the city theme, and/or an associated look or experience.

To illustrate, visual elements 324A-C and 404B-D depict things associated with cities, such as bridges, buildings, structures (e.g., parks, benches, roads, garages, etc.), landmarks, cityscapes, scenes, vehicles, a Ferris Wheel, a volcano, etc. Any visual element in user interface 600 can optionally include or represent a reference to a content item. The reference to the content item can include or depict a feature (e.g., object, character, message, scene, landscape, landmark, activity, event, animal, graphic, building, structure, animation, content, etc.) associated with the content item (e.g., depicted in or within the content item, included in or within the content item, corresponding or correlated to the content item, etc.). The reference to the content item can include or represent a hidden message or clue associated with the content item, such as a reference to something in the content item that is added to user interface 600 as a hidden message or clue to entertain the user(s) 140 (e.g., by testing the user's ability to recognize the visual element as a reference to the content item or associate the visual element with the content item, by providing the visual element as part of a game or activity such as a scavenger hunt or trivia challenge, etc.).

A visual element configured as a reference, hidden message, or clue associated with a content item can include and/or depict anything from the content item such as an object, character, scene, graphic, content item, building, structure, shape, animal, person, vehicle, logo, landmark, infrastructure, animation, element, symbol, pattern, device, and/or any other item associated with the content item. Some or all of the users who view the visual element may be able to associate the visual element with the content item and recognize the visual element as a reference to the content item. Such users can recognize the reference to the content item as part of an immersive/engaging experience with user interface 600, a game or activity provided by user interface 600 (e.g., a scavenger hunt, a challenge, a trivia game, a questionnaire, a competition with other users, a test of the user's knowledge about the content item, etc.), a challenge that allows users who successfully identify the reference associated with the visual element (and/or a certain number of references associated with a certain number of visual elements) to win benefits (e.g., points, credits, subscriptions, add-on features, discounts, opportunities to be promoted on user interface 600, etc.) for identifying the reference (and/or the number of references), any activity or event, and/or entertain the user(s) 140.

A visual element(s) depicted in user interface 600 can be associated with a theme(s), content, campaign, and/or promotion associated with user interface 600. For example, in FIG. 6A, the user interface 600 includes promoted content 608 and visual element 404C depicts the Eiffel Tower from Paris (or a representation thereof). The promoted content 608 includes content related to the Paris Olympics, such as a video, stream, and/or recording of the Paris Olympics (or one or more events of the Paris Olympics. Like the Paris Olympics, the Eiffel Tower is also in Paris and thus similarly relates to Paris. Accordingly, the visual element 404C depicting the Eiffel Tower is also associated with or related to the promoted content 608 depicted in the user interface 600.

The background 602 (and/or a feature(s) of the background 602 such as a color, pattern, attribute, object, character, content, style, shape, visual effect, screensaver, visual element, interface element, design, animation, characteristic, detail, aesthetics, appearance, etc.) can be predetermined for user interface 600 or selected when user interface 600 is launched (e.g., dynamically or in real-time). The content section 604 can include content of or accessible from user interface 600. In FIG. 6A, the content section 604 includes content items 606A-N such as movies, TV shows, TV channel feeds, podcasts, video games, etc. The content items 606A-N can optionally be depicted and/or organized within tiles in content section 604. The content in content section 604 may or may not be associated with the theme(s) of the user interface 600. For example, the content can include content selected for or based on the theme(s) of user interface 600.

The content in the content section 604 can additionally or alternatively include prioritized content (e.g., prioritized by the user(s) 140, a user group, the content platform associated with the user interface 600, a business, a sponsor, etc.), preferred content (e.g., content preferred by or matching a preference of the user(s) 140, a user group, a business, the content platform, a sponsor, etc.), sponsored content, promoted content, content associated with a user/group activity or statistic (e.g., content with a threshold statistic such as popularity or view/play counts, content previously started by a user or group, content selected based on a watch history of a user or group, content designated as a favorite or added to a list of content to watch by a user or group, etc.), trending content, recommended content, contextually-relevant content, content matching a selection criteria, content associated with a weight or bias, etc.

For example, the content items 606A-N (collectively “content items 606” hereinafter) in content section 604 can include content selected for the user(s) 140, content associated with a category, content recommended to the user(s) 140 (and/or a group including user(s) 140), content recommended or suggested by UI management system 130, content having a threshold popularity, content having a trend score, content having a threshold relevance to one or more signals, content initiated by the user(s) 140 in a current or previous session, and/or any other content items.

The promoted content 608 can include a content item(s) selected for promotion via user interface 600, such as an advertisement, a promoted movie or show, etc. The promoted content 608 can additionally or alternatively include content associated with or selected based on a theme of user interface 600, content associated with or selected based on a topic or event, a contextually-relevant content (e.g., content having a threshold relevance to a context), content personalized for and/or targeting the user(s) 140, and/or any other content. In some examples, the promoted content 608 can include content determined based on a context of user(s) 140, a date (e.g., temporally-relevant content) when user interface 600 is displayed, a calendar, a topic (e.g., a topic associated with a previous, current, and/or scheduled event, activity, promotion, trend, etc.), a location associated with user(s) 140 and/or media device(s) 104, and/or any other signal(s). For example, if user interface 600 is displayed during the Olympics, the promoted content 608 can include a video, channel, page, advertisement, feed, animation, video game, and/or any other content of or associated with the Olympics (or an Olympic event). If user interface 600 is presented on election day in the United States, the promoted content 608 presented to users in the United States on election day (and/or within a time period) can include a video, channel, feed, page, animation, advertisement, and/or any other content related to the election. If a topic is trending on social media, the promoted content 608 presented while the topic is trending can include content associated with the trending topic.

The content section 610 can include content items 612A-N (collectively “content items 612” hereinafter). In FIG. 6A, the content section 610 includes a channels section. As such, the content items 612 can include content channels, such as TV channels, movie channels, media streaming application channels, etc. For example, the content items 612 can include channels that the user(s) 140 has access to, is subscribed to, has an account for, has accessed in a session, has watched, has added to a favorites list, has added to content section 610, has interacted with, has requested, has a likelihood of interest in, etc. The user interface 600 can optionally include menu 340. The menu 340 can include menu items such as toolbars or toolbar items, controls, options, content categories, links, etc.

In some cases, user interface 600 can include a user avatar 626. The user avatar 626 can include a picture of the user(s) 140 (with or without modification), an AI-generated image of the user(s) 140, an image of the user(s) 140 generated based on one or more photos of the user(s) 140 (e.g., uploaded by the user(s) 140, retrieved from a library of the user(s) 140 that includes the one or more photos, accessed from a source selected by and/or given access by the user(s) 140, etc.), and/or any other visual representation of the user(s) 140. For example, the user(s) 140 can provide UI management system 130 (and/or a content platform associated with user interface 600) access to a library of photos of the user(s) 140 and/or upload one or more photos to UI management system 130 (e.g., via user interface 600 or another user interface) and/or an associated content platform. UI management system 130 can access a photo(s) of the user(s) 140 and use the photo(s) as user avatar 626 or to generate user avatar 626.

In some cases, UI management system 130 can modify the photo based on a theme of user interface 600, a content depicted in user interface 600, a user preference or input, a context, and/or any other signal. For example, if user interface 600 includes a space theme, UI management system 130 can modify a user photo to add a space theme. UI management system 130 can add a space background, dressing the user(s) 140 depicted in the photo in an astronaut suit, adding features to the depiction of the user(s) 140 in the photo from the space theme, modifying an appearance of the user(s) 140 in the photo to include characteristics associated with a space-related being (e.g., an alien or space creature, an astronaut or a space entity such as a space agency, etc.), and/or applying other space-related modifications.

In some aspects, the user avatar 626 can be selected and displayed in user interface 600 based on an availability of user avatar 626, a user input/request, a type of content and/or session associated with user interface 600, a user profile, a pattern of activity (e.g., a content pattern, a pattern of interactions, etc.) detected by UI management system 130 and/or a content platform associated with user interface 600, a prediction of a user accessing and/or viewing user interface 600, and/or any other factors. For example, UI management system 130 can detect a presence of the user(s) 140 and, based on the presence of the user(s) 140, select and activate a user profile of the user(s) 140 for use when presenting/configuring user interface 600 to the user(s) 140 and/or in a session associated with user interface 600. Based on the selection and activation of the user profile, UI management system 130 can select or generate the user avatar 626 associated with the user(s) 140 and display the user avatar 626 in user interface 600.

In some examples, user interface 600 can provide one or more animations. The one or more animations may or may not relate to a theme of user interface 600. The one or more animations can provide an immersive experience for the user(s) 140, entertain the user(s) 140, help the user(s) 140 explore or discover content and/or features available on the user interface 600, educate the user(s) 140 about a feature(s) and/or associated functionality, promote content and/or features to the user(s) 140, interact with the user(s) 140, etc. For example, user interface 600 includes an animation used to bring the attention of the user(s) 140 to a content item 606C promoted by user interface 600. The promoted content item 606C can include a movie, show, advertisement, video game, or any other content. The animation may or may not relate to the content item 606C and/or a theme of the content item 606C. For example, in FIG. 6A, the content item 606C includes a promoted space movie. The animation includes a spaceship 614. The spaceship 614 can appear in user interface 600 while carrying the content item 606C. The spaceship 614 can move while carrying the content item 606C towards a location 616 (e.g., a content slot, tile, destination, space, container, holder, etc.) within user interface 600. The location 616 in FIG. 6A is a location within content section 604. When the spaceship 614 is above the location 616, the spaceship 614 can release the content item 606C to drop the content item 606C on the location 616. The content item 606C can fall from the spaceship 614 and land in the location 616. The content item 606C can then be displayed at the location 616 within content section 604.

The user interface 600 displays another animation. The other animation can be part of an activity, such as a game (e.g., a scavenger hunt, a search game, etc.), and/or can be used to entertain the user(s) 140, draw the attention of the user(s) 140 to something in user interface 600, and/or interact with the user(s) 140. For example, the content item 606N in content section 604 is a sports content item with a cover, thumbnail, and/or representation that depicts an athlete 618. As part of the animation, the athlete 618 can appear to jump out of the content item 606N and move to another portion/region of user interface 600. In an illustrative example, the athlete 618 can move to a location 620A on top of the promoted content item 608 and sit or stand on the promoted content item 608. This way, the animation of the athlete 618 can draw an attention of the user(s) 140 to the promoted content item 608, which may highlight or promote the promoted content item 608 and/or draw the user(s) 140 to access the promoted content item 608.

In another example, the athlete 618 can jump out of the content item 606N and move to location 620B in user interface 600 to draw the attention of the user(s) 140 to location 620B. Here, the location 620B is behind content item 612D. The athlete 618 can hide behind the content item 612D to draw the attention of the user(s) 140 to the content item 612D (e.g., to promote or highlight the content item 612D, etc.), drive the user(s) 140 to the content item 612D, entertain the user(s) 140, or as part of a game or activity such as a scavenger hunt. In another example, the athlete 618 can jump out of the content item 606N and move to location 620C in user interface 600. At location 620C, user interface 600 can present a prompt 622 from the athlete 618 asking a question to the user(s) 140. The question can be part of an activity, such as a game, and/or an experience provided to the user(s) 140. The question can additionally or alternatively be used to seek information from the user(s) 140. Such information can be used to enhance a content experience of the user(s) 140, recommend content to the user(s) 140, customize content depicted and/or provided via user interface 600, modify or customize user interface 600 (or any aspect thereof), customize the user avatar 626, select a user profile associated with the user(s) 140, customize what content and/or features are provided to the user(s) 140 on user interface 600, customize a theme of user interface 600, test the user(s) 140 as part of a game or challenge, etc.

In FIG. 6A, prompt 622 includes a question asking the user(s) 140 what is the favorite sport of user(s) 140. The user(s) 140 can provide an answer to the question. UI management system 130 can optionally use the answer to customize an experience of the user(s) 140, gather information from the user(s) 140, interact with the user(s) 140, customize user interface 600 (and/or any aspect thereof such as a content thereof, the user avatar 626, etc.), customize another page or user interface presented to the user(s) 140, etc. For example, the user(s) 140 can provide answer 624 in response to the prompt 622. In this example, the answer 624 indicates that basketball is the favorite sport of the user(s) 140. UI management system 130 can use answer 624 to modify or customize any aspect of user interface 600, another user interface, a content experience for the user(s) 140, etc. For example, with reference to FIG. 6B, UI management system 130 can use the answer 624 to provide a personalized user interface 650 to the user(s) 140. The personalized user interface 650 can include or represent a version of user interface 600 in FIG. 6A that is personalized to the user(s) 140 based on answer 624.

As shown, the user interface 650 replaces content section 610 in FIG. 6A, which includes quick access content items, with content section 652 in FIG. 6B. The content section 652 represents a content section named “Basketball Zone” in FIG. 6B because it includes content items 654A-N (collectively “content items 654” hereinafter) associated with basketball (e.g., from a basketball category). The content items 654 can include basketball movies, shows, news, live games, video highlights, video games, documentaries, channels, media applications, podcasts, XR experiences, and/or any other content items associated with basketball. For example, in FIG. 6B, the content item 654A includes a basketball highlights video and/or a tile that the user(s) 140 can use to access basketball highlight videos, content item 654B includes a live basketball stream or a tile that the user(s) 140 can use to access live basketball streams, the content item 654C includes a basketball news feed and/or a tile that the user(s) 140 can use to access basketball news feeds, the content item 654D includes a basketball movie and/or a tile that the user(s) 140 can use to access basketball movies, the content item 654E includes a video of a basketball game, the content item 654F includes a basketball video game, the content item 654G includes a basketball channel (e.g., a channel that includes basketball content such as news, live streams, videos such as movies and TV shows, etc.), and the content item 654N includes a basketball podcast. As shown, the content items 654 are tailored to include basketball content based on the answer 624.

The answer 624 can additionally or alternatively be used to personalize other aspects of user interface 650. For example, in FIG. 6B, user interface 650 includes promoted content item 656. Like promoted content item 608 in user interface 600, promoted content item 656 in user interface 650 relates to the Paris Olympics. However, promoted content item 656 is personalized based on the answer 624 to include basketball content. As shown, promoted content item 656 includes a live basketball game from the Paris Olympics promoted to the user(s) 140 such that promoted content item 656 is tailored to include basketball content from the Olympics.

The answer 624 can be used to customize other aspects of user interface 650, such as background 602, the theme(s) of user interface 650, content section 604, user avatar 626, and/or any other aspect of user interface 650. For example, user avatar 626 can be customized to depict the user(s) 140 with a basketball jersey, basketball headband, basketball background, basketball logo, basketball team color, etc.

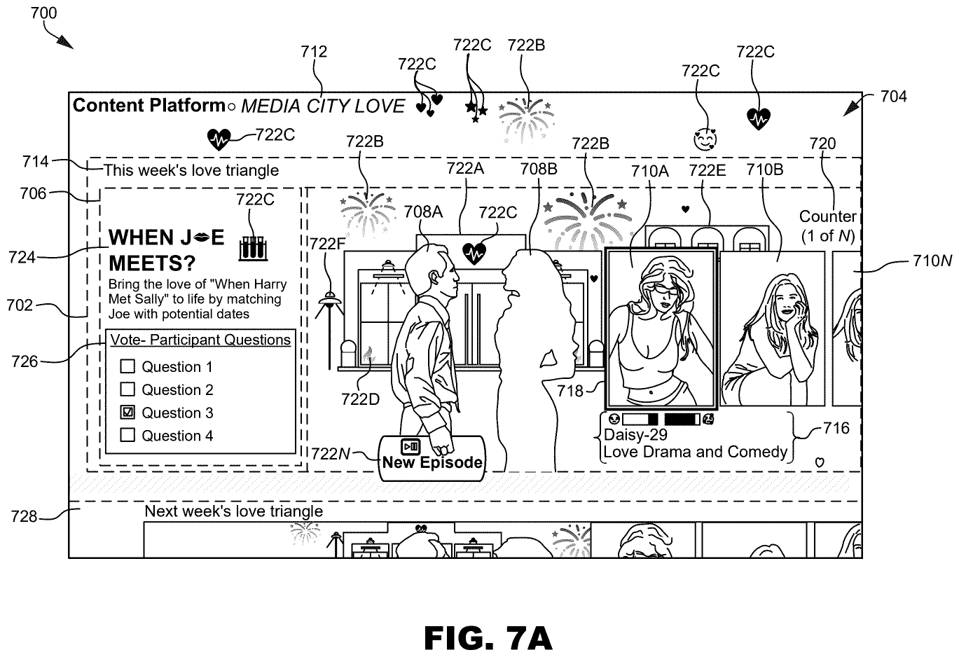

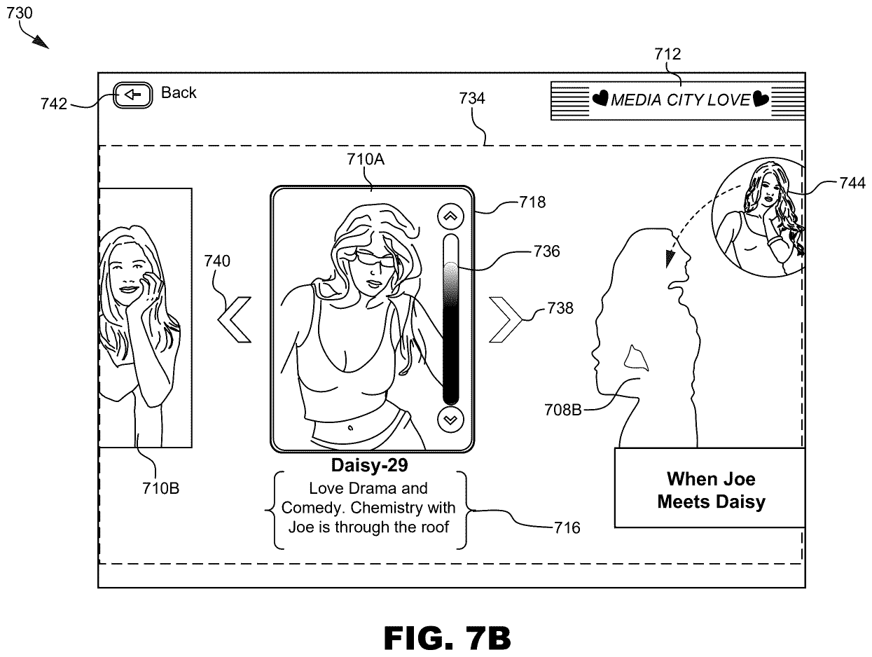

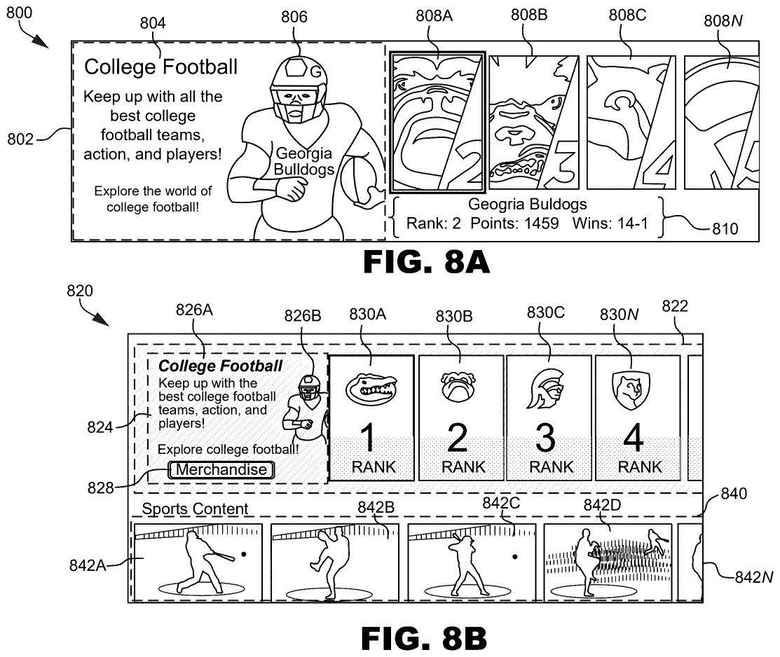

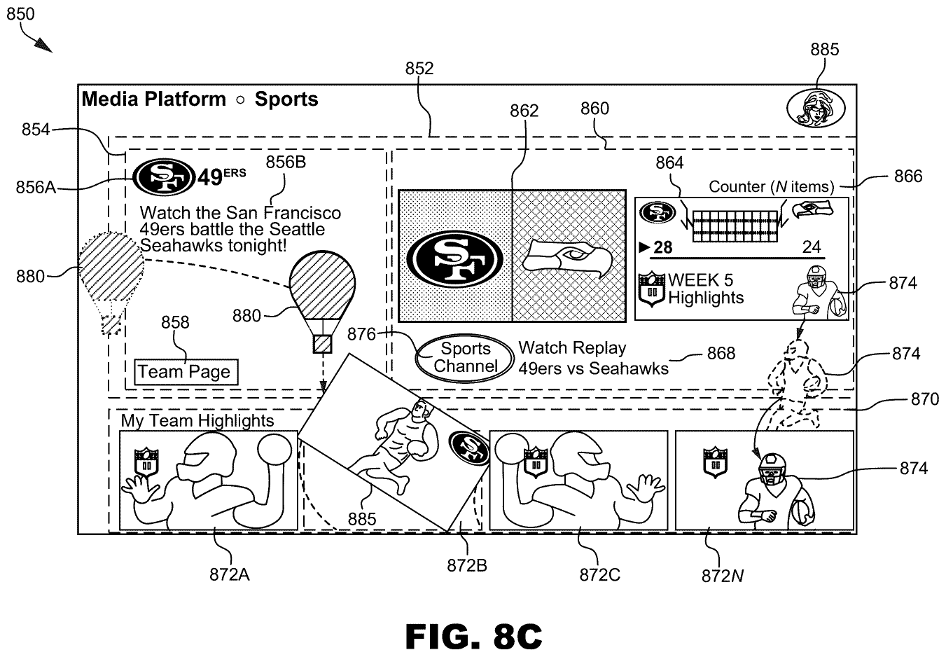

The user interfaces described herein can organize, display, arrange, and/or provide content, graphics, and/or UI elements (e.g., tiles, cards, buttons, controls, badges, sheets, sliders, menus, overlays, tabs, popups, textboxes, carousels, knobs, tooltips, input elements, links, boxes, scrollbars, contextual menus, pickers or selectors, checkboxes, dropdowns, navigation elements, snackbars, toggles, etc.) any UI element, design, and/or configuration. In some cases, a user interface can organize, display, arrange, and/or provide content, graphics, and/or UI elements (e.g., tiles, cards, etc.) within a UI row or column (e.g., frameless or with frames/borders), a UI container such as a UI banner or UI section container that includes content and/or UI elements (e.g., tiles, cards, etc.), an interface page, a window or inline frame (iframe), and/or any other UI element, design, and/or arrangement. For example, a user interface can organize, display, arrange, and/or provide content and/or UI elements such as tiles and/or cards in one or more rows, columns, or UI containers (e.g., UI banners, UI section containers, etc.) that are customized based on a theme(s), such as the UI containers displayed by the user interfaces illustrated in FIGS. 7A-8C.

A UI container can include a layout and/or container element used to group, organize, arrange, contain, provide, hold, and/or display items (e.g., content, UI and/or page elements, graphics, call-to-action components, etc.) within the user interface such as, for example and without limitation, a frame (e.g., a window, viewport, etc.) with or without a visible border, a section container that groups items into a section (e.g., a sidebar, a footer, a header, etc.), a UI banner with or without a visible border (e.g., frameless or with a visible frame), a grid container that arranges items into a grid layout, a card container configured to display items (e.g., text, graphics, UI elements, content, etc.) within a card-like design (e.g., within a square or rectangle card), a box (e.g., a horizontal box, a vertical box, etc.), a modal container containing or holding a modal window or dialog box, a scroll container with scrolling functionality, a panel container that includes a visual border or frame around items within the panel container, a tile, center container that contains items that are centered within the center container, a split container that divides a space into sections, and/or any other layout and/or container element.

As described below, a UI container can include a UI banner. The UI banner can include one or more rows or columns of items such as content, animations, text, UI elements (e.g., UI cards, tiles, call-to-action elements, input elements, display elements, etc.), and/or any other features. The UI banner (or any other UI container) can include/contain one or more items, group and/or organize items, convey information, provide a content experience (e.g., an interactive or immersive experience, a game, an activity, a call-to-action, etc.), surface information, provide a customized experience, etc. The UI banner (or any other UI container) may or may not include, depict, and/or implement a theme(s). The UI banner (or any other UI container) can tailor an appearance, content, experience, feature(s), and/or attribute(s) of the UI banner (or the other UI container) or a presentation of items in the UI banner (or the other UI container) based on one or more factors. For example, a UI container such as a UI banner can be tailored to and/or configured based on a user or group, a theme, an event, a topic, a context, a season, a date, an activity, a genre, a culture, a location or region, a language, etc. A UI container, such as a UI banner, can be part of the design of the user interface, the appearance of the user interface, an organization of the user interface, an immersive experience provided by the user interface, a user interface structure, etc.

FIG. 7A illustrates an example of a user interface 700 customized based on a theme(s) and that includes a UI container 702. The user interface 700 includes UI container 702. In this example, UI container 702 is a UI banner. The UI banner is an illustrative example UI container provided for explanation purposes. In other examples, UI container 702 can include any other type of layout and/or container element such as, for example, a frame or iframe, section container, grid container, card container, box (e.g., horizontal box, vertical box, etc.), modal container, scroll container, panel container, tile, split container, etc.

The user interface 700 can optionally include a text portion 712 and/or background 704. The text portion 712 can display text content, such as a title of user interface 700, a text description of user interface 700, a title or description of a theme(s) associated with user interface 700 and/or UI container 702, a text message, etc. The UI container 702 can include, depict, host, group, organize, and/or contain items, UI elements (e.g., UI cards, tiles, call-to-action elements, input elements, etc.), a content experience(s), and/or any other feature(s). UI container 702 can optionally include a title 714. The title 714 can include a title of content in UI container 702, a title or description of a theme of UI container 702, a title or description of a content item associated with UI container 702 and/or a theme of UI container 702, a title or description of an episode of a content item associated with UI container 702 and/or a theme of UI container 702, and/or any other features of UI container 702 and/or a theme of UI container 702. UI container 702 can additionally or alternatively include one or more content items, sections, UI elements, spaces, rows, grids, etc.

The UI banner associated with UI container 702 can have a static or dynamic shape, such as a static or dynamic width and/or height. UI container 702 can be placed, arranged, and/or depicted on or across a specific region(s) of user interface 700. For example, UI container 702 can be located across a top portion of user interface 700 such that a top edge of UI container 702 (e.g., an edge along an x or horizontal plane) overlaps with a top edge of user interface 700 and an opposite edge of UI container 702 (e.g., a bottom edge of UI container 702 that is opposite and parallel to the top edge of UI container 702) is located away from the top edge of UI container 702, in a direction towards a bottom edge of user interface 700, by a distance that is equal to the banner height. In other cases, UI container 702 can be located across a bottom portion of user interface 700 such that a bottom edge of UI container 702 along an x or horizontal plane overlaps with a bottom edge of user interface 700 and a top edge (e.g., opposite/parallel to the bottom edge) of UI container 702 is located away from the bottom edge of UI container 702, in a direction towards a top edge of user interface 700, by a distance that is equal to the banner height. In yet other cases, UI container 702 can be located across another portion of user interface 700 such as a middle portion or any other portion where the top edge of UI container 702 is below the top edge of user interface 700 and the bottom edge of UI container 702 is above the bottom edge of user interface 700.

In some cases, UI container 702 can be shaped as a column (and/or contain items arranged as a column) and/or located within a column of user interface 702. The column can have one edge along a vertical plane (e.g., a y plane) that overlaps with a left or right edge of user interface 700 (e.g., along the vertical plane) and an opposite edge that extends towards an opposite edge of user interface 700 by a distance that is equal to the banner width. In other cases, the column (or an edge thereof) of user interface 702 may not overlap with a left or right edge of user interface 700 (e.g., along the vertical plane). UI container 702 can be configured according to a size or shape, such as a rectangular, square, column, row, grid, circular or elliptical shape, and/or any other shape. While UI container 702 in FIG. 7A is shaped as a rectangle and includes items arranged in a row, UI container 702 can have any other shape and/or arrange items in any other grouping, arrangement, placement, and/or configuration. For example, UI container 702 can be configured as (and any items therein can be arranged in) a column, cloud, square, table, grid, circle or ellipse, and/or any other arrangement, geometric shape, configuration, etc. The row configuration in FIG. 7A is an illustrative example provided for explanation purposes. Moreover, UI container 702 can include any size (e.g., width, height, etc.), placement, design, and/or configuration not shown in FIG. 7A.

The user interface 700 and/or UI container 702 can include and/or be customized based on a theme(s). The theme(s) can be determined based on a topic(s), as previously explained. In FIG. 7A, user interface 700 and UI container 702 include and are customized according to a romantic city theme. The romantic city theme is selected based on a topic of a dating reality show (e.g., a reality TV dating show). The reality TV dating show and/or romantic city theme in this example can be based on, have a threshold relevance to, associated with, inspired by, and/or targeted to viewers or fans of a popular romantic comedy film named “When Harry Met Sally”. The reality TV dating show includes contestants/participants who compete for a date, relationship, and/or romance with a main character (e.g., a bachelor) named Joe. The show starts with contestants/participants engaging in challenges and/or having dates with Joe in the hopes of being picked by Joe. At the end of each round, Joe selects one or more contestants to remain in the show and at least one contestant eliminated from the show. The show includes a number of rounds where contestants/participants are selected to stay or leave until a winner is selected.

The show may be selected as the source of the romantic city theme based on a relevance of the show (e.g., a relevance to a day when user interface 700 is presented, a relevance to the user(s) 140 or a user preference, a relevance of a release date of the show to a date when user interface 700 is presented, a relevance to a user group or demographic, a relevance given a trend/popularity metric associated with the show, a relevance given a statistic associated with the show, a relevance to a context associated with the user(s) 140, etc.). For example, if the show airs on the day when user interface 700 is presented, the show may be identified as a relevant topic on that day. The topic associated with the show can be used to select the romantic city theme.

As another example, if UI management system 130 determines that the reality TV dating show is a trending topic (e.g., based on a threshold number of views, social media posts/comments, references in other media content and/or a public discourse, purchases, subscriptions, votes for contestants, etc.), UI management system 130 may select the show as a topic used to determine a theme for user interface 700 and/or UI container 702. UI management system 130 can use such topic to select the romantic city theme. The show is an example topic or content item used to select a theme for user interface 700 and/or UI container 702, and the romantic city theme is an example theme implemented by user interface 700 and UI container 702. In other examples, user interface 700 and/or UI container 702 can implement a different theme, and selected theme can be based on a different topic.

UI container 702 can optionally promote content such as the reality dating show (or an episode or merchandise thereof), a sponsor, an advertisement, and/or other content. Moreover, the configuration and/or design of user interface 700 and UI container 702 (e.g., content, layout, artwork, visual attributes, UI elements, shape, arrangement, content experiences, visual effects, visual elements, colors, color schemes, images/imagery, background, content elements, organization, style, and/or any other features) can be customized based on the romantic city theme, immerse users in the theme, engage users via the theme, etc. In some cases, as part of the romantic city theme, UI container 702 can include content associated with the reality dating show, display information about the show, include interactive content (e.g., a game/activity) associated with the show, depict features (e.g., visual elements, artwork, colors, logos, patterns, designs, attributes, etc.) associated with the show, display a background associated with the show, display characters and/or objects associated with the show, include content and/or interface elements associated with the show and/or the romantic city theme, etc. To illustrate, if the reality TV dating show is associated with a background (e.g., because a content used to promote the show includes that background, that background resembles a background depicted in the show or a scene of the show, that background matches or has a similarity to a background in an advertisement or other content or event of the show, etc.), user interface 700 and/or UI container 702 can depict that background or a background configured based on that background. This way, the background used for the theme of UI container 702 can be based on or have a correlation, relationship, similarity, and/or resemblance to a background associated with the show.

If the show has previously depicted (or is known for depicting) contestants in a school yearbook format with a grid of thumbnails containing pictures of contestants, UI container 702 may depict contestants (e.g., representations of contestants, content items depicting the contestants and/or representations thereof, etc.) of the show within UI container 702 in a school yearbook format that includes a grid of thumbnails. This way, the theme of UI container 702 can include a format/configuration that matches, relates to, resembles, correlates to, has a similarity to, and/or is associated by users to the show.

In FIG. 7A, user interface 700 and UI container 702 include a background 704. The background 704 can optionally be based on, depict, include, and/or implement a theme(s). The theme(s) may or may not include a theme(s) of user interface 700 and/or UI container 702, such as the romantic city theme. For example, the background 704 can include content, a backdrop or background image, a screensaver, a scene (e.g., a landmark, a building, a house, a cityscape, etc.), one or more visual elements, one or more features (e.g., one or more colors, shapes, patterns, images, designs, color schemes, animations, videos, content items, interface elements, graphics, views, objects, artwork, etc.), a visual attribute(s), animated content, a background style(s), a background design(s), a background content organization/arrangement, content item references (and/or hidden messages or clues), and/or any other features which may or may not depict, include, and/or implement/incorporate the romantic city theme of user interface 700 and UI container 702, and/or may or may not be associated with (e.g., from, of, inspired by, related to, based on, corresponding to, etc.) the reality TV dating show associated with the romantic city theme.

To illustrate, the background 704 may depict a house where the reality dating show (or any scene or portion thereof) takes place or is filmed, a house where contestants of the show live during the show, something from the show (e.g., house, scene, object, character, logo, color scheme, landmark, view, building, structure, animal, vehicle, view, graphic, etc.), features (e.g., one or more visual elements, colors, color schemes, attributes, objects, graphics, artwork, images, animations, content items, scenes, etc.) associated with the show, visual elements associated with the show, etc. The features associated with the show can include features from the show, correlated to the show, selected based on the show, and/or designed to invoke or convey a mood, scene, and/or motif (e.g., a dating, romantic, night, and/or any other mood, scene, and/or motif) associated with (e.g., that matches, relates to, corresponds to, has a threshold relevance to, has a threshold similarity to, is based on, conveys, includes, etc.) a mood, scene, and/or motif of the show. The background 704 can additionally or alternatively include a theme(s) that is different from a theme(s) of user interface 700 and/or UI container 702. For example, the background 704 can include a theme(s) that is different from the romantic city theme of user interface 700 and UI container 702.

User interface 700 and/or UI container 702 can include visual elements 722A-N (collectively “visual elements 722” hereinafter). The visual elements 722 can be part of the theme of user interface 700 and/or UI container 702, selected based on such theme, associated with such theme, configured based on such theme, customized according to such theme, used to implement such theme, and/or configured to depict an aspect of such theme. For example, visual element 722A depicts a building from the reality dating show associated with the romantic city theme of user interface 700, visual elements 722B depict fireworks to convey a romantic mood, visual elements 722C include romantic emojis (e.g., emojis determined to convey a romantic mood or motif such as heart emojis, star emojis, smiling face emojis, a chemistry emoji, etc.), visual element 722 depicts a fireplace inside of the building associated with visual element 722A which provides a romantic mood (e.g., is associated with a mood classified as a romantic mood) and represents a content reference that relates to the romantic city theme (e.g., is a reference to a fireplace in a movie or TV show and can optionally represent a hidden message or clue associated with that movie or TV show), visual element 722E depicts a building from a romantic movie and is part of the romantic city theme and represents a reference to the romantic movie (and optionally a hidden message or clue associated with the romantic movie), visual element 722F depicts a lamp from a romantic city scene in a movie and is part of the romantic city theme (and optionally represent a hidden message or clue associated with that movie), and visual element 722N depicts an object promoting an episode of the reality dating show.

The visual element 722N can optionally include a link or selectable object that the user(s) 140 can select or activate to access and/or watch the episode of the reality TV dating show promoted by visual element 722N, play/stream the episode, navigate to a destination where the user(s) 140 can watch or play/stream the episode, load the episode, purchase the episode, subscribe to the episode (or a channel or application that has the episode and can be used to watch the episode), and/or access information and/or content associated with the episode. In some cases, UI container 702 can include sections (e.g., one or more content sections, interface spaces, interface frames, etc.). For example, UI container 702 can optionally include a section 706 that includes features (e.g., content, UI elements, information, etc.) associated with UI container 702, the theme of UI container 702, and/or the reality TV dating show associated with the theme of UI container 702. In FIG. 7A, the section 706 includes a text portion 724 and UI element 726. The text portion 724 includes information about the reality TV dating show such as a title, a summary or description, a schedule, information about an episode(s), information about a status of a competition, sponsored content, and/or any other content and/or information associated with the show. UI element 726 can include content and/or a content experience, such as an interactive content or experience, associated with the reality TV dating show (e.g., a game, challenge, survey, prompt, activity, animated interactive experience, XR experience, option to submit a vote associated with the show, etc.). For example, in FIG. 7A, UI element 726 includes a prompt with a question. The prompt can allow the user(s) 140 to vote on a question that the main character (e.g., the bachelor Joe) in the reality TV dating show should ask remaining participants of the show in a future round or challenge. The prompt may additionally or alternatively include other voting options, such as options to vote for remaining participants from the show, a predicted or preferred winner of the show, activities or challenges for the remaining participants in the show, outfits that Joe or any participant(s) can wear in a round or challenge/activity, and/or any other voting options.

In some cases, UI container 702 can include an image 708A of Joe. UI container 702 can optionally include a silhouette 708B depicting an outline of a participant of the show (e.g., a winner of the show or a round, an eliminated participant, a participant with the highest or lowest votes from the public, etc.) or an image of any participant of the show. In some cases, the silhouette 708B may not initially depict a specific person but can be updated to display (e.g., to be filled in with an image of) a specific person (e.g., a participant, a user, etc.), such as a winner of the show or a round of the show such that the silhouette 708B initially depicts a representation of an unknown participant (e.g., an outline of a non-specific person) but is later updated to depict a participant (e.g., once the participant is known or selected).

In some cases, the silhouette 708B may depict or be updated to depict a user, such as user(s) 140 or a winner of a game associated with user interface 700. For example, the silhouette 708B can be updated to depict or be filled with an image of the user(s) 140 such as a real picture of the user(s) 140, an image of the user(s) 140 generated by UI management system 130 (e.g., via an AI/ML model), an image of the user(s) 140 customized by UI management system 130, an image of the user(s) 140 from an avatar of the user(s) 140 or a photo album of the user(s) 140, or any other representation of the user(s) 140. The silhouette 708B is depicted next to (adjacent to) the image 708A of Joe. However, in other examples, the image 708A of Joe and the silhouette 708B can be displayed in another configuration or arrangement (or excluded).

UI container 702 can include UI elements such as tiles, cards, navigation elements, interactive elements, section elements, container elements, display elements, input elements, visual elements, and/or any other elements. In FIG. 7A, UI container 702 includes tiles 710A-N (collectively “tiles 710” hereinafter). The tiles 710 are associated with the reality dating show. The tiles 710 include images, thumbnails, or profiles of contestants in the show. The tiles 710 can be static (e.g., not selectable or dynamic), dynamic, or interactive. For example, the tiles 710 can be selectable to retrieve information about an associated contestant, interact with content associated with the associated contestant, provide an input associated with the contestant (e.g., vote for the contestant, submit a request for the contestant, purchase merchandise associated with the contestant, etc.), play/stream content associated with the contestant (e.g., videos with the contestant, highlights or video clips of the contestant, portions of the show that include the contestant, etc.), and/or initiate an activity associated with the contestant.

To illustrate, if the user(s) 140 selects tile 710A corresponding to “Daisy”, user interface 700, UI container 702, or tile 710A can display or load content associated with Daisy (e.g., a page, tile, showcase banner, window, interface, inline frame, video, image, tile content, etc.) such as information about Daisy, historical data associated with Daisy, votes received by Daisy, statistics of Daisy, and/or any information. In another example where tile 710A is selectable to initiate an interactive experience, if the user(s) 140 selects tile 710A, user interface 700, UI container 702, or tile 710A can load a game such as a reality game or a game with Daisy as a character (and/or themed according to the reality TV dating show). The user(s) 140 can participate in the game as Daisy or control (or request) actions of Daisy in the game. If the tiles 710 are configured to allow users to cast votes for corresponding contestants, user(s) 140 can select tile 710A to vote for Daisy (or select any other tile to vote for any other contestant) and optionally view information about Daisy such as votes or a percentage of votes received by Daisy (e.g., relative to other contestants).

In some cases, UI container 702 can display other types of tiles. For example, UI container 702 can display tiles of content items that the user(s) 140 can access, watch, play, and/or interact with via such tiles. To illustrate, UI container 702 can display tiles of videos, movies, TV shows, live streams or broadcasts, applications, channels, etc., which may or may not relate to the reality TV dating show, contestants of the reality TV dating show, and/or the romantic city theme. As previously noted, the tiles 710 in UI container 702 can include or correspond to contestants of the reality TV dating show. However, in some cases, the tiles 710 may correspond to other things. For example, the tiles 710 can correspond to content items available through user interface 700 and UI container 702, such as previous episodes of the show, recap or replay videos from the show, other shows, movies and/or TV shows (e.g., movies and/or TV shows related to a theme of the reality TV dating show, such as romance movies and/or TV shows), etc.

UI container 702 can optionally display metadata associated with any of the tiles 710. The metadata of a tile can be displayed relative to that tile (e.g., under, next to, above, adjacent to, inside/within, etc.). For example, in FIG. 7A, UI container 702 includes metadata section 716 below the 710A. The metadata section 716 can include information about Daisy and/or any associated information, UI elements, visual elements, etc., such as a voting meter, emojis, symbols, statistics, merchandise, a call-to-action (CTA), etc. In this example, the metadata section 716 includes a name and age of the contestant associated with the tile 710A (Daisy), information about the contestant (e.g., Daisy loves true crime and stand-up), and voting meters or bars indicating how many votes have been cast for and against the contestant. However, the metadata section 716 can include other information, in addition to or instead of what is shown in FIG. 7A.

In some cases, each of the tiles 710 can include its own metadata section. In other cases, only a subset of the tiles 710 may include a respective metadata section. For example, in FIG. 7A, only tile 710A includes a metadata section. The metadata section 716 is displayed for tile 710A because the tile 710A has been selected by the user(s) 140, as depicted by the outline 718 (or highlight) around tile 710A. In other cases, UI container 702 can include a respective metadata section for the tile corresponding to the contestant with the most votes (or the top n number of tiles corresponding to the top n number of contestants with the most votes) or the tile(s) corresponding to any other contestant(s) (e.g., a favorite or most popular contestant(s) to the user(s) 140 or an audience, a contestant(s) that has been selected to continue to a next round or eliminated from a next round, etc.). In some examples, when the user(s) 140 selects a tile, user interface 700 can update a presentation of the tile to show that the tile has been selected.

In some examples, if the tiles contained/hosted in/by UI container 702 (e.g., the number of tiles included based on the number of participants or remaining participants in the show) do not fit within the display area of UI container 702, UI container 702 can be configured to allow users to scroll to other tiles and/or change which tiles are shown within UI container 702. For example, in FIG. 7A, tile 710N does not fit entirely within a current view of user interface 700 and is partially truncated. However, UI container 702 may be scrollable to allow the user(s) 140 to scroll through UI container 702 to bring the rest of the tile 710N (and, optionally, any other tiles that are not shown in FIG. 7A) within view (e.g., within a view of user interface 700). In some cases, rather than truncating a tile that does not fit within user interface 700 (e.g., instead of showing a partial tile), UI container 702 may remove the tile from a current view of user interface 700 such that the user(s) 140 would need to scroll UI container 702 to see that tile.

In some cases, rather than truncating or excluding any tiles, user interface 700 can resize any of the tiles 710 so the tiles 710 fit within a view of user interface 700 and tile 710N is not truncated. When resizing tiles, the overall size (e.g., the height and/or width) and/or aspect ratio of all or some of the tiles 710 can be increased or decreased. Moreover, the tiles 710 can have (e.g., can be displayed according to) a same size and/or aspect ratio, or different sizes and/or aspect ratios. For example, to highlight or promote a tile(s), the size and/or aspect ratio of that tile(s) can be adjusted relative to other tiles to convey/indicate that such tile(s) is highlighted or promoted.

The size and/or aspect ratio of the tiles 710 and/or number of tiles to display within a view of UI container 702 without requiring a user to scroll UI container 702 can depend on one or more factors. The one or more factors can include a size of a screen used to display user interface 700, a resolution of the screen, a size of user interface 700 (e.g., a window size or a height and width of user interface 700), user preferences, a resolution of the tiles 710, a layout of the tiles 710 (e.g., landscape, portrait, etc.), an amount of space within UI container 702 used by other content/elements in UI container 702 (e.g., text section 706, image 708A, silhouette 708B, etc.), a type of device (and/or device characteristics) used to display user interface 700 (e.g., a TV, computer display or monitor, smartphone screen, smart glasses, HMD, smartwatch display, etc.), and/or other factors. In some cases, each of the tiles 710 can have a same shape and/or layout. In other cases, the shape and/or layout of the tiles 710 (or some of the tiles 710) can vary.

For example, the tiles 710 can be depicted in a landscape or portrait layout. In other cases, one or more of the tiles 710 can be depicted in a particular layout and one or more other tiles can be depicted in a different layout. To illustrate, tiles 710B and 710N can be depicted in a portrait layout and tile 710A can be depicted in a landscape layout because tile 710A is selected/highlighted (e.g., to show that tile 710A is selected/highlighted). The size and/or aspect ratio of any of the tiles 710 can be adjusted (e.g., increased, decreased) to convey information about such tile(s) and/or the other tile(s). For example, the size and/or aspect ratio of tile 710A can be increased relative to other tiles to show that tile 710A is selected/highlighted and/or to promote tile 710A. In some cases, the user(s) 140 can optionally resize any of the tiles 710 or provide sizing information used to resize any of the tiles 710. When resizing tiles, there may be constraints limiting how much a tile can be resized (e.g., reduced or increased in size or aspect ratio).

For example, the user(s) 140 or the device managing user interface 700 (e.g., UI management system 130 and/or the device displaying user interface 700) can provide rules specifying/setting a minimum tile size or aspect ratio to prevent tiles from being adjusted to a size below the minimum tile size or aspect ratio (e.g., to avoid tiles being reduced so much that users may have difficulty seeing such tiles or associated details) and/or specifying/setting a maximum tile size or aspect ratio to prevent tiles from being increased in size above the maximum size or aspect ratio. UI container 702 can optionally include a tile counter 720 that indicates the number of tiles in UI container 702.

The tile counter 720 can allow a user determine whether any tiles in UI container 702 are not visible within a current view of UI container 702 (e.g., to indicate whether the user needs to scroll UI container 702 to see other tiles). For example, if tile counter 720 indicates there are eight tiles in UI container 702 and only three tiles are shown in a current view of UI container 702 (e.g., tile 710A, tile 710B, and partial tile 710N), a user can determine that there are five other tiles in UI container 702 that are not shown/visible in UI container 702 (e.g., that are not within the currently visible portion of UI container 702). The other five tiles may not be visible because the eight tiles do not fit within the portion of UI container 702 that is visible within a current view of UI container 702. In such cases, UI management system 130, the user(s) 140, or the device displaying user interface 700 can determine whether to resize any or all tiles so more or all tiles fit and are visible within a view of UI container 702 without scrolling UI container 702.

For example, UI management system 130 can compare the user interface space available within UI container 702 for placing tiles and/or the screen size of user interface 700 with the number of tiles in UI container 702 and/or the total size of the tiles in UI container 702, to determine whether the tiles can be resized to fit within a visible portion of UI container 702. In some cases, UI management system 130 can take into account a minimum tile size defined (if any) to determine whether the tiles fit within the visible portion of UI container 702 without reducing the size of tiles below the minimum tile size. If UI management system 130 determines that all tiles do not fit within the visible portion of UI container 702 without reducing the size of tiles below a minimum size, UI management system 130 can determine whether to reduce the overall size of tiles enough to fit all tiles within the visible portion of UI container 702 (e.g., even if any tiles are reduced below the minimum tile size) or whether to reduce a subset of the tiles in a way that does not violate the minimum tile size requirement but increases the number of tiles that can fit (e.g., are visible) within a view of UI container 702.

UI management system 130 (or user(s) 140) can weigh whether to show all tiles within the visible portion of UI container 702 (e.g., without requiring the user(s) 140 to scroll UI container 702), which may require the tiles to be smaller than if some of the tiles are excluded or truncated, or show larger tiles, which may prevent all tiles from fitting within a visible portion of UI container 702 (and thus require the user(s) 140 to scroll to see one or more of the tiles). For example, if UI management system 130 (or user(s) 140) prioritizes showing all tiles within a visible portion of UI container 702 over showing larger tiles and consequently requiring the user(s) 140 to scroll UI container 702 to see some of the tiles, UI management system 130 (or user(s) 140) can reduce the overall size of the tiles to allow all tiles to be displayed within a visible portion of UI container 702 and avoid requiring the user(s) 140 to scroll UI container 702. Alternatively, if UI management system 130 (or user(s) 140) prioritizes showing larger tiles or avoiding reducing the size of the tiles (or any tile) below a certain size (e.g., even if that size is larger than the minimum tile size) over trying to fit all tiles within the visible portion of UI container 702, UI management system 130 (or the user) can select to display a subset of tiles according to a larger tile size (e.g., for each tile or the overall subset of tiles) and place any remaining tiles outside of the visible portion of UI container 702 such that the user(s) 140 would need to scroll UI container 702 to see such remaining tiles (e.g., to place them within the visible portion of UI container 702).

In some cases, the tiles 710 can be configured, modified, or tailored based on the theme of UI container 702. For example, the tiles 710 can depict participants of the reality dating show associated with the theme of UI container 702. The participants can be depicted with a background associated with the theme. In other examples, the user(s) 140 can revise the tiles 710 and/or the content depicted by the tiles 710 (e.g., participants). For example, the user(s) 140 can specify how a participant in a tile should be shown or modified. The user interface 700 can modify the depiction of the participant to show the participant as specified by the user(s) 140. To illustrate, if the user(s) 140 specifies a dark or light theme for the tiles 710, user interface 700 can depict the participants in the tiles 710 according to a dark or light theme.

In some examples, UI container 702 can include other features (e.g., content, visual elements, interface elements, objects, etc.) that are not shown in FIG. 7A. For example, UI container 702 can include UI elements that allow the user(s) 140 to provide an input(s), such as a CTA (e.g., a button, link, control, etc.) for initiating an action such as a purchase of merchandise related to the reality TV dating show, an element with a link to something such as content, a website (e.g., a website of the reality show, a sponsor, associated merchandise, etc.), an application (e.g., an application related to the show, a dating application, a social media application, or any other application), a channel, and/or anything else. In FIG. 7A, UI container 702 (e.g., the UI banner) is depicted without visible borders (e.g., frameless/borderless). In other examples, the UI banner can include any visible borders (e.g., can be framed with one or more borders).

The user interface 700 can optionally include other content sections. For example, user interface 700 can include content section 728. Content section 728 is depicted outside of UI container 702 (e.g., below UI container 702 or at any other location within user interface 700 and relative to UI container 702). The content section 728 can include content, UI elements, visual elements, and/or any other features that may or may not be associated with the reality TV dating show or implement the romantic city theme. For example, the content section 728 can include content related to the reality TV dating show (e.g., previous episodes, previous seasons, highlight videos, recap videos, preview videos or trailers, contestant videos, other images of one or more contestants, other images of Joe, etc.), related to other reality shows, related to a similar or relevant theme or genre (e.g., romance movies or shows, romance theme, etc.), unrelated to the show and/or theme (and/or to reality shows or romance), and/or any other content. The content section 728 can additionally or alternatively include other UI elements such as tiles (e.g., of other contestants, reality shows, content, etc.), content experiences, graphics, objects, UI containers, etc.

In some examples, the content section 728 may include content, UI elements, visual elements, UI elements, objects, a section, a background, etc., related to the reality TV dating show and/or UI container 702. For example, in FIG. 7A, the content section 728 includes a preview or representation related to a next episode of the reality TV dating show. Here, the content section 728 includes the image 708A of Joe, the silhouette 708B, and another UI container with UI elements (e.g., tiles) depicting contestants (e.g., other contestants, other arrangement of contestants, one or more contestants highlighted or promoted in a next episode of the show, etc.). The content section 728 can retain the theme of UI container 702, a version of the theme, and/or a different theme. For example, the content section 728 can include or retain the theme (and/or any aspects thereof) of UI container 702 or a version of the theme.

In an illustrative example, if the content section 728 relates to a next episode of the reality TV dating show and a contestant in the show reveals a health condition in the next episode, the revelation of the health condition can be used to promote awareness to such condition. As such, the content section 728 can incorporate aspects of the theme of the show similar to UI container 702 and/or aspects related to a theme of awareness to such condition. The user interface 700 (or any portion of the user interface 700) can optionally be personalized for a user. For example, user interface 700 can fill in the silhouette 708B with an image of the user(s) 140 and show the image 708A of Joe along with an image of the user(s) 140 depicted within the silhouette 708B. In some examples, the user(s) 140 can grant an application associated with user interface 700 access to a picture(s) of the user(s) 140. The application can access the picture(s) to obtain an image of the user(s) 140 to place over (e.g., fit within, filled into, etc.) the silhouette 708B (e.g., with or without modifications). The user interface 700 can optionally adjust the silhouette 708B to match the image of the user(s) 140 (and/or the outline or contour of the image) or vice versa. In some cases, the user(s) 140 can select an image and place it over the silhouette 708B. The user interface 700 can optionally adjust the silhouette 708B based on the image. In some cases, the user(s) 140 can grant the application access to a camera device to capture an image of the user(s) 140 to place over the silhouette 708B. In other cases, the application can use a generative AI/ML model to generate or modify an image of the user(s) 140 that can be placed on the silhouette 708B.

FIG. 7B illustrates an example user interface 730 depicting another UI container 734. The UI container 734 includes a UI banner. In FIG. 7B, the UI banner depicted by UI container 734 does not have visible borders (e.g., frameless). However, in other examples, the UI banner can include one or more visible borders. In some cases, user interface 730 can be displayed in response to an interaction with user interface 700 in FIG. 7A. For example, when the user(s) 140 selects tile 710A corresponding to Daisy, the selection of tile 710A can trigger user interface 730 to be loaded/displayed. The user interface 730 in this example displays a scenario generated based on the contestant associated with the selected tile (tile 710A). The scenario (e.g., theme, context, situation, etc.) is “When Joe Meets Daisy”, which highlights the contestant Daisy associated with tile 710A. UI container 734 can include a UI banner generated for the scenario. As shown, tile 710A associated with Daisy is highlighted, as indicated by the outline 718. Moreover, the metadata section 716 has been expanded to include more information about Daisy. UI container 734 partially shows tile 710B but does not show other tiles, as it is focused on Daisy.

Tile 710A includes an object 736 representing a score for Daisy. The score can represent a chemistry between Daisy and Joe, a number of votes for Daisy, a probability that Daisy will win the contest or a next round, or any other metric. In some cases, the object 736 can allow the user(s) 140 to vote for or against Daisy. For example, the object 736 can include an arrow pointing up in relation to the object 736 to indicate that the user(s) 140 can vote for Daisy by selecting the up arrow to increase the votes for Daisy, and optionally an arrow pointing down in relation to the object 736 to indicate that the user(s) 140 can vote against Daisy by selecting the down arrow. The object 736 can optionally include any other UI element, such as a button that the user(s) 140 can select to provide an input or specify how the user(s) 140 wants to vote. UI container 734 can include one or more navigation elements, such as navigation elements 738 and 740, that the user(s) 140 can select or activate to navigate or scroll through tiles in UI container 734.

For example, navigation element 738 can allow user(s) 140 to scroll (e.g., by selecting or activating navigation element 738) UI container 734 in a direction (e.g., to scroll to another tile) and navigation element 740 allows user(s) 140 to scroll UI container 734 (e.g., scroll to another tile) in a different direction. User interface 730 can include a back button 742 that allows user(s) 140 to navigate back to user interface 700 (e.g., by selecting or activating back button 742). In some cases, user interface 730 can depict an image 744 within silhouette 708B. User interface 730 can load silhouette 708B with image 744 or show image 744 being added to silhouette 708B. In some examples, user interface 730 can depict an animation showing image 744 added to silhouette 708B. The animation can show image 744 appearing in user interface 730 or entering user interface 730 from outside of user interface 730 (e.g., a visual effect that depicts image 744 entering the view of user interface 730 from an edge/border of user interface 730 such as the right border/edge of user interface 730) and progressively filling silhouette 708B or molding into a shape of silhouette 708B and filling the shape of silhouette 708B (or silhouette 708B molding into a shape of image 744 or both molding into a common shape).

The image 744 can include an image of a participant in the show, an image of the user(s) 140, or an image of any other person. For example, the image 744 can include an image of the user(s) 140. The user interface 730 can display an animation where the image 744 of the user(s) 140 is moved into the silhouette 708B to depict the user(s) 140 (e.g., the image 744) within the silhouette 708B. In some cases, the image 744 can include a user avatar, an image used to generate a user avatar, an image depicted by a user avatar, a real picture of the user(s) 140, an image of the user(s) 140 generated based on a real picture of the user(s) 140, an image of the user(s) 140 generated or modified by an AI/ML model, or any other image used to depict the user(s) 140 or a representation of the user(s) 140 within the silhouette 708B. In some cases, the contour of the silhouette 708B can be matched or adjusted to the contour of the image 744 (or vice versa) so the image 744 and silhouette 708B are aligned/overlapped to show the person (e.g., user(s) 140, a contestant, etc.) in the image 744 within the silhouette 708B. The silhouette 708B can alternatively be filled with an image of another person, such as a contestant in the show or another user. In some cases, the image of the other user can include an image of a user selected as a winner of a challenge associated with user interface 730 or 700, such as a scavenger hunt or trivia challenge, or a user promoted within user interface 730 (e.g., a user with a highest score in an activity, a user with a highest votes, a user with a most number of watched content items within a period of time, a user with a highest watch/play count of content items available through a content platform associated with user interfaces 700 and 730, a user with a certain number of credits associated with the content platform, a paid user, a random user of the content platform, a user selected from a pool of users who submitted requests to be added, a user who answered the highest number of questions related to the show correctly, a user being celebrated the day when user interface 730 is displayed such as a user who won a contest or got engaged within a specific time period, etc.).

FIG. 8A illustrates an example UI container 800 customized to include a combination of themes. In this example, UI container 800 includes a UI banner with tiles 808A-N (collectively “tiles 808” hereinafter), and the theme of UI container 800 includes a college football theme and a college football team theme. UI container 800 includes a themed space 802 adjacent to the tiles 808. The themed space 802 includes the college football and the college football team themes. The tiles 808 correspond to respective college football teams and depict content corresponding to the teams, such as team logos, names, mascots, colors, etc. The themed-space 802 can include content associated with college football and/or a particular college football team, such as a team favored by the user(s) 140, a team that is ranked in first place, a team that is scheduled to play, a team associated with a selected tile, any other team. The content of the themed space 802 and tiles 808 can convey a theme(s), such as the college football theme of UI container 802. The college football theme can be based on a college football topic, which can be selected based on one or more signals. In some examples, the college football topic (and thus the college football theme) can be selected based on a relevance of college football to the user(s) 140, a relevance of college football given a current context and/or a time period (e.g., date, week, season, etc.) when UI container 800 is displayed, a user preference, a trending metric associated with college football, a user watch history indicating a trend or uptick associated with college football, social media data (e.g., post counts, keyword/topic references, content likes, etc.), etc. For example, if UI container 800 is included in a user interface displayed during college football season, on a day in which a college football game(s) is/are scheduled, or a day when college football is trending, college football can be selected as the topic of the theme of UI container 800 given the relevance of college football when the user interface is displayed. The college football theme can highlight or promote college football and/or align the theme (and related content) of UI container 800 to an event, trend, context, culturally-relevant situation, preference, etc.

In some cases, the college football theme can be personalized for the user(s) 140. For example, the college football theme can additionally or alternatively be selected based on information indicating that the user(s) 140 is a college football fan, is interested in college football (e.g., from a user profile, a user input, a user preference, etc.), enjoys/prefers college football content (e.g., based on a watch history, social media data and/or connections, user preferences, etc.), has discussed college football on social media, follows college football content and/or a college football entity or person (e.g., a college football team, coach, player, etc.) on a platform(s) such as a social media platform, has a history of watching college football or doing something that shows interest in college football, etc. Such information can be obtained from a user preference(s), a user input(s), a user profile(s), user activity (e.g., a content viewing/watching history, a purchase history and/or transaction(s), content likes, content subscriptions, etc.), user statistics, inferred user preferences (e.g., inferred from a user demographic, user characteristics, a user location, a user context, etc.), etc. If the information instead indicates (or is used to infer) that the user(s) 140 does not like college football, UI container 800 may implement a different theme even if college football is otherwise a selected and/or relevant theme (e.g., even during college football season or a day when college football is trending).

The content in the themed space 802 can include college football content or content associated with college football (and, optionally, other content). For example, the themed space 802 can include text section 804 with text information about college football (and/or a college football team, game, schedule, coach, player, institution, statistic, history, etc.). The themed space 802 in FIG. 8A also includes an image 806 of a college football player. In other examples, the themed space 802 can additionally or alternatively include any other image related to college football, any other type of content and/or UI elements, etc.

UI container 800, including the themed space 802, can include a background. The background can relate to a theme(s) of UI container 800, such as the college football theme. Thus, the background can depict elements associated with the college football theme, such as college football team graphics (e.g., colors, logos, symbols, flags, etc.), college football artwork, college football imagery, etc. In some cases, the background can include one or more additional themes. For example, in FIG. 8A, the background also includes a college football team theme. To illustrate, UI container 800 and/or the background of UI container 800 depict content and/or features associated with the Georgia Bulldogs, which is the team associated with tile 808A. The content and/or features based on the Georgia Bulldogs theme can include, for example, the team colors (e.g., red and white), an image 806 depicting a Georgia Bulldogs player, artwork associated with the team, a team mascot, etc.

The Georgia Bulldogs theme can be selected based a Georgia Bulldogs topic associated with the user(s) 140. The Georgia Bulldogs topic can be selected based on one or more signals, such as a signal(s) indicating a relevance of the Georgia Bulldogs (e.g., the Georgia Bulldogs have a game on the day UI container 800 is displayed, the Georgia Bulldogs are trending, the Georgia Bulldogs have a certain ranking, the Georgia Bulldogs may be favored to win the college football championship, etc.), a user preference, etc. For example, the Georgia Bulldogs theme can be selected for the user(s) 140 to further tailor UI container 800 to the user(s) 140. The Georgia Bulldogs topic used to select the Georgia Bulldogs theme can be selected based on a user preference (e.g., the user(s) 140 is a fan of the Georgia Bulldogs), a viewing history of the user(s) 140, a request from user(s) 140 (e.g., an input requesting a Georgia Bulldogs theme or indicating a preference for a Georgia Bulldogs theme), a ranking of the Georgia Bulldogs, social media data associated with the user, etc. To illustrate, the tiles 808 correspond to college football teams and are ordered according to their rankings (e.g., to show the rankings of the teams). As shown, the tiles 808 are arranged in a sequence based on the respective rankings of the teams corresponding to the tiles 808. Since the Georgia Bulldogs are ranked highest, the tile 808A of the Georgia Bulldogs is sorted first (before the other tiles). The ranking of the Georgia Bulldogs can also be used to select a Georgia Bulldogs theme as the college football team theme of UI container 800. If the Georgia Bulldogs drop in the rankings, the tiles 808 in UI container 800 can be reordered to reflect the change in rankings and UI container 800 may be optionally updated to replace the Georgia Bulldogs theme with a theme of the team that overtakes the Georgia Bulldogs in the rankings. Alternatively, if the Georgia Bulldogs are trending/relevant even after dropping in the rankings or if user(s) 140 has an interest in the Georgia Bulldogs, UI container 800 may retain the Georgia Bulldogs theme despite the Georgia Bulldogs dropping in the rankings.

The tiles 808 can include features (e.g., artwork, UI elements, images, colors, color schemes, animations, objects, content, backgrounds, visual elements, etc.) related to their respective football teams, such as team logos or mascots, to correlate the tiles 808 with respective college football teams. In some cases, each of the tiles 808 can display the respective ranking of its corresponding team, and the tiles 808 can be arranged in an order based on rankings to depict or match the team rankings. In some examples, the user(s) 140 can select any of the tiles 808 to interact with such tile(s) and/or access associated content, experiences, activities, etc. For example, if the user(s) 140 wants to access information about Penn State Nittany Lions, which correspond to tile 808C and are ranked 4^{th}, the user(s) 140 can select the tile 808C to access such information. When the user(s) 140 selects the tile 808C, UI container 800 (or an associated user interface) can load content associated with the Penn State Nittany Lions, such as a team page, a tile(s) with Penn State content (e.g., a video of Penn State games or highlights, a movie or show about Penn State, an interview with its coach, an image of the football stadium, etc.), a game or activity involving Penn State, Penn State football statistics, etc.

UI container 800 and/or any of the tiles 808 can include metadata associated with any of the teams. For example, UI container 800 includes metadata section 810 depicted below the tile 808A associated with the Georgia Bulldogs. The metadata section 810 includes information and/or statistics about the Georgia Bulldogs. As previously noted, UI container 800 can be implemented in a user interface. The interface implementing UI container 800 can include a theme of UI container 800 and/or any other theme, such as a similar or relevant theme.

FIG. 8B illustrates an example user interface 820 that includes an example UI container 822 customized with themes. UI container 822 includes a UI banner and implements multiple themes. In FIG. 8B, the themes include a college football and a college football team theme. UI container 822 includes tiles 830A-N (collectively “tiles 830” hereinafter) and content space 824 used to display items in addition to the tiles. The content space 824 can implement one or more themes based on a topic(s). The one or more signals used to select the topic(s) can include, for example, a trending or popularity metric or statistic of the topic(s) (e.g., a metric determined based on one or more social media posts, content viewership statistics/metrics, purchasing habits and/or statistics of users, a frequency in which the topic(s) is mentioned or discussed in one or more mediums such as the media, user or group preferences, business preferences, paid sponsorship, an increased or threshold availability or promotion of the topic by a content provider, a temporal relationship between a time period when the UI container 822 is displayed and the topic(s) (e.g., a temporal relationship between a release date or schedule of content or products associated with the topic(s) and a time period when the UI container 822 is displayed, a trend or popularity of the topic(s) is higher on that time period than other time periods, statistics of the topic(s) on that time period, popularity of the topic(s) on that time period, user trends with respect to the topic(s) on that time period, etc.), a relationship between the topic(s) and a location associated with the user(s) 140 and/or a device used to display the UI container 822 (e.g., based on a particular significance/popularity or history of the topic(s) with respect to that location, a specific relationship between the topic(s) and location, etc.), a context associated with the user(s) 140 and/or the device used to display the UI container 822 (e.g., a relationship between the context and the topic, a relevance metric between the topic and the context, etc.), and/or any other signals.

The content space 824 includes text 826A. The text 826A can include information about college football, a college football team, a college football schedule, etc. The content space 824 can include artwork 826B associated with the theme(s) of UI container 822. In this example, the artwork 826B includes an image of a player of the college football team and a background color associated with the college football team. The content space 824 may additionally or alternatively display other content. For example, content space 824 includes UI element 828, which includes a CTA such as a button, link, or other element that the user(s) 140 can select or activate to access or interact with content associated with college football and/or the college football team associated with the team theme, purchase merchandise related to college football and/or the college football team, play a video or video game associated with college football or the college football team, etc. UI element 828 can include a link to content or a destination, or can be configured to trigger an action such as loading a video, game, activity, interaction, channel, application, etc.

The tiles 830 in UI container 822 can be configured in any arrangement. For example, in FIG. 8B, the tiles 830 are arranged in a row. Moreover, the tiles 830 can be ordered within the row according to a sorting scheme. For example, the tiles 830 can be ordered within the row according to the rankings of the college football teams (e.g., to show the rankings of such college football teams) corresponding to the tiles 830. In this example, the tiles 830 can be arranged in a sequence that is based on the rankings of the college football teams corresponding to the tiles 830. For example, the Florida Gators associated with tile 830A are ranked first, the Georgia Bulldogs associated with tile 830B are ranked second, the University of Southern California (USC) trojans associated with tile 830C are ranked third, and the Pennsylvania State University (PSU) Nittany Lions associated with tile 830N are ranked fourth. Thus, tile 830A is first in the row, tile 830B is second (e.g., next to tile 830A) in the row, tile 830C is third (e.g., next to the 830B) in the row, and tile 830N is fourth (e.g., next to tile 830C) in the row.

Thus, the order of tiles 830 can reflect the rankings of teams associated with the tiles 830. For example, the order of tile 830A visually indicates that its corresponding team is ranked first, the order of tile 830B visually indicates that its corresponding team is ranked second, the order of tile 830C visually indicates that its corresponding team is ranked third, and the order of tile 830N visually indicates that its corresponding team is ranked fourth. This way, the user(s) 140 can identify the rankings of the teams corresponding to the tiles 830 based on the order of the tiles 830. Even if the tiles 830 do not visually indicate the team rankings, the user(s) 140 may ascertain the rankings of the teams based on the order of the tiles 830 within the sequence of the row of tiles.

UI container 822 may include a metadata section for any of the tiles 830. The metadata section associated with a tile can display information associated with that tile and/or a content of the tile. UI container 822 can include a metadata section below, above, next/adjacent to, within, or in association with any tile (e.g., one tile, multiple tiles, all tiles, etc.). For example, UI container 822 may include a metadata section with information about the Florida Gators. The metadata section can be positioned near the tile 830A (e.g., below, above, adjacent to, etc.) associated with the Florida Gators. The metadata section associated with tile 830A and Florida Gators can be included because the Florida Gators are ranked first, the tile 830A is highlighted, the Florida Gators are playing on the day when (or within a time period when) user interface 820 is displayed, the user(s) 140 has a preference for or is a fan of the Florida Gators (e.g., as indicated by user data or preferences), the user(s) 140 requested such information for the Florida Gators or tile 830A (e.g., via a user input), or any other reason.

The metadata section in UI container 822 can dynamically change in response to one or more events or triggers. For example, UI container 822 includes a metadata section associated with tile 830A because tile 830A is highlighted by the user(s) 140. If user(s) 140 subsequently provides an input to highlight another tile, UI container 822 can be updated to include a metadata section associated with the other tile (or the metadata section can be updated to provide information about the team corresponding to the other tile). When UI container 822 is updated to include the metadata section associated with the other tile, UI container 822 may or may not remove the metadata section associated with the previous tile.

The user interface 820 can include any other sections. For example, in FIG. 8B, user interface 820 includes content section 840. Content section 840 can include content items and/or UI elements linked to (e.g., used to view or access) content such as videos, movies, shows, livestreams, broadcasts, podcasts, videos, promoted content, media applications, media channels, and/or any other content. In some cases, the content section 840 can include UI elements with content and/or used to access content, experiences, features, etc. For example, the content section 840 can include tiles 842A-N (collectively “tiles 842” hereinafter) associated with content. The tiles 842 can be arranged in any configuration, such as a row, column, grid, cloud, etc. In some examples, the tiles 842 can be linked to and provide access to associated content. For example, in FIG. 8B, the tiles 842 can include or provide a link to sports content. The sports content in this example includes baseball videos. The user(s) 140 can select or activate any of the tiles 842 to watch/play corresponding content, such as a corresponding baseball clip. The tiles 842 can depict frames (e.g., keyframes, still images, etc.) or thumbnails of a scene, view, poster, and/or content of the corresponding content, which allows the user(s) 140 to see what each of the tiles 842 pertains to and the content associated with (e.g., accessible/available through) the tiles 842. In some cases, the tiles 842 may depict other visual information or content (e.g., in addition to or instead of the frames or thumbnails) associated with the content of the tiles 842. For example, the tiles 842 can depict titles and/or descriptions of their corresponding content to identify the content (e.g., baseball clips) associated with the tiles 842 and/or what the content associated with the tiles 842 is about.

The content associated with the tiles 842 may be based on a relevance or relationship of the theme(s) of user interface 820 and content. For example, user interface 820 includes a college football theme. Since the college football theme is more broadly a sports theme, the content associated with tiles 842 relate to the college football theme in that both the college football theme and the sports content are sports themes or related to sports. The content associated with tiles 842 can additionally or alternatively include content that is part of or more specifically related to the college football theme and/or content associated with any other theme. In FIG. 8B, the tiles 842 in content section 840 and the content associated with the tiles 842 relate to baseball. However, the tiles 842 (or any portion thereof) in content section 840 and the content associated with the tiles 842 (or any portion thereof) may or may not relate to a theme of UI container 822. For example, the tiles 842 (or any portion thereof) in content section 840 and the content associated with the tiles 842 (or any portion thereof) can relate to college football and/or any of the college football teams associated with the tiles 830. However, the tiles 842 (or any portion thereof) in content section 840 and the content associated with the tiles 842 (or any portion thereof) can additionally or alternatively relate to any other theme. To illustrate, the tiles 842 and the content associated with the tiles 842 can relate to sports or a particular sport(s) (e.g., college football). This way, the tiles 842 and the content associated with the tiles 842 can implement or relate to a general and/or specific theme of UI container 822. As previously noted, the tiles 842 relate to sports content and are associated with sports content such as baseball content. Since UI container 822 relates to a sport (college football) and the tiles 842 relate to sports, user interface 820, including UI container 822 and content section 840, has an overall sports theme.

In some examples, the tiles 842 and content associated with the tiles 842 can relate to any other theme. For example, the tiles 842 can relate to movies (and/or any other type of content) associated with a different sport, such as soccer. In other cases, the tiles 842 can relate to movies (and/or any other type of content item) associated with any other topic, such as action movies, comedy, drama, animated movies, etc.

FIG. 8C illustrates another example user interface 850 customized based on themes and including UI containers. In this example, user interface 850 includes UI container 852 and UI container 870. UI container 852 and UI container 870 include a football theme. UI container 852 also includes a football team theme, which in this example is a San Francisco 49ers theme. The team theme can be based on information that the user(s) 140 has a threshold interest in the San Francisco 49ers, such as a user profile, user input, watch history, social media data (e.g., social media posts, likes, connections, subscriptions, etc.), etc. The team theme can be used to further personalize UI container 852 (and user interface 850) for the user(s) 140. UI container 852 in this example includes a UI banner. Moreover, UI container 852 includes a section 854 with team content based on the San Francisco 49ers theme. For example, the section 854 includes imagery 856A related to the San Francisco 49ers, text content 856B providing information about the San Francisco 49ers, and UI element 858. The UI element 858 can include a CTA. For example, in FIG. 8C, the UI element 858 includes a link to a team page of the San Francisco 49ers. The user(s) 140 can select or activate the link to access the team page.

UI container 852 also includes a section 860 with UI elements and content associated with the San Francisco 49ers. As shown, the section 860 includes a tile 862 promoting a game between the San Francisco 49ers and another team, and a tile 864 that provides a summary of the game and depicts details about the teams and the game. In some cases, the tile 862 can be selected or activated to watch a video associated with the game, such as a highlights reel or replay video. The section 860 can optionally include a counter 866 specifying the number of tiles in the section 860. The counter 866 can indicate whether the section 860 of UI container 852 includes any tiles that are not visible in the current view of user interface 850. The user(s) 140 can identify any number of remaining tiles based on the tiles 862-864 that are visible and the number of tiles indicated in counter 866. The remaining tiles may not be visible in UI container 852 because UI container 852 may not fit all the tiles or only fit the tiles if some or all of the tiles are resized to a size that is smaller than a minimum tile size. In such cases, UI container 852 may allow the user(s) 140 to scroll through tiles to view and/or access other tiles.

For example, the user(s) 140 can scroll UI container 852 (or its tiles) in any direction to view/access any tiles that are not visible within a current view of UI container 852 but would become visible upon scrolling in that direction. As the user(s) 140 scrolls (e.g., via a scrolling input) through tiles in UI container 852, user interface 850 can display a scrolling effect where tiles in UI container 852 appear to move or rotate based on a scrolling direction, and tiles that were not visible prior to the scrolling may be moved into focus (e.g., become visible). In other words, when the user(s) 140 scrolls in a direction, user interface 850 can update a view of UI container 852 or load a view of UI container 852 to show one or more tiles move from the scrolling direction and become visible within UI container 852. In some examples, the scrolling effect can include an animation that depicts any visible tiles moving away from the scrolling direction (e.g., moving towards an opposite direction) and depicts one or more tiles that were not visible (e.g., because the one or more tiles were outside of a visible portion of UI container 852) moving into focus. When the user(s) 140 scrolls UI container 852 to shift the tiles shown in the view of UI container 852 by a tile, user interface 850 can load or update a view of UI container 852 that shifts the row of tiles by a tile based on the scrolling direction. When shifting the row of tiles, user interface 850 can move an end tile (e.g., previously located at an end of UI container 852 opposite to the scrolling direction) out of view (unless that tile fits within the view as in cases where the scrolling has reached an end of the row or is near the end of the row) and move another tile (e.g., a tile that before the scrolling was located at an end of UI container 852 towards the scrolling direction) within view. Alternatively, when the user(s) 140 scrolls the tiles in UI container 852, user interface 850 can update or load a view of UI container 852 that replaces one or more tiles that were visible before the scrolling with one or more tiles that were not visible before the scrolling and were located adjacent to the visible area of UI container 852 in the scrolling direction. In some cases, UI container 852 can behave like a carousel when the user(s) 140 scrolls UI container 852 such that the tiles in UI container 852 move and rotate as user interface 850 displays a scrolling effect.

The section 860 includes a UI element 876 that the user(s) 140 can select or activate to watch the game (e.g., watch a replay of the game), and information 868 about UI element 876 and/or the content available via UI element 876. In this example, the game has already completed so the tile 864 and UI element 876 relate to a completed game and an associated replay of the game. If the game has not been played, UI element 876 can identify a source (e.g., channel) that will stream or televise the game, and the information 868 can provide information about the game and/or UI element 876, such as a date/time when the game is scheduled, a description of the source of the game associated with UI element 876, and/or any other information. In some cases, UI element 876 can include a link to the channel, stream, broadcast, or signal that will provide the game, which the user(s) 140 can select or activate to watch the game. The information 868 can specify when the game is scheduled so the user(s) 140 knows. In examples where the game has not completed, the tile 864 can include information about the game, information about another game, or a link or button to watch another game.

UI container 870 also includes a UI banner, which in this example is titled “My Team Highlights” and provides highlight content of a team of the user(s) 140, such as the San Francisco 49ers. The UI banner (UI container 870) includes tiles 872A-N (collectively “tiles 872” hereinafter) that the user(s) 140 can select or activate to access highlight videos of the team. The tiles 872 can depict details about the respective highlight videos associated with the tiles 872. The tiles 872 can include or depict keyframes from the highlight videos associated with the tiles 872, images/thumbnails associated with the videos, image posters associated with the videos, and/or any other information visually identifying the respective videos corresponding to the tiles 872. The theme and content of UI container 870 are illustrative examples provided for explanation purposes. In other examples, UI container 870 can include any other theme and/or content.

In some examples, user interface 850 can depict a user avatar 885 of the user(s) 140. The user avatar 885 may or may not be customized based on a theme(s) of user interface 850. For example, since user interface 850 includes a football theme, the user avatar 885 can be customized to add a football helmet or jersey to the user depicted in the user avatar 885. In some cases, the user avatar 885 can be based on the user profile associated with user interface 850, such as a user profile that is active. The user avatar 885 can identify the user profile applied by user interface 850 and any associated content.

In some examples, the topic(s) used to select the theme(s) associated with user interface 850 can be determined based on a threshold relevance of the topic(s), a context (e.g., time, date, season, location, country, environment, weather, region, culture, society, household, situation, event, trend, topic, etc.), a user (or user group), a community, a device (or group of devices), an event (e.g., news, trending, cultural, holiday, competition, awards, sports, current, social, release, and/or any other event), an environment, a situation (e.g., a release date, an event outcome, an announcement, etc.), and/or related in any other way.

In some cases, a theme of UI container 852 and/or UI container 870 can vary by location such that devices in different locations may display versions of user interface 850 with different themes. Users in a particular location or geographic region may have a higher interest in or a higher likelihood of being interested in a particular theme. Accordingly, location information can serve as a signal used to determine a theme(s) for user interface 850 (and/or UI container 852 and/or 870). For example, if user interface 850 is displayed by media device(s) 104 when media device(s) 104 is in San Francisco, the location of media device(s) 104 can suggest a preference for or relevance of the San Francisco 49ers given that San Francisco may have a higher amount, percentage, or concentration of San Francisco 49ers fans or that the San Francisco 49ers team is the home team associated with that location. Similarly, if media device(s) 104 is located within a region that has a threshold number or proportion of San Francisco 49ers fans or content consumers, the location of media device(s) 104 can be used to select a San Francisco 49ers theme for user interfaces and UI containers displayed by media device(s) 104 (while media device(s) 104 is in that region or in general) since the location of media device(s) 104 can indicate a likelihood that the user(s) 140 associated with media device(s) 104 is a fan of the San Francisco 49ers or interested in content associated with the San Francisco 49ers.

If the location of media device(s) 104 changes from San Francisco to a new location, such as Paris, the new location can be used to select a new theme, such as a Paris theme, that may be more relevant to the user(s) 140 associated with media device(s) 104 than the San Francisco 49ers theme (e.g., or any other San Francisco theme) as the new theme (e.g., Paris) is more temporally/contextually relevant to the new location of media device(s) 104 than the San Francisco 49ers theme. Thus, when media device(s) 104 is located in Paris, UI container 852 and/or UI container 870 may incorporate a theme related to Paris. For example, UI container 852 and/or the UI container 870 may include a background that shows the Eiffel Tower and/or colors associated with Paris (or France), and the tiles 862-864 or tiles 872 may include or correspond to content items associated with Paris, such as movies based in Paris, videos of the Paris Saint-Germain soccer team, videos about or including a famous Parisian or a Parisian landmark, etc.

User interface 850 may include more or less UI containers than shown in FIG. 8C. While the tiles in UI container 870 are depicted in a row arrangement, the tiles can be arranged within UI container 870 in any other pattern or arrangement. For example, the tiles can be arranged in a column, grid, cloud, circular, or any other shape or arrangement. Moreover, tiles in a UI container can have the same or different sizes, shapes, alignments, aspect ratios, resolutions, layouts, and/or any other configuration or attributes. To illustrate, the tiles in a UI container can have different sizes, layouts (e.g., landscape, portrait, etc.), resolutions, and/or shapes to convey different information about the tiles, highlight or promote certain tiles, fit the tiles within a user interface space, vary the visual configuration, etc.

In some cases, user interface 850 can include an animation(s). For example, in FIG. 8C, the tile 864 in UI container 852 depicts a football player 874. As part of an animation, the football player 874 can leave or exit the tile 864 (e.g., appear to jump and/or run out of the tile 864) and run to a destination. In this example, the destination is tile 872N. Thus, the football player 874 can run to the tile 872N to entertain the user(s) 140, draw the attention of the user(s) 140 to that tile, promote that tile, encourage the user(s) 140 to view or play a content of that tile, help the user(s) 140 discover that tile, etc. In some cases, the football player 874 can run to the tile 872N and stay by the tile 872N, perform an activity by the tile 872N such as jump on top of the tile 872N or catch a football above the tile 872N, hide behind the tile 872N, jump into the tile 872N and appear to enter the tile 872N, and/or display any other animation. For example, if the tile 872N includes a link to a football video about the football player 874, the football player 874 can jump out of the tile 864, run towards the tile 872N, and jump into the tile 872N such that the football player 874 is depicted in the tile 872N. This animation can draw the attention of the user(s) 140 to the tile 872N and visually suggest to the user(s) 140 that the tile 872N corresponds to a video about or including the football player 874, which the user(s) 140 can access via tile 872N.

In another example, a balloon 880 can appear in user interface 850 and float towards a tile slot of tile 872B. The balloon 880 can carry tile 885 as it floats towards the tile slot. When balloon 880 reaches the tile slot, it can drop the tile 885 so it falls into the tile slot. The tile 885 can be aligned with the tile slot and replace the tile 872B. The tile 885 can depict content and optionally include a link to content. For example, the tile 885 can include a link to a content item, such as a promoted video, an advertisement, an episode associated with tile 872B, a video game, etc. In some examples, if the user(s) 140 completes a video associated with the tile 872B, the balloon 880 can appear and drop the tile 885 to replace the tile 872B associated with the video that the user(s) 140 watched, with the tile 885 corresponding to a different video that the user(s) 140 can watch.

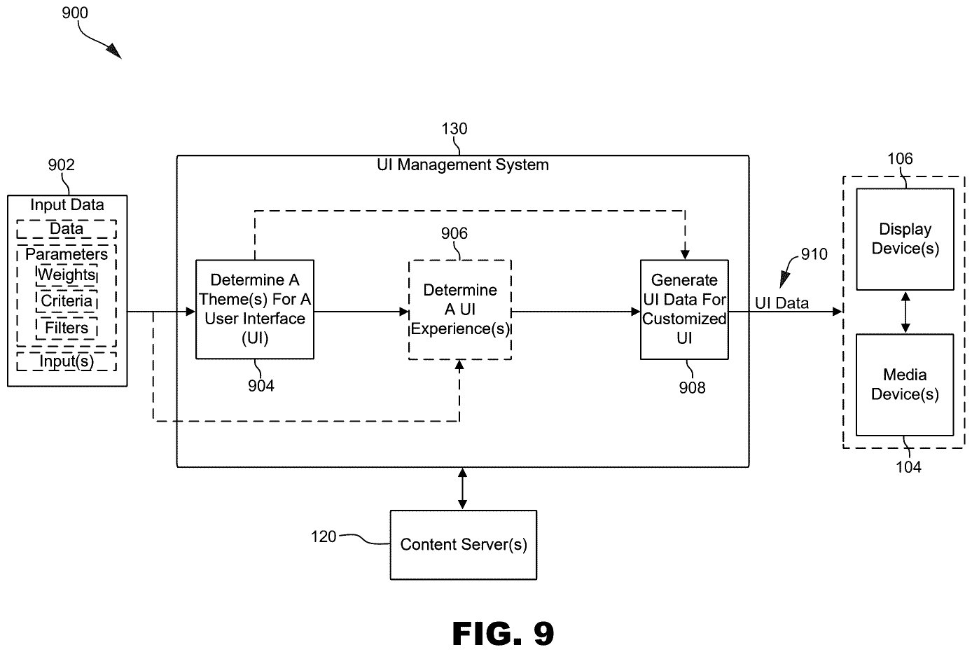

FIG. 9 is a diagram illustrating an example system process 900 for customizing user interfaces. In this example, UI management system 130 can determine configuration parameters of a user interface (e.g., one or more themes, structures, appearances, artwork items, behaviors, attributes, content items, UI elements, visual elements, UI containers, animations, configurations, menu items, styles, visual effects, input elements, controls, personalization parameters, promotions, features, etc.), configure the user interface, generate the user interface, trigger and/or instruct media device(s) 104 to display/render and/or generate the user interface, customize the user interface, generate data that media device(s) 104 can use to display/render and/or generate the user interface, etc.

The user interface can be customized. For example, one or more aspects of the user interface (e.g., a theme, design, behavior, artwork, look/appearance, structure, arrangement, organization, attribute, configuration, visual effect, and/or characteristic) can be customized based on a theme(s). The theme(s) can be selected based on a topic(s). The topic(s) can be selected based on one or more signals such as one or more relevance signals, context signals, trend metrics, event signals, temporal signals, user/group preferences, user profiles, preferences of an entity (e.g., sponsor, business and/or content platform, etc.) user statistics (e.g., watch history, input statistics, interactions, purchase statistics, etc.), interface usage statistics, content statistics (e.g., media consumption statistics, play counts, etc.), device signals (e.g., device capabilities, device statistics, device location, device configuration, device activity, etc.), language signals, cultural signals, location signals, calendar signals, social media signals, and/or any other signal.

UI management system 130 can be implemented by a device used to display the user interface, such as media device(s) 104 (e.g., see FIG. 2) or a remote server(s), such as system server(s) 126. As shown in system process 900, UI management system 130 can obtain and use input data 902 to determine how to configure the user interface. For example, UI management system 130 can use input data 902 to determine a theme(s) for the user interface, an animation(s) for the user interface, a content of the user interface, a content experience provided by the user interface, configuration parameters for the user interface, a background of the user interface, a customized organization, UI containers to include (and/or a configuration thereof) in the user interface, visual elements for the user interface, UI elements, a behavior of the user interface, etc.

UI management system 130 can obtain input data 902 from one or more sources such as content server(s) 120, media device(s) 104, display device(s) 106, one or more social media platforms/networks, one or more users (e.g., user(s) 140), an AI/ML model (e.g., an AI/ML prediction model, a large language model (LLM), an object detection model, a recognition model such as a facial recognition model and/or a scene recognition model, a generative AI model, etc.), a content platform (and/or a business associated with the content platform), the Internet, a news source(s), a database, a channel and/or program guide, client device(s) associated with the user(s), devices associated with users, a sponsor, a content provider, a sensor(s) (e.g., an image sensor, ambient light sensor, humidity sensor, temperature sensor, gyroscope, accelerometer, touch sensor, load/weight sensor, motion sensor, proximity sensor, magnetometer, inertial measurement unit, capacitive sensor, etc.), rules, templates, parameters, weights, filters, a blacklist, etc.

For example, UI management system 130 can obtain input data 902 from user(s) 140, data and/or activity at media device(s) 104, content server(s) 120, the Internet, an AI/ML model, a content database, a content release information source, an events store or source, a content platform associated with the user interface, an input(s) and/or decision(s) from a business associated with the content platform, a sensor device(s), etc. The input data 902 can include a signal(s) that UI management system 130 can use to select a topic(s), which UI management system 130 can use to select a theme(s) and/or determine how to configure/customize the user interface. For example, input data 902 can include a signal(s) indicating one or more events, content items, conditions, subjects, activities, and/or other topics that have threshold temporal, relevance, priority, preference, trend, popularity, contextual, and/or user scores, priorities, weights, relationships, rankings, metrics, etc. In some examples, input data 902 can include content statistics, parameters (e.g., weights, filters, values, etc.), UI criteria, a blacklist, one or more filters, a user input(s), a preference/weight or decision from a business or content platform associated with the user interface, event information, content information, user information, device information, context information, sponsor preferences, user or device activity, social media data (e.g., social media posts, statistics, trends, connections, subscriptions, patterns, content, activity, etc.), campaign information, current event information, news information, etc.

The topic(s) can be used to select a theme(s) for the user interface. The theme(s) can be used to configure any aspects of the user interface, such as one or more structures, designs, UI elements (e.g., input elements, navigation elements, display elements, buttons, toggles, menu items, controls, toolbars, etc.), visual elements, UI containers (e.g., UI banners, boxes, rows, columns, tiles, cards, sheets, etc.), images/imagery, attributes, behaviors, characteristics, organization, appearance, artwork, and/or other features. For example, the signal(s) in input data 902 can include information used to identify a topic(s) for a theme(s), such as a theme(s) that is relevant to the user(s) 140 (and/or a household), a group of users, a device(s) associated with the user(s) 140 (e.g., media device(s) 104 and/or display device(s) 106), a context associated with the user(s) 104 and/or an associated device(s), a date(s), a location(s), a user preference(s) and/or interest(s), a trend, a topic(s), an event(s), etc.

In some examples, the one or more signals can include, describe, and/or identify a location of the user(s) 140 and/or a device(s) associated with the user(s) 140 (e.g., media device(s) 104, display device(s) 106, etc.), a context associated with the user(s) 140 and/or media device(s) 104, user preferences and/or a user profile (e.g., a user preference and/or profile of user(s) 140), a user input(s), social media data (e.g., posts and/or metrics indicating a trending topic and/or event in social media, etc.), calendar/temporal data (e.g., a date, time, season, holiday, etc.), a schedule or scheduling data (e.g., a content release date, an event date or scheduled event date, a holiday calendar or date, a competition schedule or date, a programming schedule, a date of an announcement (an event announcement, product release announcement, an announcement of a winner of an award/competition, etc.), etc.), weather data, topic information (e.g., social media posts about a topic, references in social media to a topic, a topic trending or associated with a particular date(s), trending or popularity metrics of a topic, a description of a topic, a context of a topic, a rating/ranking of a topic, a relevance of a topic to user(s) 140, etc.), a content/theme blacklist, a content/theme filter, content/theme selection rules and/or weights, a preference and/or decision/input from a business or content platform associated with the user interface, a candidate theme(s) for the user interface, cultural information, language information, UI templates, UI configuration parameters, and/or any other information. In some cases, the one or more signals can identify, describe, and/or include data indicating a relationship between a topic(s) and any cues, conditions, factors, features, etc.

For example, the one or more signals can include, describe, and/or identify a temporal relevance of a topic (e.g., a date(s) of an event associated with the topic, a date(s) when the topic is trending or has a threshold trend/popularity metric, an anniversary of a topic or associated event, an announcement of a topic or associated event, a celebration of a topic or associated event, etc.), a contextual relevance of a content item (e.g., a score measuring a relevance/relationship between the content item and a context, a score indicating a match and/or similarity between the context (or aspects thereof) and the content item, a match or similarity between a current date/period and a release date or presentation date(s) of the content item, a relevance score or match/similarity between a location associated with the content item and a location associated with user(s) 140 and/or a user device(s), etc.), a cultural relevance between a topic and a content item (e.g., a topic included in or associated with a content item has (in general or on one or more dates) a particular meaning or significance for, relationship with, metric in, and/or history in a culture associated with user(s) 140 and/or an associated location), a relevance between a location and a topic (e.g., a topic including an event that occurred or is scheduled to occur at the location, a topic associated with the location, a topic about or originating from the location, a topic trending in the location, a significance or relationship between the location and a topic, etc.), a relevance (e.g., temporal, contextual, location, etc.) of a theme to a context associated with user(s) 140 and/or a device(s), a relevance (e.g., temporal, contextual, location, etc.) of a theme or context to a content item (e.g., a movie, show, televised event such as a game or competition, a movie or show released or scheduled to be released or presented on a date(s), etc.), a relationship between a situation (e.g., an announcement, release or scheduled date, expected or scheduled outcome or event, etc.) and a cue (e.g., context, date, location, scene, topic, etc.) or content item, etc.

In some cases, input data 902 can include information about content at content server(s) 120 and/or scheduled to be available or released. For example, input data 902 can identify content items at content server(s) 120 (and/or scheduled to be available at content server(s) 120), a programming guide or schedule including any dates when any content items are or will be released or televised, a channel guide (e.g., a channel list, an indication of content items available from channels in the channels list, a schedule of content from channels in the channel list, etc.), content statistics (e.g., content views and/or viewing/consumption statistics, content ratings, streaming statistics determined for any content, trending or popularity metrics/statics calculated for any content, information about user interactions with any content, playback statistics of any content, etc.), social media data, content metadata (e.g., genres, actors, topics, viewership metrics, descriptions/summaries, subtitles or closed captions, depicted scenes, depicted contexts, depicted activities, depicted events, language information, location or region/country information, titles, information about characters in content, release dates, programming dates/schedules, content sources, content producers, content themes, content tags, etc.), and/or any other information.

At step 904, UI management system 130 can determine, based on input data 902, a theme(s) for a customized user interface (UI). The UI can be customized for the user(s) 140, a group of users including user(s) 140, all users of a content platform associated with the UI, or any other user or number of users. UI management system 130 can analyze input data 902 and select a topic(s) of the theme(s) based on input data 902, and determine the theme(s) based on the topic(s). For example, UI management system 130 can analyze context information, event information, activity information, temporal information, user information, content information, social media data, trends, popularity or ratings information, and/or any other information in input data 902 to select a topic(s) for the theme(s).

UI management system 130 can use the topic(s) to select the theme(s). For example, if the topic includes a comedy sitcom, UI management system 130 can select a comedy sitcom theme. The comedy sitcom theme can include any content, experience, UI appearance, UI design, UI element(s), UI container(s), visual element(s), UI organization(s), organization (e.g., organization of UI elements, UI containers, content, etc.), UI and/or background color(s) or color scheme(s), UI attribute(s), UI animation(s), UI behavior(s), UI style(s), UI structure(s), UI object(s), artwork(s), imagery, and/or any other feature(s) about, related to, including, depicting, associated with, and/or customized based on the comedy sitcom theme. In some cases, the topic(s) can be relevant in/to (or have a threshold relevance) a date, context, location, environment, scenario, user, and/or device associated with the UI; a topic associated with a context, condition, event, activity, content, subject, trend, and/or category that has a threshold trend metric, relevance metric, temporal metric, popularity metric, user/group preference metric, user or group matching score, business or platform preference metric, priority metric, rank, statistic, etc.

For example, if input data 902 indicates that a finale of a tour of a celebrity is on a particular date, UI management system 130 can determine that the celebrity, content associated with the celebrity (e.g., music, movie, etc.), the tour of the celebrity, a genre of content of the celebrity, a topic or theme of the tour or a content of the celebrity, or any attribute associated with the celebrity and/or the tour has/have a threshold relevance on that date, a threshold trend score on that date, a threshold match for a topic/theme associated with that date, etc. UI management system 130 can select the celebrity, content associated with the celebrity (e.g., music, movie, etc.), the tour of the celebrity, a genre of content of the celebrity, a topic or theme of the tour or a content of the celebrity, and/or attribute associated with the celebrity and/or tour as a topic(s) for the theme(s) of the UI displayed on that date (or within a number of days or time increments from that date), and use the topic(s) to select the theme(s) for the UI.

In some cases, input data 902 can include metrics used to determine a level of user interest or relevance, such as attendance and/or viewership statistics of shows in the celebrity tour, metrics associated with content from the celebrity (e.g., views, purchases, subscriptions, chart rankings, etc.), and/or other data associated with the celebrity and/or tour. UI management system 130 can use such information to determine that the celebrity, content of the celebrity, and/or tour of the celebrity has/have a threshold popularity, interest, consumption, priority, rank, relevance, match, and/or selection score. UI management system 130 can take such information into account when determining the topic used to select the theme(s). In other words, in addition to selecting the celebrity, the celebrity's content, and/or the celebrity's tour as a topic(s) for the theme(s) based on a relationship (e.g., a match) between the current date and the date of the final show in the tour (e.g., a temporal relevance), UI management system 130 can analyze other metrics, statistics, weights, filters, cues, scores, and/or information to determine a level of interest or popularity as another factor used to select the celebrity and/or tour topic for the topic used to select the theme(s). In such cases, the selected topic for the theme(s) may have a higher relevance score as it would not only have a temporal relevance but also a broader or higher user interest or relevance. For example, if UI management system 130 determines that the current date matches the final date of the tour as well as the date of a game, UI management system 130 can determine, based on such temporal cues, that both the tour and the game are relevant to the current date. UI management system 130 may select both topics as the topic(s) of the theme(s) or may pick one of the topics for the theme(s). To select between the topics, UI management system 130 may analyze other data, such as metrics, preferences, weights, filters, rules, etc.

For example, UI management system 130 can use metrics in input data 902 to compare a popularity of the game and the tour. If the metrics indicate that the game has a lower popularity than the tour, UI management system 130 may select the tour as the topic for the theme(s) rather than the game. UI management system 130 may calculate a higher relevance or score for the tour than the game despite both being temporally relevant, as the relevance scores can also account for a popularity. UI management system 130 can use the tour as a topic of the theme(s). Thus, the theme(s) may not only have a temporal relevance but also a popularity or additional relevance, increasing the overall relevance of the tour.

By considering additional information, UI management system 130 can avoid selecting a theme that has a threshold temporal relevance but a lower popularity or overall relevance. For example, if the teams in the game have a smaller fanbase than the celebrity and a lower viewership or user support than the tour, the game may have a lower relevance than the tour to many users even though the game is also temporally relevant. Thus, UI management system 130 may optionally forego selecting the game as a topic for the theme(s), or may select the game as a topic but select the tour as a higher priority, more prominent or highlighted, and/or higher-weighted topic for the theme(s). UI management system 130 can select the tour as the topic instead of or in addition to the game, since it has a higher overall score.

In some cases, UI management system 130 can use weights, rules, preferences, and/or blacklists to select between topics, such as topics that satisfy a selection criteria or threshold metric (e.g., the tour and game). In some examples, a content platform or business associated with the UI can provide inputs used as weights, preferences, filters, and/or blacklists for selecting or excluding a topic. In some examples, UI management system 130 can receive a request or instruction (e.g., from media device(s) 104) for a customized UI (or UI data used to generate, render, and/or display the customized UI). UI management system 130 can use input data 902 to determine a topic(s) (e.g., an event, cue, scene, activity, condition, context, location or landmark, scenario, content, subject, content item, activity, tournament, competition, object, celebration, etc.) for a theme(s) of the UI, and identify the theme(s) based on the topic(s).

For example, if the UI is displayed on a holiday or a day of celebrated event, UI management system 130 may select the holiday or the celebrated event as a topic for the theme(s). To illustrate, if the UI is displayed on Saint Patrick's Day, UI management system 130 can determine that Saint Patrick's Day is a relevant topic on that day and select a Saint Patrick's Day topic for the theme(s). This way, the UI generated based on the theme(s) can be relevant and have an appearance (e.g., artwork, look, design, content, etc.) that the user(s) 140 associates with Saint Patrick's Day. For example, the UI can include green-colored elements, a green background, content (e.g., movies, videos, shows, etc.) related to Saint Patrick's Day, a design (e.g., artwork/imagery, logos, visual elements, etc.) related to Saint Patrick's Day such as a green background and Sain Patrick's Day artwork (e.g., leprechauns, shamrocks, etc.), and thus appear customized for Saint Patrick's Day. As another example, if input data 902 indicates that the World Cup final is on the day when the UI is displayed, UI management system 130 can determine that soccer, the World Cup, the World Cup final, and/or the soccer teams in the final are relevant, candidate, and/or high-scoring/ranking topics for a theme of a UI displayed on that day. UI management system 130 can select soccer, the World Cup, the World Cup final, and/or the soccer teams in the final as the topic(s) for the theme(s), and select an associated theme(s) for the UI.

The theme(s) can be used to customize the UI to provide a UI appearance and/or experience that relates to, celebrates, and/or promotes the World Cup, the World Cup final, soccer, and/or the soccer teams in the final. The UI can include features associated with the theme(s), such as colors and/or symbols/logos of the teams playing in the final, soccer and/or World Cup artwork (e.g., an image of the World Cup trophy, an image of the stadium where the final is being played, interface objects shaped like or resembling soccer balls, flags of the countries playing in the final, etc.), content related to soccer and/or the World Cup (e.g., World Cup replays, World Cup highlight videos/clips, a soccer documentary, etc.), content related to the teams in the final and/or associated countries (e.g., previous games of the teams, video highlights of the teams or specific players, documentaries of any of the teams/players or countries, movies based on any of the teams/countries playing in the final, etc.), a UI container(s) (e.g., UI container 702, UI container 734, UI container 760, UI container 802, UI container 822, UI container 852, UI container 870, etc.) incorporating relevant features (e.g., content, UI components, animations, background, visual attributes, artwork, graphics, visual effects, content experiences, etc., related to soccer, the World Cup, the World Cup final, the teams playing in the final and/or associated countries, any player in the final, a host country/city of the World Cup, the World Cup trophy, etc.), and/or any other relevant details.

In some cases, the theme(s) can be selected by or based on a sponsor. For example, a sponsor can pay for a theme of any (or certain) UIs of a content platform presented on a particular day or period of time (e.g., week, month, etc.). As another example, a sponsor can provide a preference for a theme that can be used as a theme-selection metric such as a weight or factor.

In some cases, the theme(s) can be customized for the user(s) 140. For example, if input data 902 indicates that the user(s) 140 is a fan of one of the teams in the World Cup final or follows one of the teams, the theme(s) can be tailored based on that team. The UI customized for the user(s) 140 based on the theme(s) can include, highlight, and/or promote UI features (e.g., content, UI elements, UI containers, UI design features, UI attributes, visual elements, artwork, graphics, UI appearance, UI style, UI background, UI animations, UI experiences, etc.) related to that team.

As another example, if input data 902 indicates that a popular movie is being released on the day when the UI is displayed, UI management system 130 can select that movie as a topic of the theme for the UI. The theme can be customized based on that topic (the movie). In some examples, the theme can include any characters, scenes, and/or content in the movie, a logo or background of the movie, a motif or mood of the movie (e.g., if the movie is a horror movie the theme can be a dark or horror theme, if the movie is a romance movie the theme can include features that invoke or convey a romantic mood, etc.), images from the movie, fonts and/or shapes from the movie, references to the movie, an activity in the movie, items related to the movie, etc. In some cases, the theme can promote the movie or an associated movie franchise, movies in the movie franchise (if any), related movies (e.g., movies with a same actor, movies based in a same country or region, movies associated with a same topic, etc.), relevant content or merchandise (e.g., merchandise from the movie, movie collections associated with the movie, etc.), etc.

The theme(s) can include or be used to determine features of the UI, such as UI content, UI elements, UI containers, a UI organization, an arrangement of UI elements, an organization of UI containers, a UI background, visual characteristics and/or elements (e.g., colors, patterns, visual effects, shapes, imagery, etc.), any scenes depicted in the UI, brands or products to depict or promote in the UI, UI artwork (e.g., images, logos, symbols, thumbnails, keyframes, shapes, graphics, etc.), a mood of the UI, a UI design, a UI style, information to include in the UI, a structure of the UI, promoted or highlighted content, design elements, a layout and/or configuration of the UI and/or any UI components (e.g., a UI container, UI element, UI content item, UI background, UI template, etc.), parameters for any UI elements (e.g., UI element types such as tiles/cards or thumbnails, arrangement of UI elements such as a tile or card row or column, a shape of UI elements such as a size or aspect ratio of tiles and/or UI containers, etc.), an appearance of the UI, an activity or game available from the UI (e.g., a type of activity or game, a topic of an activity or game, etc.), any animations displayed by the UI, a content experience provided by the UI, a behavior of the UI, and/or any other attributes.

In some examples, the theme(s) can include a UI container(s), such as UI container 702 in FIG. 7A, UI container 734 in FIG. 7B, UI container 800 in FIG. 8A, UI container 822 in FIG. 8B, UI container 852 in FIG. 8C, etc. The UI container(s) may or may not be customized based on the theme(s). For example, the UI container(s) can include a background, content, animation, visual elements, and/or any other features associated with the theme(s). In some cases, the theme(s) can specify what content, animations, visual elements, UI containers, UI elements, organization, style, design, appearance, attributes, experiences, and/or any other features are included in the UI.

Once UI management system 130 determines the theme(s) for the UI, UI management system 130 can generate the UI or UI data used to generate and/or configure the UI, as described below with respect to step 908. In some cases, UI management system 130 can determine a UI experience(s) provided by the UI, as described below with respect to step 906. For example, rather than proceeding from step 904 to step 908, UI management system 130 can perform step 906 in addition to step 904 before proceeding to step 908.

At step 906, UI management system 130 can optionally determine a UI experience(s) for the UI based on input data 902 and/or the theme(s) determined at step 904. The UI experience(s) can include, for example, any animations displayed by the UI, CTAs included in the UI, user and/or content interactions (and/or types of interactions) supported and/or enabled by the UI, activities displayed and/or supported by the UI, behaviors and/or actions configured on or performed by the UI, outputs of the UI, games displayed/provided and/or configured on the UI, challenges provided by the UI, content item references (e.g., hidden messages or clues pertaining to specific content items such as movies or TV shows), and/or any other interactions between the user(s) 140 and the UI (and/or content/features thereof). For example, if UI management system 130 selects to promote a particular feature of the UI, UI management system 130 can determine whether to promote the feature using an animation by configuring the UI (or aspects thereof) or the feature to have a certain appearance used to promote or highlight the feature (e.g., adjusting a size, placement, and/or visual attribute of the feature), by configuring the UI to provide a game or activity that may draw the user's attention to the feature, by determining any other way to promote the feature, etc. To illustrate, UI management system 130 can select to configure the UI to display content references representing hidden messages/clues for a game or activity and invite the user(s) 140 to take part in the game/activity. UI management system 130 can display a content reference(s) on or around (e.g., adjacent to, within a proximity of, etc.) the feature or hide the content reference(s) within/behind the feature to try to draw the attention of the user(s) 140 to the feature via the content reference(s) as part of the game/activity.

If UI management system 130 determines to use include animation, UI management system 130 can determine what animation and/or type of animation to include and/or how to configure such animation. For example, UI management system 130 can determine to configure a feature to be animated to draw the user's attention to the feature. As another example, to draw the user's attention to the feature and promote it, UI management system 130 can determine to configure an object to interact with the feature or move the feature to a UI location where the feature is displayed, or animate other content in a way that draws the user's attention to the feature.

As another example, to promote a feature, UI management system 130 can select to configure the UI to invite, encourage, draw, or enable the user(s) 140 to explore the feature in the UI in exchange of a benefit to the user(s) 140 that incentivizes the user(s) 140 to use or explore the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of user(s) 140 displayed on UIs presented to other users, being recognized in the UIs presented to other users, etc.), unlocking a feature/functionality, etc.

To illustrate, if the feature includes an advertisement, UI management system 130 can select to configure the UI to invite the user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that the user(s) 140 would need to access to get to the control setting. For example, assume that, to reach the control element associated with the control setting, the user(s) 140 would need to navigate to a menu, within the menu navigate to a first submenu, within the first submenu navigate to a second submenu, and the control element can be found within the second submenu.

In this example, UI management system 130 can select to configure the UI to display an animation that draws the attention of the user(s) 140 to the menu to encourage the user(s) 140 to navigate to the menu (e.g., an animation that interacts with the menu, an animation that places or drops a visual element on or about the menu, an animation that animates the menu, etc.). Once the user(s) 140 navigates to the menu, the UI can display another animation that steers the user(s) 140 towards the first submenu. Once the user(s) 140 navigates to the first submenu, the UI can display another animation that steers the user(s) 140 to the second submenu. Once the user(s) 140 navigates to the second submenu, the UI can display an animation that draws the attention of the user(s) 140 to the control element. This way, the animations can provide a journey or navigation experience that leads to the control element to push the user(s) 140 to explore or learn the control element. In this way, the animations can follow a journey or storyline and provide clues, signals, or “breadcrumbs” along a navigation path or journey that lead the user(s) 140 to the feature promoted.

In some cases, the UI experience(s) can include an immersive experience involving content, UI functionalities, activities, or games. For example, the UI experience(s) can include a puzzle on the UI and clues that user(s) 140 can find by answering questions in the game and can help the user(s) 140 solve the puzzle. The clues can be placed in the UI so as the user(s) 140 navigates the UI and performs an action, (e.g., selects a content item, watches a content item such as a movie or an advertisement, uses a part of the UI or a feature for a first time, etc.) the UI unlocks a corresponding clue that may appear in a game. In some examples, clues can be dispersed throughout UI pages, sections, contents, features, screens, UI containers, and/or any other locations. The UI experience(s) can include a game or journey where the user(s) 140 can uncover clues at specific destinations until the user(s) 140 finds the last clue (and/or all clues).

If the theme(s) of the UI and/or the UI includes content related to a contest, the UI experience(s) can include an option to vote on questions to ask in the contest. If the theme(s) is/are associated with food, the UI experience(s) can include a question asking the user(s) 140 to identify the user's favorite celebrity chef, and the answer from the user(s) 140 can be used to update the theme(s) and/or a content of the UI. For example, the UI can be updated based on the answer to include content associated with the favorite celebrity chef or add a section or UI container with content or tiles associated with the favorite celebrity chef. The answer can optionally trigger a user avatar to be updated to include an attribute associated with the favorite celebrity chef. For example, if the favorite celebrity chef is known for wearing specific glasses and a chef hat, the avatar can be updated to show the user(s) 140 with the glasses and chef hat.

The UI experience(s) can optionally support user interactions. For example, the UI experience(s) can include an option for the user(s) 140 to select a favorite team in a sport. The UI can obtain an answer identifying a team and display a comparison of the team pick of the user(s) 140 with the teams picked by other users to show the user(s) 140 how the user's team preference compares to the team preferences of other users. In some cases, the UI experience(s) can allow the user(s) 140 pick or suggest UI themes, UI theme changes, content references, hidden messages/clues or surprises (also referred to as “Easter eggs” herein), and/or other content and/or features to display in the UI. The Easter eggs can be placed or hidden anywhere in the UI. For example, an Easter egg can be hidden in a control element for a setting, such as a closed caption or video setting, to encourage users to explore or discover the setting. If the user(s) 140 finds the Easter egg, the UI can display a celebration (e.g., a celebration that the user(s) 140 found the Easter egg or landed on a special UI destination) such as an image of the user(s) 140 or a name of the user(s) 140 depicted in a background or screensaver associated with a UI theme.

In some cases, the UI experience(s) can provide a Easter egg hunt challenge/game where Easter eggs are placed throughout the UI or a background. Users can try to find the Easter eggs to win the challenge/game. The challenge/game can help users become familiar with the UI, discover features of the UI, learn aspects of the UI, explore locations of the UI, learn how to access certain features of the UI, become more proficient with the UI, among other benefits. Users can win awards or other benefits. In some cases, a behavior of an Easter egg can change dynamically based on one or more conditions. For example, assume that a weather balloon from a movie is depicted in the UI and used as an Easter egg hidden within a background of the UI. As the number of users who find the weather balloon (the Easter egg) increases, the weather balloon can grow. The weather balloon can eventually burst or disappear to provide a timeliness constraint so users are encouraged to find the weather balloon faster.

In some examples, the UI experience(s) can be configured to assist the user(s) 140 to setup a new device or profile. For example, the UI can display animations or highlight UI areas during a device or profile setup or activation/registration. The animations or highlighted UI areas can help the user learn the UI, discover UI features, etc. The UI can include Easter eggs or animations that steer users to certain features and/or spaces, engage in certain activities, etc. To illustrate, to help the user(s) 140 calibrate microphone(s) 112 on remote control(s) 110 or a voice recognition feature based on audio recorded by microphone(s) 112, the UI can display interactive content that prompts or encourages the user(s) 140 to submit verbal commands or utterances through microphone(s) 112. This way, the UI can try to drive the user(s) 140 to provide voice commands or utterances used to calibrate microphone(s) 112 or the voice recognition feature and make the calibration process easier/seamless for the user(s) 140.

In some cases, the UI experience(s) optionally determined at step 906 can relate to or be based on the theme(s) selected for the UI. For example, if the theme(s) includes a football theme, the UI experience(s) can include football content, a football activity, a football game, a football interaction, and/or a visual appearance associated with football. Thus, UI management system 130 can take into account the theme(s) of the UI when determining the UI experience(s) (if any).

UI management system 130 can use any portion of input data 902 to help determine the UI experience(s). For example, UI management system 130 can use input data 902 to determine that a movie is being released on a particular day and select the movie as a theme for the UI. UI management system 130 can use this information to determine a UI experience(s) to promote the movie on the day of release. This way, the UI experience(s) relates to the theme(s) of the UI and the movie release. As another example, if input data 902 indicates that a sponsor has paid to have a channel of the sponsor promoted, UI management system 130 can select a UI experience(s) configured to promote the channel of the sponsor through the UI.

If input data 902 includes a blacklist of topics that should not be used for a theme, UI management system 130 can use the blacklist to avoid UI experiences related to such topics. If input data 902 includes preferences (e.g., user preferences, business preferences, etc.) or topic weights, UI management system 130 can use the preferences or topic weights to select a UI experience from multiple candidate UI experiences or rank the candidate UI experiences.

At step 908, UI management system 130 can generate UI data 910 based on the theme(s) and optionally based on the UI experience(s) selected (if any). UI data 910 can include the UI and/or data used to generate, render, and/or display the UI. The UI can be customized with the theme(s) and can include the UI experience(s) (if any). In some cases, UI data 910 can include parameters used to configure and customize the UI based on the theme(s) (and optionally the UI experience(s), if any). The parameters can specify any content, UI elements (e.g., tiles, cards, input elements, navigation elements, output elements, controls, etc.), UI containers, UI behaviors, an organization and/or arrangement of UI items (e.g., UI containers, UI elements, content, visual attributes or elements (e.g., images, animations, visual elements, colors, color schemes, artwork, thumbnails, a background(s), a screensaver(s), graphics, visual effects, logos, symbols, etc.), UI components, etc.), style parameters (e.g., UI style parameters, UI fonts, UI element/container shapes and/or sizes, UI element/container border settings, UI element types, etc.), UI design parameters, a UI structure, UI experience settings, UI activities, content groupings or categories, content (e.g., movies, TV shows, video games, etc.), personalization parameters, content types, UI design elements, etc. The UI parameters can implement, convey, include, depict, and/or relate to the theme(s) and/or can be customized for or based on the theme(s). In some cases, the UI parameters can be used to configure the UI experience(s) determined at step 906.

In some cases, UI data 910 can include a UI customized based on the theme(s). The customized UI can optionally include a UI experience (e.g., determined at step 906). UI management system 130 can send UI data 910 to media device(s) 104, which can use it to generate, build, render, and/or display the customized UI. In some cases, UI data 910 can include data used to generate and/or render the UI, such as instructions, parameters, objects, code, UI components, a UI template, etc. UI data 910 can be used to customize the UI to include the theme(s) and UI experience(s) (if any).

In some examples, UI management system 130 can provide UI data 910 to display device(s) 106, which can use it to display/render the UI. In other examples, UI management system 130 can provide UI data 910 to media device(s) 104, and media device(s) 104 can use UI data 910 to display the UI or trigger display device(s) 106 to display the UI. In server-side rendering scenarios, UI data 910 can include the UI generated by UI management system 130. UI management system 130 can provide the UI (e.g., UI data 910 in this example) to media device(s) 104 or display device(s) 106 for display. In a client-side rendering scenario, UI data 910 may include the data used to generate/build and render the UI at the edge (e.g., locally). In this scenario, rather than UI management system 130 building the UI and providing the UI, UI management system 130 can provide data used by media device(s) 104 or display device(s) 106 to generate/build and render the UI.

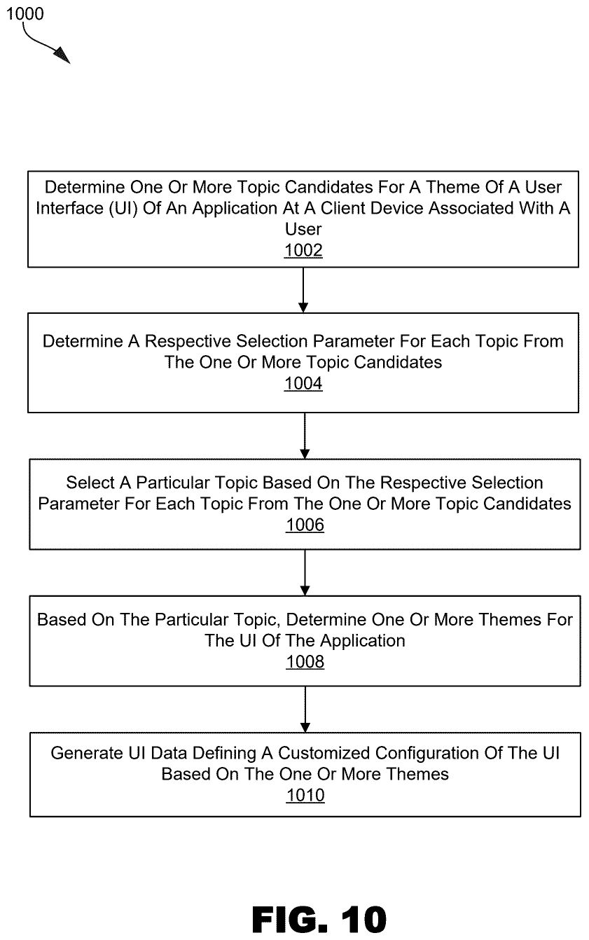

FIG. 10 is a flowchart illustrating an example method 1000 for customizing a UI based on one or more themes. The method 1000 can be performed by processing logic that can include hardware (e.g., circuitry, dedicated logic, programmable logic, microcode, etc.) and/or software (e.g., instructions executing on a processing device). It is to be appreciated that not all steps may be needed to perform method 1000. Further, some of the steps may be performed simultaneously, or in a different order than shown in FIG. 10, as will be understood by a person of ordinary skill in the art. Method 1000 shall be described with reference to FIGS. 1 and 2. However, method 1000 is not limited to those examples.

At step 1002, UI management system 130 or media device(s) 104 can determine one or more topic candidates for a theme of a UI of an application at media device(s) 104. The one or more topic candidates can include, relate to, and/or be determined based on one or more signals or cues, such as an event (e.g., a game, competition, debate, birthday, holiday, tournament, informal holiday or commemorative day, content or product release, current event, social event, cultural event, etc.), a team (e.g., a sports team, science team, etc.), a brand, a product, a content item, a content franchise, a person, a sport, a subject, a context, a geographic location or region, a character, an object, an activity, a landmark, a scene, a metric, social media data, calendar data, user/entity preferences, and/or any other signal/information.

In some cases, the one or more signals can include a contextual signal (e.g., a signal indicating a context associated with user(s) 140, media device(s) 104, the application, a content associated with the application, a content platform associated with the application, a user and/or device location, a regional context, a cultural context, a social context, a language, an entertainment context, a media content context, etc.), calendar data, social media data (e.g., posts, trends, connections, subscriptions, news, etc.), a temporal signal (e.g., a release date of a content item or product, a scheduled date of an event or content item, a current date, a date of a holiday or celebration, a date of an activity, a date of cultural/religious or national interest event, a current event date, a birthdate, an announcement date, etc.), a location signal (e.g., a location of user(s) 140 and/or media device(s) 104, a location of an event, a location of an activity, a location of a public figure, a location of a festival or celebration, a location of a scene in a content item, a location of a current event, a location of national or cultural/religious significance such as a landmark, a location of significance on a particular date(s), etc.), a preference(s) (e.g., a user preference, a group preference, a business preference, a preference of a sponsor, etc.), a user profile, a content, a signal identifying a promoted content or event, a weather signal, a trend signal, a popularity signal, a signal identifying a set of potential topics, a database of topics, a signal indicating an activity associated with a trend or data, a signal indicating an activity associated with a user or event, and/or any other signal.

At step 1004, UI management system 130 or media device(s) 104 can determine a respective selection parameter for each topic from the one or more topic candidates. Each topic can have a respective selection parameter (or multiple selection parameters). The respective selection parameter of a topic can include, for example, a topic preference score, a topic priority, a topic metric, and/or a topic relevance. The topic relevance can include a relevance of the topic with respect to a date when the UI is displayed (e.g., a current date), the user(s) 140, the application, content associated with the application, an event, a trend, a context, and/or any other cue (e.g., any other signal).

At step 1006, UI management system 130 or media device(s) 104 can select a particular topic from the one or more topic candidates based on the respective selection parameter for each topic from the one or more topic candidates. For example, UI management system 130 or media device(s) 104 can compare the respective selection parameter of each topic candidate with the respective selection parameter of each of the remaining topic candidates to identify the topic candidate that has the highest selection parameter. UI management system 130 or media device(s) 104 can then select the topic candidate with the highest selection parameter, such as the particular topic in step 1006.

UI management system 130 or media device(s) 104 can select the particular topic based on a relevance of the topic as compared to each of the remaining topic candidates. For example, UI management system 130 or media device(s) 104 can select the topic that has a highest relevance score and/or highest amount of relevant features (e.g., features related to the date, user(s) 140, application, application content, an event, etc.), a topic that has a threshold relevance, a topic that has a threshold relevance and is associated with another selection parameter (e.g., a particular topic preference score or a user preference, topic priority, topic metric, etc.), a topic that has a specific type of relevance (e.g., a specific type of relationship with or to the date, the user(s) 140, the application, a content of the application, a content item, an event, etc.), etc. In some cases, UI management system 130 or media device(s) 104 can select the particular topic based on a comparison between the respective selection parameter of each of the one or more topic candidates. For example, the particular topic can include a topic that has a highest relevance (or relevance score), a best match for the date and/or a user preference, a highest number of relevant characteristics, a highest relevance ranking, a threshold relevance, a threshold relevance as well as one or more additional selection criteria or factors relative to other topics (e.g., a user preference, a rating or ranking, an additional relevance, a cultural significance relative to other topics, a celebration statistic, a relevance history, etc.).

In some cases, the topic relevance can include a relevance score, a match or matching score, a similarity value, a relationship or relationship metric, a comparison metric, a relevance value, etc. For example, to determine the topic relevance of each topic, UI management system 130 or media device(s) 104 can compare aspects of the topic with the date, user preferences, user activity, aspects of the content of the application, a content item, the application, an event, a context, etc., to determine whether the topic is related to the date, is of more significance on the date (or a period that includes the date) than other dates, is related to an item being released/presented or promoted, matches or has a similarity/relevance to an event or topic associated with the date, etc.

At step 1008, UI management system 130 or media device(s) 104 can determine, based on the particular topic, one or more themes for the UI of the application. For example, UI management system 130 or media device(s) 104 can determine a theme(s) that is based on or relates to the particular topic and select that theme(s) for the UI. The particular topic can define the one or more themes and/or aspects thereof.

In some cases, the one or more themes can be based on one or more aspects or examples of the particular topic. For example, if the topic is football, the one or more themes can include a theme about a football team or a particular football game. In other words, the one or more themes can include a theme that relates generally to the particular topic and/or relates to a specific detail associated with the particular topic (e.g., football in general or a particular football team, player, game, etc.).

At step 1010, UI management system 130 or media device(s) 104 can generate UI data defining a customized configuration of the UI based on the one or more themes. For example, the UI data can define a configuration that customizes the UI to incorporate the one or more themes (or aspects thereof). In some examples, the customized configuration of the UI can include a user experience (UX) design of the UI that incorporates and/or is at least partly based on the one or more themes. The UX design can define a UI design customized based on the one or more themes, a configuration of the one or more themes, a user experience associated with the UI, a behavior of the UI, a UI background, a UI organization, an interaction design of the UI, an arrangement of items in the UI, UI parameters, and/or any other attributes of the UI.

In some cases, the UI design can include a visual design of the UI customized based on the one or more themes. The visual design can include, for example and without limitation, a layout of the UI (e.g., a page layout, an UI structure, a grid layout, a container layout, a section layout, a banner layout, a tile layout, a content layout, UI sections, content areas, a placement of UI elements, etc.), a UI style, a background (e.g., a background of the UI, a background of any UI elements, a background of any UI containers, etc.), artwork, imagery, an animation depicted in the UI, UI graphics, one or more definitions of one or more UI elements, one or more UI containers, and/or any other UI attributes. In some examples, the UI style can define or include visual attributes of the UI, such as a color and/or color scheme (e.g., a primary color, a secondary color, a color pattern, an accent color for one or more UI elements, a color palette, etc.), a typography (e.g., fonts or font families, sizes, weights, heading styles, etc.), one or more objects, a style (e.g., page style, UI element style, navigation style, design style, etc.), a visual property of the one or more UI elements (e.g., a background, an appearance, a label, a color, a shape, a size, a hover state, a placement, etc.), and/or any other visual attributes. In some examples, the color scheme can be based on the one or more themes. For example, if the one or more themes are associated with any specific color(s), the color scheme can include that specific color(s).

The UI design can optionally include the one or more UI elements and one or more UI containers. The one or more UI elements can include, for example, one or more navigation elements (e.g., a navigation bar, navigation drawer, navigation rail, bottom app bar, search element, tab, top app bar, scrolling element, next or back button, etc.), action or CTA elements (e.g., a button, selectable icon, selectable tile or card, link, input element, selectable content, etc.), selection and/or input elements (e.g., a checkbox, menu, date picker, button, slider, switch, picker, content selection element, etc.), text elements (e.g., a text field, label, section, input, etc.), interactive elements, control elements (e.g., control settings, buttons, command elements, etc.), menus, UI dividers, UI dialogue elements, a silhouette(s), a UI tile, a UI card, communication elements (e.g., a tooltip, badge, snackbar, progress indicator, notification or notification area, chat or message element, etc.), and/or any other UI element. The one or more UI containers can include, for example, one or more UI banners, UI sections, UI spaces, UI frames, UI sheets (e.g., bottom sheets, side sheets, etc.), UI carousels, dialogs, dividers, toolbars, etc.

The one or more definitions of the one or more UI elements can include a definition of each UI element. In some examples, the definition of each UI element can specify, include, and/or define a UI element type (e.g., button, checkbox, field, icon, image, showcase banner, tile, search element, menu, date picker, content picker, slider, navigation bar, selectable image or video, etc.), a UI element position, a UI element size, a UI element appearance (e.g., color(s), pattern(s), background(s), style, visual attribute, etc.), a UI element shape, a UI element background, a UI element behavior, UI element data/content, a UI element hierarchy, and/or any other UI element characteristic. In some examples, the UI element appearance can include a UI element color(s) and/or color scheme(s), a UI element font, a UI element border setting (e.g., no border, a border, a border width/thickness, a border color, etc.), a UI element style, a UI element image, a UI element link, a UI element background, a UI element pattern, a UI element label, a UI element text, a visual attribute of the UI element, and/or any other characteristic.

In some cases, the customized configuration of the UI can include a UI design customized based on the one or more themes. The UI design can include, for example, a layout, UI element definitions, UI content (e.g., displayed and/or available content items, content selected for the one or more themes, etc.), a visual design of the UI customized based on and/or incorporating the one or more themes, a navigation design, a UI template, a UI container(s), one or more UI parameters customized based on the one or more themes, and/or any other characteristics. The one or more UI parameters can define, for example and without limitation, one or more UI properties, one or more content spaces, one or more UI behaviors, etc. The UI content can include one or more UI elements, images, thumbnails, icons, videos, movies, TV shows, interactive content items, video games, podcasts, dynamic content, and/or any other content. The UI element definitions can specify UI element sizes, shapes, positions, appearances, backgrounds, styles, element types, behaviors, colors, color schemes, links, fonts, border settings, etc.

The visual design of the UI can include visual attributes of the UI customized based on the one or more themes and/or styling information based on the one or more themes. The styling information can include or specify a color(s) and/or color scheme associated with the one or more themes, a background, a typography, artwork, graphics, imagery, fonts, styles, border settings, iconography of any UI elements, labels, spacing, content structures, formatting, visual patterns, etc. The UI elements can include, for example, a UI tile, a UI card, a silhouette, a menu, a form element, a button, a navigation element, a search element, a selection element, a control element, a display element, an input element, and/or the like.

In some cases, UI management system 130 or media device(s) 104 can determine that the date when the UI is displayed corresponds to a scheduled event. The scheduled event can include, for example, a content release date or promotion, a formal holiday recognized by one or more entities, an informal holiday including a commemorative day celebrated by one or more users, a game, a competition, an announcement, a news event, a political event, a community event, and/or any other event. The particular topic can be associated with the scheduled event. For example, the particular topic can include, relate to, describe, and/or match the scheduled event (and/or any aspect thereof).

UI management system 130 or media device(s) 104 can determine, based on the determination that the date corresponds to the scheduled event, that the particular topic associated with the scheduled event has a highest selection parameter from the respective selection parameter of each topic from the one or more topic candidates. The highest selection parameter can include, for example, a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and/or a highest topic relevance from one or more respective topic relevances of the one or more topic candidates. UI management system 130 or media device(s) 104 can select the particular topic associated with the scheduled event from the one or more topic candidates based on the highest selection parameter associated with the particular topic, and determine the one or more themes for the UI based on the particular topic. The one or more themes can be customized based on the particular topic associated with the scheduled event. In some examples, the customized configuration of the UI can include the one or more theme customized based on the particular topic associated with the scheduled event.

In some cases, the topic preference score can be based on a preference of the user(s) 140, a group of users, the application, an entity associated with the application, a sponsor, and/or any other preference. The topic priority can be based on a topic trend score, a topic popularity, a topic promotion associated with the sponsor (e.g., a topic promoted by the sponsor, a topic having a promotion priority from the sponsor, a topic that the sponsor paid for or paid a certain amount for, etc.), a count of references to the topic in one or more media sources and/or social media networks (e.g., how many times the topic was referenced in one or more media sources and/or social media networks), a topic interest score, and/or any other criteria. The topic metric can include, for example, a topic request count, a topic statistic, a topic weight (e.g., a topic weight defined or specified by the application, the user(s) 140, an entity associated with the application, a sponsor, etc.), a topic performance value, etc. The topic relevance can be based on, for example, a relationship between the topic and the date when the UI is displayed (e.g., a current date), a context associated with the user(s) 140, a trend associated with a trend score (e.g., a trend on social media, a community, a popular culture, a region, etc., that has a threshold trend score, a particular trend score or count, a popularity score, etc.), a location of the user(s) 140, a UI content, an event, etc.

In some aspects, UI management system 130 or media device(s) 104 can select, based on user data, a topic personalized to the user(s) 140 and/or one or more features of the one or more themes personalized to the user(s) 140. The user data can include a user preference, a user input, a user history (e.g., content watch history, purchasing history, social media history, interaction, user profile, input history, history of activities, etc.), a user interaction(s) with content and/or previous UIs, a user purchase, a user characteristic (e.g., demographics, attributes, location, etc.), user activity, social media data (e.g., posts, connections, subscriptions, likes, dislikes, etc.), and/or any other user data. The topic personalized to the user and/or the one or more features personalized to the user can be associated with an activity, content, team, player, character, competition, genre, event, etc. The particular topic can include the topic personalized to the user(s) 140. UI management system 130 or media device(s) 104 can determine the one or more themes further based on the topic personalized to the user(s) 140, and determine the customized configuration of the UI based on the one or more themes and the one or more features personalized to the user.

In some cases, UI management system 130 or media device(s) 104 can determine that the date corresponds to a holiday, such as a formal holiday recognized by an entity (e.g., a federal or religious holiday, etc.) or an informal holiday such as a commemorative day celebrated by any users (e.g., “May The Fourth Be With You”, etc.). In some examples, the particular topic can include the holiday and UI management system 130 or media device(s) 104 can determine a respective relevance of a holiday topic associated with the holiday. UI management system 130 or media device(s) 104 can determine the respective relevance of the holiday topic based on the determination that the date corresponds to the holiday, select the holiday topic from the one or more topic candidates based on the respective relevance of the holiday topic, and determine the one or more themes for the UI based on the holiday topic. The one or more themes can include a holiday theme associated with the holiday topic and the customized configuration of the UI can be customized based on the holiday theme.

In some examples, UI management system 130 or media device(s) 104 can determine that the date matches a release date of a content item. The content item can include content scheduled for release in the application. The content can include a movie, TV show, video, podcast, video game, live content, or any other content. UI management system 130 or media device(s) 104 can determine a respective relevance of a content topic associated with the content item (e.g., a topic of the content item, a topic related to the content item, a topic about the release of the content item, etc.). UI management system 130 or media device(s) 104 can determine the respective relevance of the content topic based on the determination that the date matches the release date of the content item. In this example, the content topic can be the particular topic. UI management system 130 or media device(s) 104 can select the content topic from the one or more topic candidates based on the respective relevance of the content topic and determine the one or more themes for the UI based on the content topic. The one or more themes can include a theme associated with the content topic (e.g., a theme based on the content topic, a theme including the content topic, etc.), and the customized configuration of the UI can be customized based on the content topic.

In some cases, UI management system 130 or media device(s) 104 can determine that the date matches a scheduled date of an event, such as a game, competition, announcement, anniversary, annual event, celebration, holiday, activity, etc. UI management system 130 or media device(s) 104 can then determine a respective relevance of an event topic associated with the event (e.g., a topic related to or based on the event). UI management system 130 or media device(s) 104 can determine the respective relevance of the event topic based on the determination that the date matches the scheduled date of the event. The event topic can include or represent the particular topic. UI management system 130 or media device(s) 104 can select the event topic from the one or more topic candidates based on the respective relevance of the event topic and determine the one or more themes for the UI based on the event topic. The one or more themes can include an event theme associated with the event topic (e.g., a theme based on or related to the event or the event topic), and the customized configuration of the UI can be based on the event theme.

In some examples, UI management system 130 or media device(s) 104 can additionally or alternatively determine a preferred topic of the user(s) 140. The preferred topic of the user(s) 140 can include or be associated with a preferred activity, a preferred content, a preferred team, a preferred media character, a preferred winner of a contest, a preferred genre of content, a preferred event, a preferred celebration, a preferred geographic location, a preferred cultural detail, etc. UI management system 130 or media device(s) 104 can determine a respective relevance of the preferred topic of the user(s) 140. In this example, the preferred topic can include or represent the particular topic. UI management system 130 or media device(s) 104 can select the preferred topic from the one or more topic candidates based on the respective relevance of the preferred topic and determine the one or more themes for the UI based on the preferred topic. The one or more themes can include a theme associated with the preferred topic, and the customized configuration of the UI can be customized based on the theme associated with the preferred topic.

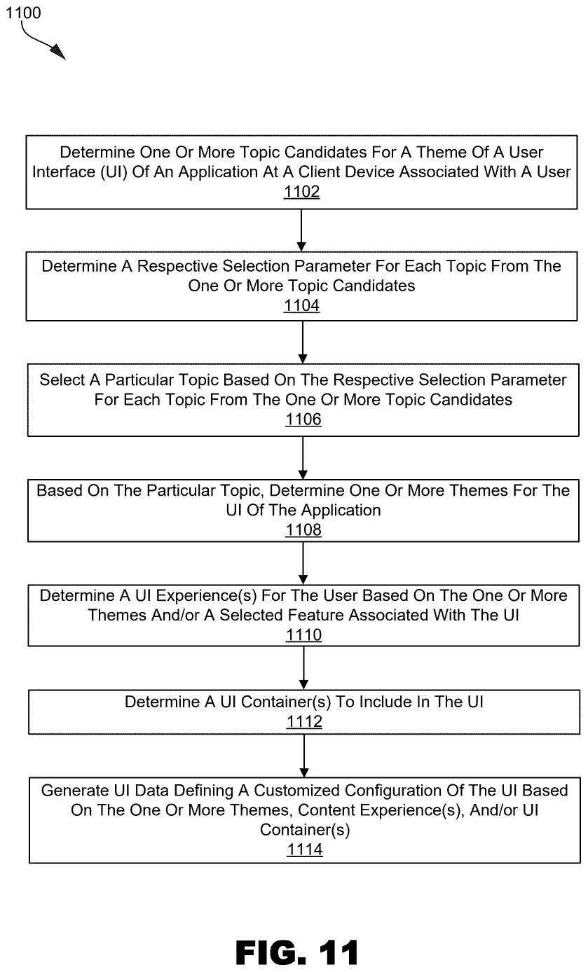

FIG. 11 is a flowchart illustrating an example method 1100 for customizing a UI to include a UI container(s) and an animation(s) associated with one or more customized themes. The method 1100 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 1100. Some of the steps may be performed simultaneously or in a different order than shown in FIG. 11, as will be understood by one of ordinary skill in the art. Method 1100 shall be described with reference to FIGS. 1 and 2. However, method 1100 is not limited to those examples.

At step 1102, UI management system 130 (e.g., at system server(s) 126 and/or media device(s) 104) can determine one or more topic candidates for a theme of a UI of an application at media device(s) 104. UI management system 130 can determine the one or more topic candidates based on one or more signals.

At step 1104, UI management system 130 can determine a respective selection parameter for each topic from the one or more topic candidates. Each topic can have a respective selection parameter (or multiple selection parameters). The respective selection parameter of a topic can include, for example, a topic preference score, topic priority, topic metric, and/or topic relevance. The topic relevance can include a relevance of the topic with respect to a date associated with a presentation of the UI (e.g., a current date), the user(s) 140, the application, content associated with the application, an event, a trend, a context, and/or any other cue (e.g., any other signal).

In some examples, the topic preference score can be based on a preference of the user(s) 140, a group of users, the application, an entity associated with the application, a sponsor, a business, and/or any other preference. The topic priority can be based on a topic trend score, topic popularity, topic promotion associated with the sponsor, count of references to the topic in one or more media sources and/or social networks, topic interest score, and/or any other priority score. The topic metric can include a topic request count, topic statistic, topic weight (e.g., a topic weight specified by the application, the entity, a user, etc.), topic performance value, etc. In some examples, the topic relevance can be based on a relationship between the topic and a date when the UI is displayed, a context associated with the user(s) 140, a trend associated with a trend score, a location associated with the user(s) 140, a content of the UI, an event, etc.

At step 1106, UI management system 130 can select a particular topic from the one or more topic candidates based on the respective selection parameter for each topic from the one or more topic candidates. For example, UI management system 130 can compare the respective selection parameter of each topic candidate with the respective selection parameter of each of the remaining topic candidates to identify the topic candidate that has the highest selection parameter. UI management system 130 can select the topic candidate with the highest selection parameter.

In some examples, UI management system 130 can select the particular topic based on a determination that the particular topic has a highest topic preference score, highest topic priority, highest topic interest score, highest topic metric, and/or highest a topic relevance relative to other topic candidates. The topic preference score can be based on a preference of the user(s) 140, a group of users, the application, an entity associated with the application, a sponsor associated with the application, a business, and/or any other preference. The topic priority can be based on a topic trend score, topic popularity, topic promotion associated with the sponsor, count of references to the topic in one or more media sources and/or social networks, topic interest score, and/or any other priority score. The topic metric can include a topic request count, topic statistic, topic weight (e.g., a topic weight specified by the application, the entity associated with the application, a user, etc.), topic performance value, etc. In some cases, the topic relevance can be based on a relationship between the topic and a date when the UI is displayed, a context associated with the user(s) 140, a trend associated with a trend score, a user location, a content of the UI, an event, etc.

At step 1108, UI management system 130 can determine, based on the particular topic, one or more themes for the UI of the application. For example, UI management system 130 can determine a theme(s) that is based on or relates to the particular topic and select that theme(s). The particular topic can define the one or more themes and/or any aspect of the one or more themes.

At step 1110, UI management system 130 can determine a UI experience(s) for the user(s) 140 based on the one or more themes and/or a selected feature associated with the UI. The selected feature can include a content item selected to be highlighted or promoted by the UI (e.g., based on a content release data of the content item, trend metric of the content item, content statistic, request from a sponsor or payment from the sponsor, relevance of the content item to a current date, event associated with the content item, campaign associated with the content item, rank or priority associated with the content item, etc.), a menu, a toolbar, a control element, a setting, a UI control, a functionality, and/or any other aspects of the UI selected to be highlighted, promoted, and/or included in a UI experience for the user(s) 140.

The UI experience(s) can include an animation(s) displayed by the UI (e.g., to promote or highlight the selected feature, draw the attention to the selected feature, help the user(s) 140 discover or explore the selected feature, help the user(s) 140 learn the selected feature, etc.), CTAs, user/content interactions, UI activities, UI behaviors and/or actions, UI outputs, games on the UI, challenges provided by the UI, content item references (e.g., hidden messages or clues pertaining to specific content items such as movies or TV shows), and/or any other interactions between the user(s) 140 and the UI (and/or content/features thereof).

For example, if UI management system 130 selects to promote a feature of the UI, UI management system 130 can determine whether to promote the feature by using an animation, configuring the UI (or aspects thereof) or the feature to have an appearance used to promote or highlight the feature (e.g., adjusting a size, placement, and/or visual attribute of the feature), configuring the UI to provide a game or activity that may draw the user's attention to the feature, or determining any other way to promote the feature.

If UI management system 130 determines to use an animation to promote the feature, UI management system 130 can determine what animation and/or type of animation to use to promote the feature and/or how to configure such animation. For example, UI management system 130 can determine to configure the feature to be animated to draw the user's attention to the feature. As another example, to promote the feature, UI management system 130 can select to configure the UI to invite, encourage, draw, or enable the user(s) 140 to explore the feature in the UI in exchange of a benefit to the user(s) 140 that incentivizes the user(s) 140 to use or explore the feature as a way to promote the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of the user(s) 140 displayed on UIs presented to other users, being recognized in the UIs presented to other users, etc.), unlocking a feature/functionality, etc.

To illustrate, if the feature includes an advertisement, UI management system 130 can configure the UI to invite the user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that the user(s) 140 would need to access to get to the control setting.

In some cases, the UI experience(s) can relate or be based on the one or more themes of the UI. For example, if the one or more themes includes a soccer theme, the UI experience(s) can involve soccer content, a soccer activity or game, and/or can be configured to have a visual appearance associated with soccer. Thus, UI management system 130 can take into account the one or more themes selected for the UI when determining a UI experience(s) for the UI. When determining the UI experience(s), UI management system 130 can use content information, sponsor information, campaign information, event information, user information, application information, statistics, social media data, historical data, topic information, and/or any other data described herein. For example, UI management system 130 can use information indicating that a movie is being released on a particular day and select the movie as the feature for the UI experience(s). UI management system 130 can determine a UI experience(s) to promote the movie on the day of release.

At step 1112, UI management system 130 can optionally determine a UI container(s) to include in the UI. UI management system 130 can also determine a configuration of the UI container(s) such as, for example, a type of UI container(s) (e.g., UI banner, section, sheet, carousel, toolbar, space, box, etc.), a size and/or shape of the UI container(s), a UI container style and/or design (e.g., row, column, circle, etc.), a UI container appearance, a UI container behavior, a UI container placement, a UI container animation, a UI container background, a UI container customization (e.g., based on a theme(s), etc.), a type of UI elements (e.g., UI cards, tiles, boxes, navigation elements, input elements, display elements, spaces, menus, etc.), UI content, an arrangement of items in the UI container(s) (e.g., row, column, etc.), a number of UI containers, and/or any other attributes of the UI container(s).

The UI container(s) can organize and/or host content, UI elements, animations, and/or any other features. UI container(s) can be customized based on the one or more themes. In some examples, UI management system 130 can generate configuration data for configuring the UI container(s) and/or a specification of the UI container(s) defining how to configure the UI container(s). In some cases, the configuration data can include code configured to render/generate and/or configure the UI container(s). The configuration data can be used to build, configure, and/or render the UI container(s), and/or can include a UI container template, a specification of the UI container(s), a design of the UI container(s), UI elements in the UI container(s), content items and/or animations in the UI container(s), definitions of any UI elements of UI container(s), code or definitions of a behavior of the UI container(s), UI parameters associated with the UI container(s), parameters for integrating the UI container(s) into the UI, and/or any other content and/or configuration data for the UI container(s).

In some examples, the UI container(s) can implement the one or more themes and/or visual components thereof. For example, the UI container(s) can display content related to the one or more themes. The content can include imagery, UI elements, text, videos, interactive content, metadata, logos, icons, and/or any other content. In some cases, the content can include tiles, and the tiles can be positioned within the UI container(s) according to any arrangement or grouping, such as a row, column, cloud, grid, or any other arrangement. The tiles can depict content related to or based on the one or more themes. To illustrate, if the one or more themes includes a baseball theme, the tiles can depict baseball content, visual content related to one or more baseball teams and/or games (e.g., images of the one or more baseball teams, colors of the one or more baseball teams, team logos of the baseball teams, team mascots of the one or more baseball teams, text labels/titles and/or content with names and/or information of the one or more baseball teams, image covers of one or more videos of the one or more baseball teams, etc.), a visual design or pattern associated with a baseball team or conference, baseball player images, etc.

In some cases, the tiles can be selectable to access associated content or navigate to associated content or pages. In some cases, the tiles can be selected to access related content pages or interface views. In some examples, the user(s) 140 can select a tile to access more information about a content or topic associated with the tile, update a view of the UI container(s) to display an updated tile or content, load an associated page, etc. The UI container(s) (and/or the tiles) can include or incorporate any visual attributes of the UI or other visual attributes that are based on or have a similarity to any visual attributes of the UI. For example, if the one or more visual attributes of the UI include a background and imagery depicting a city theme, the UI container(s) (and/or the tiles) can also include the background (or a portion thereof) and/or the imagery (or a portion thereof) depicting the city theme, or can include other visual attributes that depict the city theme or another city theme (e.g., a theme of another city, a theme of the same real or fictitious city with modifications or from a different view, etc.). The UI container(s) (and/or tiles) can include the background and/or imagery or the other visual attributes in addition to any other visual details or components configured or selected based on the one or more themes (e.g., in addition to other visual content and/or attributes configured to reflect the one or more themes).

At step 1114, UI management system 130 can generate UI data defining a customized configuration of the UI based on the one or more themes, the content experience(s), and/or the UI container(s). In some cases, the UI data can include the UI customized based on the one or more themes, the content experience(s) and/or the UI container(s). UI management system 130 can provide the UI data to media device(s) 104 which can render/display the UI. In other cases, the UI data can include data used to generate, render, configure, and/or customize the UI based on the one or more themes, the content experience(s), and/or the UI container(s). For example, the UI data can include a description and/or specification of the UI, instructions for generating/customizing and/or rendering/displaying the UI, UI objects (e.g., UI elements, UI container(s), etc.), UI content, UI parameters, and/or other data. Media device(s) 104 can use such data to generate, build, customize, and/or render/display the customized UI.

In some cases, the UI can be customized based on a user profile. UI management system 130 can use the profile to collect user data, which UI management system 130 can use to customize the UI. If the profile is an existing profile with data, UI management system 130 can customize any aspects of the UI based on the profile (e.g., based on user preferences, a watch/content history, user statistics, content purchases, subscriptions, user inputs, user histories, etc.), such as the theme(s), a background, the UI experience(s), the UI container(s), any UI elements, visual elements, UI content, promoted items, etc.

### Example Computer System

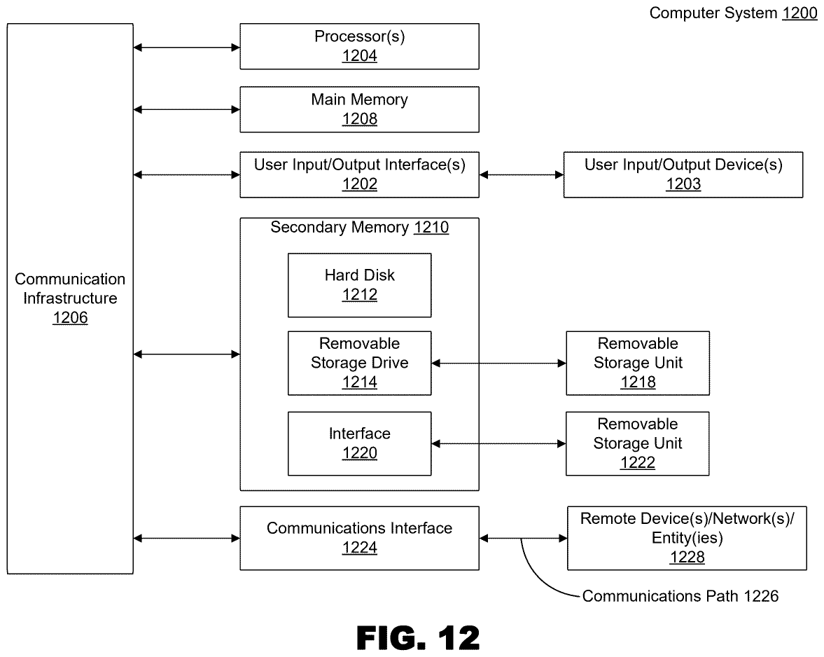

Various aspects and examples may be implemented using one or more computer systems, such as computer system 1200 shown in FIG. 12. For example, media device(s) 104, display device(s) 106, the content server(s) 120, system server(s) 126, UI management system 130, and/or any other device may be implemented using combinations or sub-combinations of computer system 1200. Also or alternatively, computer system 1200 may be used to implement any of the aspects and examples discussed herein, and combinations and sub-combinations thereof.

Computer system 1200 may include one or more processors (e.g., central processing units or CPUs), such as processor 1204. Processor 1204 may be connected to a communication infrastructure 1206 (or communication bus). Computer system 1200 may also include user input/output device(s) 1203, such as monitors, keyboards, pointing devices, etc., which may communicate with communication infrastructure 1206 through user input/output interface(s) 1202.

In some examples, the one or more processors 1204 may include a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the one or more processors 1204 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1200 may also include a main or primary memory 1208, such as random access memory (RAM). Main memory 1208 may include one or more levels of cache. Main memory 1208 may have stored therein control logic (e.g., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, /d/ any other computer data storage device. Removable storage drive 1214 may read from and/or write to removable storage unit 1218. Secondary memory 1210 may include other means, devices, components, instrumentalities or approaches for allowing computer programs, instructions, and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), removable memory chip (e.g., EPROM, PROM, etc.) and associated socket, memory stick and USB or other port, memory card and associated card slot, and/or any removable storage and associated interface.

Computer system 1200 may include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, mobile phone (e.g., smartphone), smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Proprietary data structures, formats or schemas may be used, either exclusively or in combination with known or open standards.

In some cases, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200 or processor(s) 1204), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. Embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating implementations of specified functions and relationships thereof. The boundaries of these functional building blocks have been defined herein for the convenience of the description. Alternate boundaries can be defined as long as the specified functions and relationships (or equivalents thereof) are appropriately performed. Alternative embodiments can perform functional blocks, steps, operations, methods, etc. using orderings different than those described herein.

References to “one embodiment,” “an embodiment,” “an example embodiment,” or similar phrases indicate that the embodiment may include a particular feature, structure, or characteristic, but every embodiment may not necessarily include that feature, structure, or characteristic. Moreover, such phrases are not necessarily referring to the same embodiment. When a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described examples, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative Examples of the Disclosure Include

Aspect 1. A system comprising: memory; and one or more processors are coupled to the memory and configured to perform operations comprising: determining one or more topic candidates for a theme of a user interface (UI) of an application at a client device associated with a user; determining a respective selection parameter for each topic from the one or more topic candidates, the respective selection parameter comprising at least one of a topic preference score, a topic priority, a topic metric, and a topic relevance to at least one of a date associated with a presentation of the UI, the user, the application, and content associated with the application; selecting a particular topic from the one or more topic candidates based on the respective selection parameter for each topic from the one or more topic candidates; based on the particular topic, determining one or more themes for the UI of the application; and generating UI data defining a customized configuration of the UI based on the one or more themes.

Aspect 2. The system of Aspect 1, wherein the customized configuration of the UI based on the one or more themes comprises a user experience (UX) design based on the one or more themes, the UX design defining at least one of a UI design customized based on the one or more themes, a configuration of the one or more themes, a user experience associated with the UI, a behavior of the UI, a background of the UI, an organization of the UI, and an arrangement of items in the UI.

Aspect 3. The system of Aspect 2, wherein the UI design comprises a visual design of the UI customized based on the one or more themes, the visual design comprising at least one of a layout of the UI, a UI style, the background of the UI, artwork depicted in the UI, an animation depicted in the UI, UI graphics, UI imagery, and one or more definitions of one or more UI elements, wherein the UI style defines visual attributes of the UI, the visual attributes comprising at least one of a color, a color scheme, a typography, one or more UI objects, and a visual property of the one or more UI elements, and wherein the color scheme is based on the one or more themes.

Aspect 4. The system of Aspect 3, wherein the UI design further comprises the one or more UI elements and one or more UI containers, the one or more UI elements comprising at least one of a navigation element, a call-to-action element, an input element, a UI divider, a UI dialogue element, a selection elements, a text element, a menu, an interactive element, a control element, a silhouette, a tile, and a card; the one or more UI containers comprising at least one of a UI banner, a UI sheet, a UI toolbar, a UI section, and a UI carousel; and wherein the UI sheet comprises at least one of a bottom sheet and a side sheet.

Aspect 5. The system of any of Aspects 3 or 4, wherein the one or more definitions of the one or more UI elements comprise a definition of each UI element from the one or more UI elements, wherein the definition of each UI element specifies at least one of a UI element type, a UI element position, a UI element size, a UI element appearance, a UI element shape, a UI element background, and a UI element behavior, wherein the UI element appearance comprises at least one of a UI element color, a UI element font, a UI element border setting, a UI element style, a UI element image, a UI element pattern, a UI element label, a UI element text, and a visual attribute of the UI element.

Aspect 6. The system of any of Aspects 1 to 5, wherein the customized configuration of the UI comprises a UI design customized based on the one or more themes, wherein the UI design customized based on the one or more themes comprises at least one of a layout, a respective definition of each UI element in the UI, UI content comprising one or more content items selected for the one or more themes, a visual design of the UI customized based on the one or more themes, a navigation design, a UI template, a UI container, and one or more UI parameters customized based on the one or more themes, the one or more UI parameters defining at least one of a UI behavior, a UI property, and a content space, wherein the UI content comprises at least one of an image, a thumbnail, an icon, a video, interactive content, metadata, display content, a graphic, and a background, and wherein the respective definition of each UI element in the UI specifies one or more characteristics of the UI element comprising at least one of a size, a shape, a position, an appearance, a background, a style, a type, a behavior, a color, a font, and a border setting.

Aspect 7. The system of Aspect 6, wherein the visual design of the UI comprises at least one of visual attributes of the UI customized based on the one or more themes and styling information based on the one or more themes, wherein the styling information specifies at least one of a color, a color scheme, a UI background, a typography, artwork, graphics, and imagery, wherein the UI container comprises at least one of a UI banner, a UI sheet, a UI toolbar, and a UI section, and wherein the UI element comprises at least one of a UI tile, a UI card, a silhouette, a menu, a form element, a button, a navigation element, a search element, a selection element, a control element, a display element, and an input element.

Aspect 8. The system of any of Aspects 1 to 7, wherein the one or more processors are configured to perform operations further comprising: determining that the date corresponds to a scheduled event, the scheduled event comprising a release date or promotion of a content item, a formal holiday recognized by an entitiy, an informal holiday comprising a commemorative day celebrated by users, a game, a competition, an announcement, a news event, a political event, and a community event, and wherein the particular topic is associated with the scheduled event; based on the determining that the date corresponds to the scheduled event, determining that the particular topic associated with the scheduled event has a highest selection parameter from the respective selection parameter of each topic from the one or more topic candidates, the highest selection parameter comprising at least one of a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and a highest topic relevance from one or more respective topic relevances of the one or more topic candidates; selecting the particular topic associated with the scheduled event from the one or more topic candidates based on the highest selection parameter associated with the particular topic; and determining the one or more themes for the UI based on the particular topic, the one or more themes being customized based on the particular topic associated with the scheduled event, wherein the customized configuration of the UI comprises the one or more theme customized based on the particular topic associated with the scheduled event.

Aspect 9. The system of Aspect 8, wherein the content item comprises at least one of a movie, a TV show, a video, a podcast, a video game, and live content, wherein the topic preference score is based on a preference of at least one of the user, a group of users, the application, an entity associated with the application, and a sponsor associated with the application, wherein the topic priority is based on at least one of a topic trend score, a topic popularity, a topic promotion associated with the sponsor, a count of references to the topic in one or more media sources or social media networks, and a topic interest score, wherein the topic metric comprises at least one of a topic request count, a topic statistic, a topic weight specified by at least one of the application and the entity associated with the application, and a topic performance value, and wherein the topic relevance is based on at least one of a relationship between the topic and at least one of the date, a context associated with the user, a trend associated with a trend score, a location associated with the user, a content of the UI, and an event.

Aspect 10. The system of any of Aspects 1 to 9, wherein the one or more processors are configured to perform operations further comprising: selecting, based on user data, at least one of a topic personalized to the user and one or more features of the one or more themes personalized to the user, the user data comprising at least one of a user preference, a user input, a user history, a user interaction, a user purchase, a user characteristic, and a user activity, the at least one of the topic and one or more features personalized to the user being associated with at least one of an activity, a content, a team, a character, a competition, a genre, and an event, wherein the particular topic comprises the topic personalized to the user;
determining the one or more themes further based on the topic personalized to the user; and determining the customized configuration of the UI based on the one or more themes and the one or more features of the one or more themes personalized to the user.

Aspect 11. A computer-implemented method comprising: determining one or more topic candidates for a theme of a user interface (UI) of an application at a client device associated with a user; determining a respective selection parameter for each topic from the one or more topic candidates, the respective selection parameter comprising at least one of a topic preference score, a topic priority, a topic metric, and a topic relevance to at least one of a date associated with a presentation of the UI, the user, the application, and content associated with the application; selecting a particular topic from the one or more topic candidates based on the respective selection parameter for each topic from the one or more topic candidates; based on the particular topic, determining one or more themes for the UI of the application; and generating UI data defining a customized configuration of the UI based on the one or more themes.

Aspect 12. The computer-implemented method of Aspect 11, wherein the customized configuration of the UI based on the one or more themes comprises a user experience (UX) design based on the one or more themes, the UX design defining at least one of a UI design customized based on the one or more themes, a configuration of the one or more themes, a user experience associated with the UI, a behavior of the UI, a background of the UI, an organization of the UI, and an arrangement of items in the UI.

Aspect 13. The computer-implemented method of Aspect 12, wherein the UI design comprises a visual design of the UI customized based on the one or more themes, the visual design comprising at least one of a layout of the UI, a UI style, the background of the UI, artwork depicted in the UI, an animation depicted in the UI, UI graphics, UI imagery, and one or more definitions of one or more UI elements, wherein the UI style defines visual attributes of the UI, the visual attributes comprising at least one of a color, a color scheme, a typography, one or more UI objects, and a visual property of the one or more UI elements, and wherein the color scheme is based on the one or more themes.

Aspect 14. The computer-implemented method of Aspect 13, wherein the UI design further comprises the one or more UI elements and one or more UI containers, wherein the one or more UI elements comprise at least one of a navigation element, a call-to-action element, an input element, a UI divider, a UI dialogue element, a selection elements, a text element, menu, an interactive element, a control element, a silhouette, a UI tile, and a UI card; wherein the one or more UI containers comprise at least one of a UI banner, a UI sheet, a UI toolbar, a UI section, and a UI carousel; and wherein the UI sheet comprises at least one of a bottom sheet and a side sheet.

Aspect 15. The computer-implemented method of any of Aspects 13 or 14, wherein the one or more definitions of the one or more UI elements comprise a definition of each UI element from the one or more UI elements, wherein the definition of each UI element specifies at least one of a UI element type, a UI element position, a UI element size, a UI element appearance, a UI element shape, a UI element background, and a UI element behavior, wherein the UI element appearance comprises at least one of a UI element color, a UI element font, a UI element border setting, a UI element style, a UI element image, a UI element pattern, a UI element label, a UI element text, and a visual attribute of the UI element.

Aspect 16. The computer-implemented method of any of Aspects 11 to 15, wherein the customized configuration of the UI comprises a UI design customized based on the one or more themes, wherein the UI design customized based on the one or more themes comprises at least one of a layout, a respective definition of each UI element in the UI, UI content comprising one or more content items selected for the one or more themes, a visual design of the UI customized based on the one or more themes, a navigation design, a UI template, a UI container, and one or more UI parameters customized based on the one or more themes, the one or more UI parameters defining at least one of a UI behavior, a UI property, and a content space, wherein the UI content comprises at least one of an image, a thumbnail, an icon, a video, interactive content, metadata, display content, a graphic, and a background, and wherein the respective definition of each UI element in the UI specifies one or more characteristics of the UI element comprising at least one of a size, shape, position, appearance, background, style, type, behavior, color, font, and border setting.

Aspect 17. The computer-implemented method of Aspect 16, wherein the visual design of the UI comprises at least one of visual attributes of the UI customized based on the one or more themes and styling information based on the one or more themes, wherein the styling information specifies at least one of a color, color scheme, background, typography, artwork, graphics, and imagery, wherein the UI container comprises at least one of a UI banner, a UI sheet, a UI toolbar, and a UI section, and wherein the UI element comprises at least one of a UI tile, a UI card, a silhouette, a menu, a form element, a button, a navigation element, a search element, a selection element, a control element, a display element, and an input element.

Aspect 18. The computer-implemented method of any of Aspects 11 to 17, further comprising: determining that the date corresponds to a scheduled event, wherein the particular topic is associated with the scheduled event; based on the determining that the date corresponds to the scheduled event, determining that the particular topic associated with the scheduled event has a highest selection parameter from the respective selection parameter of each topic from the one or more topic candidates, the highest selection parameter comprising at least one of a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and a highest topic relevance from one or more respective topic relevances of the one or more topic candidates; selecting the particular topic associated with the scheduled event from the one or more topic candidates based on the highest selection parameter associated with the particular topic; and determining the one or more themes for the UI based on the particular topic, the one or more themes being customized based on the particular topic associated with the scheduled event, wherein the customized configuration of the UI comprises the one or more theme customized based on the particular topic associated with the scheduled event.

Aspect 19. The computer-implemented method of Aspect 18, wherein the scheduled event comprises at least one of a release date of a content item, a promotion date of the content item, a formal holiday recognized by one or more entities, an informal holiday comprising a commemorative day celebrated by one or more users, a game, a competition, a calendar event, an announcement, a news event, a political event, and a community event.

Aspect 20. The computer-implemented method of Aspect 18 or 19, wherein the content item comprises at least one of a movie, a TV show, a video, a podcast, a video game, and live content.

Aspect 21. The computer-implemented method of any of Aspects 18 to 20, wherein the topic preference score is based on a preference of at least one of the user, a group of users, the application, an entity associated with the application, and a sponsor associated with the application.

Aspect 22. The computer-implemented method of any of Aspects 18 to 21, wherein the topic priority is based on at least one of a topic trend score, a topic popularity, a topic promotion associated with the sponsor, a count of references to the topic in a source or social media network, and a topic interest score.

Aspect 23. The computer-implemented method of any of Aspects 18 to 22, wherein the topic metric comprises at least one of a topic request count, a topic statistic, a topic weight specified by at least one of the application and the entity associated with the application, and a topic performance value.

Aspect 24. The computer-implemented method of any of Aspects 18 to 23, wherein the topic relevance is based on at least one of a relationship between the topic and at least one of the date, a context associated with the user, a trend associated with a trend score, a location associated with the user, a content of the UI, and an event.

Aspect 25. The computer-implemented method of any of Aspects 11 to 24, further comprising: selecting, based on user data, at least one of a topic personalized to the user and one or more features of the one or more themes personalized to the user, wherein the particular topic comprises the topic personalized to the user; determining the one or more themes further based on the topic personalized to the user; and determining the customized configuration of the UI based on the one or more themes and the one or more features of the one or more themes personalized to the user.

Aspect 26. The computer-implemented method of Aspect 25, wherein the user data comprises at least one of a user preference, a user input, a user history, a user interaction, a user purchase, a user characteristic, and a user activity.

Aspect 27. The computer-implemented method of Aspect 25 or 26, wherein the at least one of the topic and one or more features personalized to the user is associated with at least one of an activity, a content, a team, a character, a competition, a genre, and an event.

Aspect 28. A non-transitory computer-readable medium having instructions stored thereon that, when executed by one or more processors, cause the one or more processors to perform a method according to any of Aspects 11 to 27.

Aspect 29. A system comprising means for performing a method according to any of Aspects 11 to 27.

What is claimed is:

1. A system comprising:
memory; and
one or more processors are coupled to the memory and configured to perform operations comprising:
determining one or more topic candidates for a theme of a user interface (UI) of an application at a client device associated with a user;
determining a respective selection parameter for each topic from the one or more topic candidates, the respective selection parameter comprising at least one of a topic preference score, a topic priority, a topic metric, and a topic relevance to at least one of a date associated with a presentation of the UI, the user, the application, and content associated with the application;
selecting a particular topic from the one or more topic candidates based on the respective selection parameter for each topic from the one or more topic candidates;
based on the particular topic, determining one or more themes for the UI of the application; and
generating UI data defining a customized configuration of the UI based on the one or more themes.

2. The system of claim 1, wherein the customized configuration of the UI based on the one or more themes comprises a user experience (UX) design based on the one or more themes, the UX design defining at least one of a UI design customized based on the one or more themes, a configuration of the one or more themes, a user experience associated with the UI, a behavior of the UI, a background of the UI, an organization of the UI, and an arrangement of items in the UI.

3. The system of claim 2, wherein the UI design comprises a visual design of the UI customized based on the one or more themes, the visual design comprising at least one of a layout of the UI, a UI style, the background of the UI, artwork depicted in the UI, an animation depicted in the UI, UI graphics, UI imagery, and one or more definitions of one or more UI elements, wherein the UI style defines visual attributes of the UI, the visual attributes comprising at least one of a color, a color scheme, a typography, one or more UI objects, and a visual property of the one or more UI elements, and wherein the color scheme is based on the one or more themes.

4. The system of claim 3, wherein the UI design further comprises the one or more UI elements and one or more UI containers, wherein the one or more UI elements comprise at least one of a navigation element, a call-to-action element, an input element, a UI divider, a UI dialogue element, a selection elements, a text element, menu, an interactive element, a control element, a silhouette, a UI tile, and a UI card; wherein the one or more UI containers comprise at least one of a UI banner, a UI sheet, a UI toolbar, a UI section, and a UI carousel; and
wherein the UI sheet comprises at least one of a bottom sheet and a side sheet.

5. The system of claim 3, wherein the one or more definitions of the one or more UI elements comprise a definition of each UI element from the one or more UI elements, wherein the definition of each UI element specifies at least one of a UI element type, a UI element position, a UI element size, a UI element appearance, a UI element shape, a UI element background, and a UI element behavior, wherein the UI element appearance comprises at least one of a UI element color, a UI element font, a UI element border setting, a UI element style, a UI element image, a UI element pattern, a UI element label, a UI element text, and a visual attribute of the UI element.

6. The system of claim 1, wherein the customized configuration of the UI comprises a UI design customized based on the one or more themes, wherein the UI design customized based on the one or more themes comprises at least one of a layout, a respective definition of each UI element in the UI, UI content comprising one or more content items selected for the one or more themes, a visual design of the UI customized based on the one or more themes, a navigation design, a UI template, a UI container, and one or more UI parameters customized based on the one or more themes, the one or more UI parameters defining at least one of a UI behavior, a UI property, and a content space, wherein the UI content comprises at least one of an image, a thumbnail, an icon, a video, interactive content, metadata, display content, a graphic, and a background, and wherein the respective definition of each UI element in the UI specifies one or more characteristics of the UI element comprising at least one of a size, a shape, a position, an appearance, a background, a style, a type, a behavior, a color, a font, and a border setting.

7. The system of claim 6, wherein the visual design of the UI comprises at least one of visual attributes of the UI customized based on the one or more themes and styling information based on the one or more themes, wherein the styling information specifies at least one of a color, a color scheme, a UI background, a typography, artwork, graphics, and imagery, wherein the UI container comprises at least one of a UI banner, a UI sheet, a UI toolbar, and a UI section, and wherein the UI element comprises at least one of a UI tile, a UI card, a silhouette, a menu, a form element, a button, a navigation element, a search element, a selection element, a control element, a display element, and an input element.

8. The system of claim 1, wherein the one or more processors are configured to perform operations further comprising:
determining that the date corresponds to a scheduled event, wherein the scheduled event comprises a release date or promotion of a content item, a formal holiday recognized by one or more entities, an informal holiday comprising a commemorative day celebrated by one or more users, a game, a competition, an announcement, a news event, a political event, and a community event, and wherein the particular topic is associated with the scheduled event;
based on the determining that the date corresponds to the scheduled event, determining that the particular topic associated with the scheduled event has a highest selection parameter from the respective selection parameter of each topic from the one or more topic candidates, the highest selection parameter comprising at least one of a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and a highest topic relevance from one or more respective topic relevances of the one or more topic candidates;
selecting the particular topic associated with the scheduled event from the one or more topic candidates based on the highest selection parameter associated with the particular topic; and
determining the one or more themes based on the particular topic, the one or more themes being customized based on the particular topic, wherein the customized configuration of the UI comprises the one or more themes customized based on the particular topic associated with the scheduled event.

9. The system of claim 8, wherein the content item comprises at least one of a movie, TV show, video, podcast, video game, and live content, wherein the topic preference score is based on a preference of at least one of the user, a group of users, the application, an entity associated with the application, and a sponsor, wherein the topic priority is based on at least one of a topic trend score, a topic popularity, a topic promotion associated with the sponsor, a count of references to the topic in one or more media sources or social media networks, and a topic interest score, wherein the topic metric comprises at least one of a topic request count, a topic statistic, a topic weight specified by at least one of the application and the entity associated with the application, and a topic performance value, and wherein the topic relevance is based on at least one of a relationship between the topic and at least one of the date, a context associated with the user, a trend associated with a trend score, a location associated with the user, a content of the UI, and an event.

10. The system of claim 1, wherein the one or more processors are configured to perform operations further comprising:
selecting, based on user data, at least one of a topic personalized to the user and one or more features of the one or more themes personalized to the user, the user data comprising at least one of a user preference, a user input, a user history, a user interaction, a user purchase, a user characteristic, and a user activity, the at least one of the topic and one or more features personalized to the user being associated with at least one of an activity, a content, a team, a character, a competition, a genre, and an event, wherein the particular topic comprises the topic personalized to the user;
determining the one or more themes further based on the topic personalized to the user; and
determining the customized configuration of the UI based on the one or more themes and the one or more features of the one or more themes personalized to the user.

11. A computer-implemented method comprising:
determining one or more topic candidates for a theme of a user interface (UI) of an application at a client device associated with a user;
determining a respective selection parameter for each topic from the one or more topic candidates, the respective selection parameter comprising at least one of a topic preference score, a topic priority, a topic metric, and a topic relevance to at least one of a date associated with a presentation of the UI, the user, the application, and content associated with the application;
selecting a particular topic from the one or more topic candidates based on the respective selection parameter for each topic from the one or more topic candidates;
based on the particular topic, determining one or more themes for the UI of the application; and
generating UI data defining a customized configuration of the UI based on the one or more themes.

12. The computer-implemented method of claim 11, wherein the customized configuration of the UI based on the one or more themes comprises a user experience (UX) design based on the one or more themes, the UX design defining at least one of a UI design customized based on the one or more themes, a configuration of the one or more themes, a user experience associated with the UI, a behavior of the UI, a background of the UI, an organization of the UI, and an arrangement of items in the UI.

13. The computer-implemented method of claim 12, wherein the UI design comprises a visual design of the UI customized based on the one or more themes, the visual design comprising at least one of a layout of the UI, a UI style, the background of the UI, artwork depicted in the UI, an animation depicted in the UI, UI graphics, UI imagery, and one or more definitions of one or more UI elements, wherein the UI style defines visual attributes of the UI, the visual attributes comprising at least one of a color, a color scheme, a typography, one or more UI objects, and a visual property of the one or more UI elements, and wherein the color scheme is based on the one or more themes.

14. The computer-implemented method of claim 13, wherein the UI design further comprises the one or more UI elements and one or more UI containers, wherein the one or more UI elements comprise at least one of a navigation element, a call-to-action element, an input element, a UI divider, a UI dialogue element, a selection element, a text element, a menu, an interactive element, a control, a silhouette, a tile, and a UI card; wherein the one or more UI containers comprise at least one of a banner, a sheet, a toolbar, a UI section, and a carousel; and wherein the UI sheet comprises at least one of a bottom sheet and a side sheet.

15. The computer-implemented method of claim 13, wherein the one or more definitions of the one or more UI elements comprise a definition of each UI element from the one or more UI elements, wherein the definition of each UI element specifies at least one of a UI element type, a UI element position, a UI element size, a UI element appearance, a UI element shape, a UI element background, and a UI element behavior, wherein the UI element appearance comprises at least one of a UI element color, a UI element font, a UI element border setting, a UI element style, a UI element image, a UI element pattern, a UI element label, a UI element text, and a visual attribute of the UI element.

16. The computer-implemented method of claim 11, wherein the customized configuration of the UI comprises a UI design customized based on the one or more themes, wherein the UI design customized based on the one or more themes comprises at least one of a layout, a respective definition of each UI element in the UI, UI content comprising one or more content items selected for the one or more themes, a visual design of the UI customized based on the one or more themes, a navigation design, a UI template, a UI container, and one or more UI parameters customized based on the one or more themes, the one or more UI parameters defining at least one of a UI behavior, a UI property, and a content space, wherein the UI content comprises at least one of an image, a thumbnail, an icon, a video, interactive content, metadata, display content, a graphic, and a background, and wherein the respective definition of each UI element in the UI specifies one or more characteristics of the UI element comprising at least one of a size, a shape, a position, an appearance, a background, a style, a type, a behavior, a color, a font, and a border setting.

17. The computer-implemented method of claim 16, wherein the visual design of the UI comprises at least one of visual attributes of the UI customized based on the one or more themes and styling information based on the one or more themes, wherein the styling information specifies at least one of a color, a color scheme, a UI background, a typography, artwork, graphics, and imagery, wherein the UI container comprises at least one of a UI banner, a UI sheet, a UI toolbar, and a UI section, and wherein the UI element comprises at least one of a UI tile, a UI card, a silhouette, a menu, a form element, a button, a navigation element, a search element, a selection element, a control element, a display element, and an input element.

18. The computer-implemented method of claim 11, further comprising:
determining that the date corresponds to a scheduled event, wherein the scheduled event comprises a release date or promotion of a content item, a formal holiday recognized by one or more entities, an informal holiday comprising a commemorative day celebrated by one or more users, a game, a competition, an announcement, a news event, a political event, and a community event, and wherein the particular topic is associated with the scheduled event;
based on the determining that the date corresponds to the scheduled event, determining that the particular topic associated with the scheduled event has a highest selection parameter from the respective selection parameter of each topic from the one or more topic candidates, the highest selection parameter comprising at least one of a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and a highest topic relevance from one or more respective topic relevances of the one or more topic candidates;
selecting the particular topic associated with the scheduled event from the one or more topic candidates based on the highest selection parameter associated with the particular topic; and
determining the one or more themes for the UI based on the particular topic, the one or more themes being customized based on the particular topic associated with the scheduled event, wherein the customized configuration of the UI comprises the one or more theme customized based on the particular topic associated with the scheduled event.

19. The computer-implemented method of claim 18, wherein the content item comprises at least one of a movie, TV show, video, podcast, video game, and live content, wherein the topic preference score is based on a preference of at least one of the user, a group of users, the application, an entity associated with the application, and a sponsor, wherein the topic priority is based on at least one of a topic trend score, a topic popularity, a topic promotion associated with the sponsor, a count of references to the topic in a media source or social media network, and a topic interest score, wherein the topic metric comprises at least one of a topic request count, a topic statistic, a topic weight specified by at least one of the application and the entity, and a topic performance value, and wherein the topic relevance is based on at least one of a relationship between the topic and at least one of the date, a context associated with the user, a trend associated with a trend score, a location associated with the user, a content of the UI, and an event.

20. A non-transitory computer-readable medium having instructions stored thereon that, when executed by one or more processors, cause the one or more processors to perform operations comprising:
determining one or more topic candidates for a theme of a user interface (UI) of an application at a client device associated with a user;
determining a respective selection parameter for each topic from the one or more topic candidates, the respective selection parameter comprising at least one of a topic preference score, a topic priority, a topic metric, and a topic relevance to at least one of a date associated with a presentation of the UI, the user, the application, and content associated with the application;
selecting a particular topic from the one or more topic candidates based on the respective selection parameter for each topic from the one or more topic candidates;
based on the particular topic, determining one or more themes for the UI of the application; and
generating UI data defining a customized configuration of the UI based on the one or more themes.
